(19) United States
(12) Patent Application Publication
(10) Pub. No.: US 2017/0119034 A1
(43) Pub. Date: May 4, 2017

(54) COMPOSITIONS AND METHODS FOR MODIFYING PERCEPTION OF SWEET TASTE

(71) Applicant: University of Florida Research Foundation, Inc., Gainesville, FL (US)

(72) Inventors: Linda Bartoshuk, Gainesville, FL (US); Thomas A. Colquhoun, Gainesville, FL (US); David G. Clark, Gainesville, FL (US); Michael Schwieterman, Gainesville, FL (US); Charles A. Sims, Gainesville, FL (US); Vance Whitaker, Brandon, FL (US); Harry John Klee, Gainesville, FL (US); Denise Tieman, Gainesville, FL (US); Lauren McIntyre, Gainesville, FL (US)

(21) Appl. No.: 15/403,731

(22) Filed: Jan. 11, 2017

Related U.S. Application Data
(63) Continuation of application No. 13/869,132, filed on Apr. 24, 2013.
(60) Provisional application No. 61/637,362, filed on Apr. 24, 2012.
(60) Provisional application No. 61/781,254, filed on Mar. 14, 2013.

(51) Int. Cl. A23L 27/30; A23L 27/00

(52) U.S. Cl. CPC A23L 27/39; A23L 27/30; A23L 27/88; A23V 2002/00

(57) ABSTRACT

The present disclosure provides methods and compositions for modifying the perceived sweetness of a comestible, methods and compositions for increasing the perceived sweetness of a comestible; methods and compositions for suppressing the perceived sweetness of a comestible, hybrid plants, methods of producing hybrid plants, and sweetener compositions.

### CROSS-REFERENCE TO RELATED APPLICATIONS

This application is a continuation application of application Ser. No. 13/869,132, filed on Apr. 24, 2013, entitled, “Compositions and Methods for Modifying Perception of Sweet Taste” which claims priority to U.S. provisional applications entitled, “Modifying Perception of Sweet Taste,” having Ser. No. 61/637,362, filed on Apr. 24, 2012, and “Modifying Perception of Sweet Taste,” having Ser. No. 61/781,254, filed on Mar. 14, 2013, both of which are entirely incorporated herein by reference.

### STATEMENT REGARDING FEDERALLY SPONSORED RESEARCH OR DEVELOPMENT

This invention(s) was made with government support under Grant No.: IOS-0923312 awarded by the National Science Foundation and Grant No.: 00081058 awarded by the US Department of Agriculture-SCBGP. The government has certain rights in the invention(s).

### SEQUENCE LISTING

This application contains a sequence listing filed in electronic form as an ASCII.txt file entitled 2221061755_ST25.bd, created on Apr. 24, 2013. The content of the sequence listing is incorporated herein in its entirety.

### BACKGROUND

While human perception of food flavors involves integration of multiple sensory inputs, the most salient sensations are taste and olfaction. Orthonasal and retronasal olfaction contribute to flavor since they provide the qualitative diversity so important to identify safe and dangerous foods. Historically, flavor research has prioritized aroma volatiles present at levels exceeding the orthonasally measured odor threshold, ignoring the variation in the rate at which odor intensities grow above threshold. Further, the chemical composition of a food in itself tells us very little about whether or not that food will be liked. Alternative approaches can help elucidate flavor chemistry.

Though not well understood, the interactions between retronasal olfaction and taste represent an intriguing field of study for practical and theoretical reasons. Retronasal olfaction contributes to the sense of taste in natural products, such as tomatoes and other fruits and vegetables. Studying the volatile compounds present in such products and their contribution to overall taste and flavor provides insights into the interactions between retronasal olfaction and taste and how such interactions can be used to change the perception of taste in a consumable product.

Consumers often add ingredients to foods they consume, customizing those foods to their personal taste preferences. For instance, consumers commonly add sugar in the form of sucrose (table sugar), crystalline glucose, trehalose, dextrose or fructose, for example, to beverages, such as coffees and teas, on cereals, on fruits, and as toppings on baked goods to increase the sweet quality of the beverage or food item. Manufacturers often add sugar and other sugar substitutes to food products in order to increase the palatability of the product to consumers. Sugar generally includes a class of edible crystalline substances including sucrose, lactose, and fructose. Human taste buds interpret its flavor as sweet. Sugar as a basic food carbohydrate primarily comes from sugar cane and from sugar beet, but also appears in fruit, honey, sorghum, sugar maple (in maple syrup), and in many other sources. Sugars are high in calories, and over-consumption can lead to conditions such as obesity, diabetes, dental caries, and other health problems.

Sugar substitutes, including many artificial sweeteners, have been introduced to try to reduce the amount of sugar used in consumable products while maintaining the sweet taste preferred by consumers. Examples of sugar substitutes include, but are not limited to, aspartame, sucralose, stevioside, saccharin sodium, thaumatin, glycyrrhizin, acesulfame-K and sodium cyclamate. Many sugar substitutes are several times as sweet as sucrose, are often non-cariogenic, and are either low-caloric or non-caloric. These sugar substitutes, however, possess taste characteristics different than sugar, including, in some instances, undesirable taste characteristics such as lingering sweetness, delayed sweetness onset, and non-sugar like aftertastes. Thus, consumers and food producers continue to search for alternative methods of modifying sweetness of a consumable product.

### SUMMARY

Briefly described, embodiments of the present disclosure provide for compositions and methods for modifying the perceived sweetness of a comestible, compositions and methods for increasing the perceived sweetness of a comestible, compositions and methods for decreasing the perceived sweetness of a comestible, hybrid edible plants and methods of producing hybrid edible plants with modified perceived sweetness, and sweetener compositions.

The present disclosure describes methods of modifying the perceived sweetness of a comestible by including in the comestible one or more volatile compounds chosen from the group including: neral, 4-carene, 3-methyl-1-butanol, 6-methyl-5-hepten-2-ol, isovaleric acid, geranial, and 2-methylbutanal. In embodiments, the comestible also comprises a natural or artificial sweetener and the one or more volatile compounds modify the perceived sweetness of the comestible without increasing or decreasing the amount of natural or artificial sweetener in the comestible.

The present disclosure also provides methods of increasing the perceived sweetness of a comestible by in the comestible one or more volatile compounds chosen from the group including: neral, 4-carene, 3-methyl-1-butanol, 6-methyl-5-hepten-2-ol, isovaleric acid, and geranial, where the increase in perceived sweetness occurs without increasing the amount of natural or artificial sweetener in the comestible.

In embodiments, the present disclosure also includes methods of decreasing the perceived sweetness of a comestible by including in the comestible one or more volatile compounds chosen from: 2-methylbutanal, 3-methyl-2-buten-1-yl acetate, 4-methyl-2-pentanone, and ethyl octanoate, where the decrease in perceived sweetness occurs without decreasing the amount of natural or artificial sweetener in the comestible.

The present disclosure also provides compositions for increasing the perceived sweetness of a comestible. In embodiments, the compositions for increasing the perceived sweetness of a comestible include a combination of two or more volatile compounds chosen from: neral, 4-carene, 3-methyl-1-butanol, 6-methyl-5-hepten-2-ol, isovaleric acid, and geranial, where the composition does not contain a sugar or artificial sweetener and increases the perceived sweetness of the comestible without increasing the amount of natural or artificial sweetener in the comestible. In embodiments, the perceived sweetness of the comestible including the composition including combination of volatile compounds is greater than the perceived sweetness of a comparable comestible including only one of the volatile compounds.

In embodiments, the present disclosure also provides compositions for increasing the perceived sweetness of a comestible, where the composition includes a combination of two or more volatile compounds chosen from the group consisting of: 1-penten-3-one, (E)-pent-2-en-1-al, (Z)-pent-2-en-1-al, 5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, and S-methyl butanethioate, where the composition does not contain a sugar or artificial sweetener and increases the perceived sweetness of the comestible without increasing the amount of natural or artificial sweetener in the comestible. In embodiments of such composition, the two or more volatile compounds are chosen from the group including: 1-penten-3-one, 5-octyldihydro-2(3H)-furanone, pentyl butyrate, hexyl butyrate, hexyl acetate, and 2-pentanyl butyrate. In embodiments, the perceived sweetness of the comestible having the combination of volatile compounds is greater than the perceived sweetness of a comparable comestible including only one of the volatile compounds.

In embodiments, the present disclosure provides methods of modifying the perceived sweetness of a consumable plant product, including producing a hybrid plant having a greater amount of at least one volatile compound in the edible portion of the plant than the amount of that volatile compound in an edible portion of an ancestor cultivar of the plant, where the volatile compound is chosen from the group including: neral, 4-carene, 3-methyl-1-butanol, 6-methyl-5-hepten-2-ol, isovaleric acid, geranial, 1-penten-3-one, (E)-pent-2-en-1-al, (Z)-pent-2-en-1-al, 5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, and S-methyl butanethioate, and where the edible portion of the hybrid plant has a greater perceived sweetness than the edible portion of the ancestor plant. In embodiments of the present disclosure, the hybrid plant also includes a lesser amount of at least one volatile compound in the edible portion of the plant than the amount of that volatile compound in the edible portion produced by an ancestor cultivar, where the volatile compound is chosen from the group including: 2-methylbutanal, 3-methyl-2-buten-1-yl acetate, 4-methyl-2-pentanone, and ethyl octanoate.

A hybrid consumable plant that produces an edible portion comprising a greater amount of at least one volatile compound in the edible portion of the plant than the amount of that volatile compound in the edible portion produced by an ancestor cultivar, wherein the volatile compound is chosen from the group consisting of: neral, 4-carene, 3-methyl-1-butanol, 6-methyl-5-hepten-2-ol, isovaleric acid, geranial, 1-penten-3-one, (E)-pent-2-en-1-al, (Z)-pent-2-en-1-al, 5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, and S-methyl butanethioate;

wherein the edible portion produced by the hybrid plant also comprises a lower amount of at least one volatile compound in the edible portion of the plant than the amount of that volatile compound in the edible portion produced by an ancestor cultivar, wherein the volatile compound is chosen from the group consisting of: 2-methylbutanal, 3-methyl-2-buten-1-yl acetate, 4-methyl-2-pentanone, and ethyl octanoate; where the edible portion of the hybrid plant has a greater perceived sweetness than the edible portion of the ancestor plant.

Methods of the present disclosure also include methods of producing a plant that produces an edible portion with a modified perceived sweetness relative to a comparable wild type plant. In embodiments, such methods include introgressing a gene responsible for the production of at least one volatile compound into the genome of the plant, whereby the plant produces a greater amount of the at least one volatile compound in an edible portion of the plant than in the edible portion of a comparable wild type plant. In embodiments, the at least one volatile compound is chosen from the group including: neral, 4-carene, 3-methyl-1-butanol, 6-methyl-5-hepten-2-ol, isovaleric acid, geranial, 1-penten-3-one, (E)-pent-2-en-1-al, (Z)-pent-2-en-1-al, 5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, and S-methyl butanethioate.

The present disclosure also describes sweetener compositions including one or more volatile compounds and a natural or artificial sweetener, where the one or more volatile compounds are chosen from: neral, 4-carene, 3-methyl-1-butanol, 6-methyl-5-hepten-2-ol, isovaleric acid, and geranial.

Other methods, compositions, plants, features, and advantages of the present disclosure will be or become apparent to one with skill in the art upon examination of the following drawings and detailed description. It is intended that all such additional compositions, plants, methods, features, and advantages be included within this description, and be within the scope of the present disclosure.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A-1C include graphs illustrating the genetic distribution of 19 heirloom cultivars that vary in liking score (FIG. 1A), sweetness score (FIG. 2A), and tomato flavor intensity score (FIG. 10). Genetic variation was determined using 27 polymorphic DNA markers, and the cultivars were clustered using principal components analysis. Each circle represents a cultivar with the number corresponding to its name. The hash marks correspond to the cultivar and the liking score of the cultivars (shown at right) with liking varying from highly liked at the top to highly disliked at the bottom. The open circle in the bottom left of each plot corresponds to cultivars Chadwick Cherry (9) and Large Red Cherry (18) that were genetically indistinguishable but differed in consumer preferences.

FIGS. 2A-2B illustrate ordered correlation matrices of flavor-associated fruit chemicals. FIG. 2A shows correlations of the 71 measured chemicals. FIG. 2B shows correlations of the 27 selected for multivariate analysis. MMC (Stone et al., 2009) was used as a visual aid to assist in grouping closely related chemicals.

FIG. 3 illustrates the chemical structure of various volatile compounds (identified by CAS number) quantified in strawberry.

FIGS. 4A-4W present a series of graphs illustrating hedonics, sensory, and metabolite relations. These figures illustrate a subset of metabolites regressed against hedonic and sensory measures. The dashed line in each figure represents the fit mean; the solid line illustrates the linear fit; and the double hashed elliptical line illustrates the bivariate normal ellipse (P=0.950). Hedonic overall liking is regressed against hedonic texture liking (A), sweetness intensity (B), sourness intensity (C), and strawberry flavor intensity (D). Overall liking is fitted to harvest week (E), total sugars (F), titratable acidity (G), and total volatiles (H). Texture liking is examined against puncture force (I) and harvest week (J), and forces is examined against harvest week (K). Sweetness intensity is regressed against total sugars (L), sucrose (M), glucose (N), and total volatiles (0). Intensity of sourness is fitted to titratable acidity (P), malic acid (Q), citric acid (R), and total sugars (S). Strawberry flavor intensity is regressed by total volatiles (T) and select single volatile compounds 1576-87-0 (U), 623-42-7 (V), and 110-62-3 (W). Coefficient of determination (R²) and p-value of fit is listed above individual scatterplots and is calculated using bivariate fit in JMP 8 (α=0.05).

### DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

Any publications and patents cited in this specification that are incorporated by reference are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of agriculture, botany, statistics, organic chemistry, biochemistry, molecular biology, and the like, which are within the skill of the art. Such techniques are explained fully in the literature.

It must be noted that, as used in the specification and the appended embodiments, the singular forms “a,” “an,” and “the” include plural referents unless the context clearly dictates otherwise. Thus, for example, reference to “a support” includes a plurality of supports. In this specification and in the embodiments that follow, reference will be made to a number of terms that shall be defined to have the following meanings unless a contrary intention is apparent.

Prior to describing the various embodiments, the following definitions are provided and should be used unless otherwise indicated.

### Definitions

In describing the disclosed subject matter, the following terminology will be used in accordance with the definitions set forth below.

As used herein, the term “taste” refers to the sensation of one of the classic “taste qualities” perceived by the taste sensors in the mouth of a consumer. Taste qualities include at least the following classic taste qualities: sweet, salty, sour, and bitter.

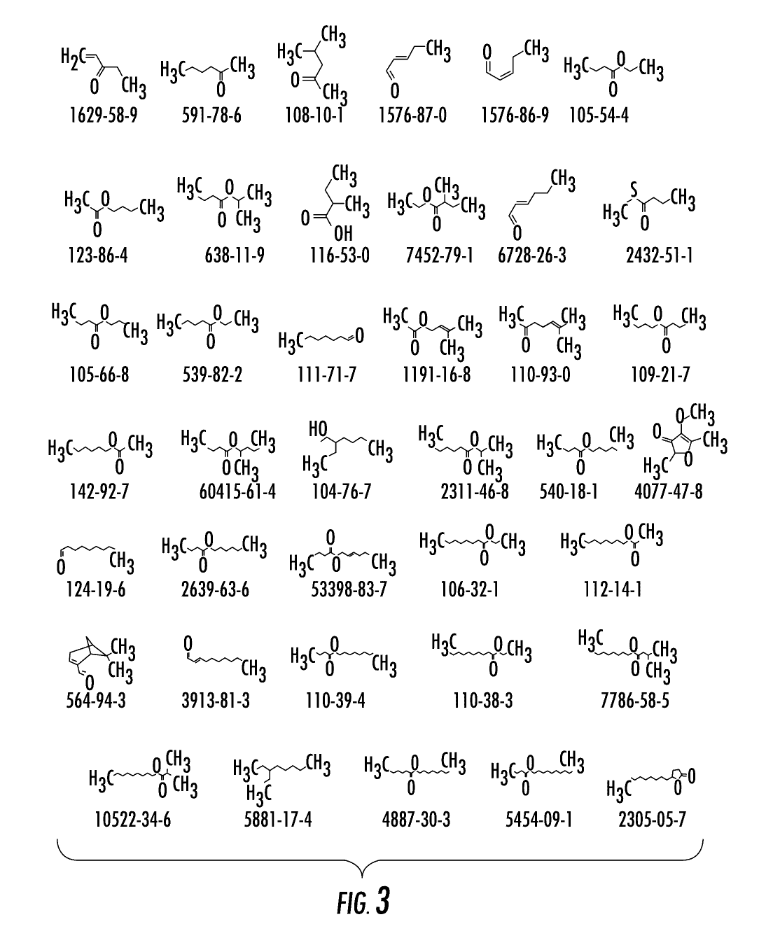

The term “volatile compound” or “flavor volatile” or “volatile” refers to certain chemicals that can be sensed by the olfactory systems of a consumer. Many of the volatile compounds of the present disclosure can be found in fruits, such as, but not limited to, tomato and strawberry. Some exemplary volatile compounds include, but are not limited to, 1-penten-3-one, isovaleronitrile, trans-2-pentenal, trans-2-heptenal, trans-3-hexen-1-ol, 6-methyl-5-hepten-2-ol, nonyl aldehyde, cis-4-decenal, isovaleraldehyde, 3-methyl-1-butanol, methional, 2,5-dimethyl-hydroxy-3(2H)-furanone, 3-pentanone, 1-pentanol, benzyl cyanide, isovaleric acid, 2-isobutylthiazole, 1-nitro-3-methylbutane, benzaldehyde, 6-methyl-5-hepten-2-one, β-ionone, β-cyclocitral, geranial, phenylacetaldehyde, eugenol, geranylacetone, 2-phenylethanol, neral, salicylaldehyde, isobutyl acetate, butyl acetate, cis-3-hexen-1-ol, 1-nitro-2-phenylethane, 1-penten-3-ol, 2-methylbutyl acetate, heptaldehyde, trans,trans-2,4-decadienal, 2-methylbuteraldehyde, 4-carene, hexyl alcohol, guaiacol, propyl acetate, hexanal, cis-2-penten-1-ol, 2-butylacetate, 1-octen-3-one, cis-3-hexenal, methylsalicylate, trans-2-hexenal (also called (2E)-2-hexenal), β-damascenone, 2-methyl-1-butanol, 2-methyl-2-butenal, prenyl acetate, hexyl acetate, 3-methyl-1-pentanol, 2-ethylfuran, isopentyl acetate, 2-methylbutanal, benzothiazole, cis-3-hexenyl acetate, benzyl alcohol, citric acid, 3-methyl-2-butenal, p-anisaldehyde, (E)-pent-2-en-1-al, (Z)-pent-2-en-1-al, 5-octyldihydro-2(3H)-furanone, 2-decenal, nonanal, 2-hexanone,3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, isopropyl butyrate, 2-pentanyl butyrate, 2-methylbutanoic acid, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, S-methyl butanethioate, 3-methyl-2-buten-1-yl acetate, 4-methyl-2-pentanone, and ethyl octanoate. The chemical structures of various volatile compounds discussed in the present disclosure are presented in FIG. 3. Although the above volatile names are generally regarded as standard in the art, variations can occur in chemical nomenclature; thus, Table 1 below also identifies many of the volatiles discussed in the present application by CAS number.

TABLE 1

| CAS # | Chemical name |
|---|---|
| 1629-58-9 | 1-penten-3-one |
| 1576-87-0 | (E)-pent-2-en-1-al |
| 1576-86-9 | (Z)-pent-2-en-1-al |
| 2305-05-7 | 5-octyldihydro-2(3H)-furanone |
| 3913-81-3 | 2-decenal |
| 124-19-6 | nonanal |
| 6728-26-3 | (2E)-2-hexenal or trans-2-hexenal |
| 591-78-6 | 2-hexanone |
| 5881-17-4 | 3-ethyloctane |
| 540-18-1 | pentyl butyrate |
| 2639-63-6 | hexyl butyrate |
| 105-54-4 | ethyl butyrate |
| 564-94-3 | 6,6-dimethylbicyclo[3.1.1]hept-2-ene-2- |
| | carbaldehyde |
| 111-71-7 | heptanal |
| 4077-47-8 | 4-methoxy-2,5-dimethyl-3(2H)-furanone |
| 110-93-0 | 6-methyl-5-hepten-2-one |
| 638-11-9 | isopropyl butyrate |
| 142-92-7 | hexyl acetate |
| 60415-61-4 | 2-pentanyl butyrate |
| 116-53-0 | 2-methylbutanoic acid |
| 123-86-4 | butyl acetate |
| 7452-79-1 | ethyl 2-methylbutanoate |
| 109-21-7 | butyl butyrate |
| 109-19-3 | butyl 3-methylbutanoate |
| 5454-09-1 | decyl butyrate |
| 53398-83-7 | (2E)-2-hexen-1-yl butyrate |
| 104-76-7 | 2-ethyl-1-hexanol |
| 110-39-4 | octyl butyrate |
| 105-66-8 | propyl butyrate |
| 10522-34-6 | nonyl 2-methylpropanoate |
| 112-14-1 | octyl acetate |
| 4887-30-3 | octyl hexanoate |
| 7786-58-5 | octyl 3-methylbutanoate |
| 110-38-3 | ethyl decanoate |
| 2311-46-8 | isopropyl hexanoate |
| 1191-16-8 | 3-methyl-2-buten-1-yl acetate |
| 539-82-2 | ethyl valerate |
| 2432-51-1 | S-methyl butanethioate |
| 108-10-1 | 4-Methyl-2-pentanone |
| 106-32-1 | ethyl octanoate |
| 106-26-3 | Neral |
| 29050-33-7 | 4-carene |
| 123-51-3 | 3-methyl-1-butanol |
| 1569-60-4 | 6-methyl-5-hepten-2-ol |
| 503-74-2 | isovaleric acid |
| 141-27-5 | geranial |
| 96-17-3 | 2-methylbutanal |

The term “aroma” or “odor” as used herein, refers to orthonasal olfaction of a volatile compound, e.g., the smell perceived when a volatile compound is sniffed through the nose.

As used herein, the term “flavor” refers to retronasal olfaction of a volatile compound, e.g., when volatiles emitted from substances in the mouth are forced up past the palate to the nasal cavity from the back. The perception of the volatile compound is referred to the mouth. While colloquially “flavor” often refers to a combination of taste and retronasal olfaction, unless otherwise indicated herein “flavor” refers to retronasal olfaction with respect to a flavor volatile, whereas “perceived flavor” or “perceived taste” refers to a combination of taste and retronasal olfaction (“flavor”).

The term “flavor-associated compound” refers to chemicals that can be sensed by the taste and/or olfactory systems of a consumer. Flavor-associated compounds include volatile compounds, as discussed above, as well as various taste-associated compounds such as sugars and acids.

The “actual sweetness” refers to the sweetness of a comestible attributable to the amount of sweetener (sugar or sugar-substitute (e.g., artificial sweetener)) in the comestible. This is the sweetness attributed to the sweet taste quality. As used herein “sweetener” refers to natural and artificial sweeteners. Natural sweeteners include sugars such as glucose, fructose, sucrose and other natural sugar-containing products used for sweetening (e.g., honey, molasses, etc.). Artificial sweeteners or sugar substitutes include other chemical sweetening agents, usually non-caloric or lower in calories than natural glucose or fructose (e.g., saccharin, sucralose, rebenia, etc.).

“Perceived sweetness” refers to the sweetness perceived by a consumer based on the combination of the sweet taste quality (“actual sweetness”) as well as contributions to sweetness by flavor volatiles. The perceived sweetness may be greater than or less than the actual sweetness of a comestible without or with a different amount of the volatile(s). For instance, the perceived sweetness may be greater than the actual sweetness if certain flavor volatiles increase and/or enhance the perceived sweetness of a comestible over the actual sweetness (e.g., the perceived sweetness to a consumer is greater with the volatile(s) present without increasing the amount of sugar or sugar-substitute). On the other hand, the perceived sweetness may be less than the actual sweetness if certain flavor volatiles suppress or mask the actual sweetness of a comestible (e.g., the perceived sweetness to a consumer is less with the volatile(s) present without any decrease in the amount of sugar or sugar-substitute).

“Induced sweetness” refers to the difference between the perceived sweetness and actual sweetness of a comestible.

As used herein, the term “introgression” or “introgressed” means the entry or introduction of one or more genes from one or more plants into another. As used herein, the term “introgressing” means entering or introducing one or more genes from one or more donor or ancestor plants into a recipient or descendent. Introgression may be accomplished by either traditional breeding techniques or by transgenic methods, or a combination of genetic transformation and traditional breeding.

The term “tasting panel” refers to a number of individuals assembled into a panel to taste samples of a consumable compound and to rate the samples based on flavor and other criteria.

As used herein, the term “liking score” refers to a numerical score assigned to a sample a food (e.g., a tomato or strawberry) by a member of a tasting panel, where the taster rates the food based on the taster's perception of the taste of the food (e.g., liking or disliking).

As used herein, the term “tomato” or “tomato plant” means any variety, cultivar, or population of Solanum lycopersicum (also known as Lycopersicon esculentum and/or Lycopersicon lycopersicum), including both commercial tomato plants as well as heirloom varieties. In some embodiments, “tomato” may also include wild tomato species, such as, but not limited to, Solanum lycopersicum var. cerasiforme, Solanum pimpinellifolium, Solanum cheesmaniae, Solanum neorickii, Solanum chmielewskii, Solanum habrochaites, Solanum pennellii, Solanum peruvianum, Solanum chilense and Solanum lycopersicoides.

The term “strawberry” or “strawberry plant” as used herein means any variety, cultivar, or population of the Fragaria genus, including garden strawberries (a hybrid known as Fragaria ananassa, as well as various other strawberry species, subspecies, and cultivars such as, but not limited to, F. vesca, F. moschata, F. viridis, F. sylvestris alba, F. sylvestris semperf/orens, F. moschata, F. virginiana, and F. chiloensis.

As used herein, the term “plant” includes plant cells, plant protoplasts, plant cell tissue cultures from which tomato plants can be regenerated, plant calli, plant cell clumps, and plant cells that are intact in plants, or parts of plants, such as embryos, pollen, ovules, flowers, leaves, seeds, roots, root tips and the like.

The “edible portion” of a plant includes any portion of a plant that may be consumed by humans, such as, but not limited to, fruits, vegetables, grains, leafy portions, seeds, and the like.

The term “tomato fruit” refers to the fruit produced by a tomato plant, including the flesh, pulp, meat, and seeds of the fruit.

The term “strawberry” or “strawberry fruit” refers to the fruit produced by a strawberry plant, including the flesh, pulp, meat, and seeds of the fruit.

As used herein, the term “variety” or “cultivar” means a group of similar plants within a species that, by structural features, genetic traits, performance, and/or content of volatile compounds, sugars, and/or acids, can be identified from other varieties within the same species.

As used herein, the term “hybrid” means any offspring (e.g., seed) produced from a cross between two genetically unlike individuals (Rieger, R., A Michaelis and M. M. Green, 1968, A Glossary of Genetics and Cytogenetics, Springer-Verlag, N.Y.). An “F1 hybrid” is the first generation offspring of such a cross, while an “F2”, “F3” hybrid, and so on, refer to descendent offspring from subsequent crosses (e.g., backcrossing of an F1 hybrid or later hybrid with one of the parent plant varieties, crossing an F1 hybrid with a different plant variety than the original parents, and so on).

As used herein “ancestor” refers to a parent, grandparent, great-grandparent, and so-on, of a plant.

As used herein, “comestible” refers to anything that can be consumed (e.g., eaten/ingested) by humans, such as, but not limited to, natural food products, manufactured food products, beverages, food additives, medications, etc. The term “comestible” also includes products, such as chewing tobacco or chewing gum that is typically chewed, and tasted, but not necessarily swallowed by the consumer.

### Discussion

The embodiments of the present disclosure encompass methods and compositions for modifying the perception of sweet taste by a consumer, methods of producing a comestible with modified perceived sweetness, and consumable plants having modified perceived sweetness and methods of producing such plants.

The senses of taste (gustation) and smell (olfaction) have biological functions that contribute to survival. When looking at mechanisms, it is well to remember the biological functions of these senses. These biological functions provide clues as to how taste and smell function.

Taste qualities (the classic four include: sweet, salty, sour and bitter) allow organisms to identify nutrients that are crucial to survival. Some researchers include a fifth taste quality, umami, but its inclusion as a taste quality is controversial. It is possible to have one or more of these taste qualities within the same item. The affect (pleasure/displeasure) evoked by these qualities is hard-wired in the brain (requires no learning). Sweetness identifies glucose, the sugar used as fuel by the brain. Saltiness identifies sodium, essential for nerve and muscle function. Sourness identifies potentially dangerous acids (and may also serve to identify unripe fruit). Bitterness identifies poisons. Taste qualities result from stimulation of oral receptors tuned to chemical characteristics of specific molecules.

Olfactory qualities, which do not fall into any generally accepted naming system, allow organisms to learn about substances in their environments that are beneficial or dangerous. Olfactory sensations are produced by receptors tuned to specific active groups on molecules, e.g., volatile compounds. The active groups on particular volatile compounds create a pattern of response at the glomeruli in the olfactory brain. That pattern is somehow stored in memory and is associated with affect by learning. For example, the bacon odor pattern becomes liked by association with the protein and fat in bacon; the orange odor pattern becomes liked by association with the sugar in oranges. The number of volatiles that can produce olfactory sensations is essentially unlimited. However, the number that can be learned (presumably those that form patterns in the brain that are stored) is smaller; for instance, experts can learn to identify and name around 200 odors.

Volatile compounds can be sensed by an individual via orthonasal and retronasal olfaction. “Orthonasal olfaction” refers to olfactory sensations resulting when odorants are sniffed through the nostrils. “Retronasal olfaction” refers to olfactory sensations resulting when odorants emitted by substances in the mouth are forced up behind the palate and into the nasal cavity from the back. In both cases, the receptors stimulated are located high in the nasal cavity. However, perceptually, retronasal olfaction is referred to the mouth. In both cases, the sensation is evoked by stimulation of the olfactory receptors at the top of the nasal cavity.

The senses of taste and smell (or odor) are anatomically two separate entities. Taste is stimulated through physical interactions of non-volatile molecules with receptors on the tongue and mouth surfaces, while volatile compounds reaching the receptors in the olfactory epithelium determine smell. At a perceptual level, however, there are many indications that the sensations of taste and smell interact. Interactions may also occur with the other modalities of appearance, sound and texture.

The multimodal interaction and integration of these sensations results in a complex perception that is commonly called “flavor” or “taste.” Thus, unless a person is aguesic (inability to perceive tastes) or anosmic (inability to perceive odors), the consumption of foods and beverages results in the simultaneous perception of taste and smell, which contributes to an overall impression of flavor. These perceptions are thought to be associated and interactive at the cognitive level (i.e. associative learning and integration) of the brain. Although some experts use the term “flavor” to refer to taste plus retronasal olfaction and others generalize further by including sensations of touch and temperature, the key element in flavor is retronasal olfaction. As defined above, in the present disclosure, “flavor” refers to retronasal olfaction of volatile compounds, whereas “perceived flavor” or “perceived taste” refers to the combination of taste and retronasal olfaction.

Interactions among taste and smell influence an individual's overall perception of a food. In mixtures of different taste qualities, suppression occurs (Bartoshuk, 1975, p. 216). For example, upon adding sugar to quinine (e.g., tonic water), both the sweetness and bitterness will be less intense than either would be alone. In mixtures of different olfactory qualities, suppression also occurs (Jones, 1964, p. 3709). One purpose of this suppression is to prevent complex mixtures from becoming extremely intense as they would if taste intensities or odorant intensities simply added in mixtures.

While taste and orthonasal olfaction essentially do not interact, taste and retronasal olfaction do interact. The biological purpose of such interactions is unclear, but those interactions lead to the phenomenon of volatile-induced-sweetness. Studies have shown that the intensity of perceived flavors or tastes can be modified by simultaneous consumption of non-volatile molecules and volatile compounds.

The food industry has long believed that adding sweeteners can intensify flavor. Sjöström and Cairncross (working for Arthur D. Little) documented examples of the “enhancement of total flavor” by the addition of sweeteners to various food products (Sjöström, 1955, p. 3707). The present study shows that the reverse can also be true: flavors can intensify or suppress sweet taste. The present disclosure describes taste modifying compositions containing certain flavor volatiles that can be used for taste modification of the sweet taste quality. The flavor volatiles can be used to enhance or suppress the perceived sweetness of a food, and consumable product.

One of the purposes of the studies described in the examples below was to use science to demonstrate how fruits and vegetables can be made more palatable. In an embodiment, the design was to (1) grow plants producing fruit varying in sugar, acid and volatile constituents, (2) measure the concentrations of those constituents and (3) measure the sensory and hedonic properties of those fruits. For the tomato study described in Examples 1 and 2 below, the concentration of each constituent was plotted against palatability for the 80 tomatoes included in the study. These correlations showed great variability: about half were positive (the more of that constituent in the tomato, the more it was liked), a few were negative (the more of that constituent in the tomato, the less it was liked) and some correlations were not significant. Similar tests were performed with strawberries, as described in Example 3, below. These studies provide a guide for increasing the constituents that correlate positively with tomato palatability and decreasing those that correlate negatively. This guide was used to further elucidate the volatile compounds that made independent contributions to the perceived sweetness of the tomato and/or strawberry, as judged by a consumer tasting panel.

Example 1 below describes in greater detail embodiments of methods used to conduct a tasting panel according to the present disclosure and methods of identifying the flavor-associated compounds (e.g., sugars, acids, and volatile compounds) positively and negatively associated with taste and methods of identifying which tomato varieties have greater or lesser amounts of various volatile compounds and other flavor-associated compounds. As shown in the tables, the amounts of various flavor-associated compounds for tomatoes with different liking scores can be determined. Further regression analysis was conducted to determine volatile compounds with a significant independent effect on perceived sweetness, as shown in Example 2. From the analysis of the date from the tomato studies in Examples 1 and 2, volatile compounds found to be positively associated with sweetness, independent of sugar content, included the following volatile compounds: neral, 4-carene, 3-methyl-1-butanol, 6-methyl-5-hepten-2-ol, isovaleric acid, and geranial. The data also identified a volatile compound negatively associated with sweetness (e.g., suppresses perceived sweetness): 2-methylbutanal.

Example 3 describes similar studies and experiments conducted with strawberries, also including conducting a tasting panel according to the present disclosure and methods of identifying the flavor-associated compounds positively and negatively associated with taste and methods of identifying which strawberry varieties have greater or lesser amounts of various volatile compounds and other flavor-associated compounds. Regression analysis was also conducted on these data associating the volatile compounds with liking and with sweetness to determine the volatile compounds independently associated with sweetness. The following compounds were found to increase perceived sweetness, independent of at least one sugar: 1-penten-3-one, (E)-pent-2-en-1-al, (Z)-pent-2-en-1-al, 5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, and S-methyl butanethioate. Six of these compounds were found to have an association with sweetness independent of all sugars: 1-penten-3-one (1629-58-9), 5-octyldihydro-2(3H)-furanone (2305-05-7), pentyl butyrate (540-18-1), hexyl butyrate (2639-63-6), hexyl acetate (142-92-7), and 2-pentanyl butyrate (60415-61-4). The following compounds had a negative association with sweetness (e.g., suppressed perceived sweetness): 3-methyl-2-buten-1-yl acetate, 4-methyl-2-pentanone, and ethyl octanoate.

Thus, in embodiments of the present disclosure, the volatile compound positively associated with sweetness (e.g., increases perceived sweetness) can be, but is not limited to: neral, 4-carene, 3-methyl-1-butanol, 6-methyl-5-hepten-2-ol, isovaleric acid, geranial, 1-penten-3-one, (E)-pent-2-en-1-al, (Z)-pent-2-en-1-al, 5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, S-methyl butanethioate, or combinations of those compounds.

In embodiments, the volatile compound negatively associated with sweetness (e.g., suppresses perceived sweetness) can be, but is not limited to, one or a combination of: 2-methylbutanal, 3-methyl-2-buten-1-yl acetate, 4-methyl-2-pentanone, and ethyl octanoate.

The present disclosure describes the use of targeted metabolomics and natural variation in flavor-associated sugars, acids and aroma volatiles to evaluate the chemistry of tomato and strawberry fruits, creating a predictive and testable model of liking. This non-traditional approach provides novel insights into flavor chemistry, the interactions between taste and retronasal olfaction and a paradigm for enhancing or suppressing the perceived sweetness of natural products. Some of the most abundant volatiles do not contribute to consumer liking or sweetness while other less abundant ones do. Aroma volatiles make contributions to perceived sweetness independent of sugar concentration, suggesting a novel way to increase perception of sweetness or suppress the perception of other taste qualities, such as bitter, without adding sugar or other sugar-substitutes.

Thus, in embodiments of the present disclosure, the volatile compounds associated with perceived sweetness can be used to modify the perceived sweetness of a comestible. Comestibles can include, but are not limited to, food items, beverages, medications, and the like as well as other items meant to be tasted by the consumer even if not swallowed (e.g., tobacco). The modification can include either increasing the perceived sweetness or suppressing the perceived sweetness of a comestible. Perceived sweetness can be enhanced by including volatile compounds that increase the perceived sweetness of a comestible by increasing the perception of sweet taste without addition of natural or artificial sweeteners. This increase in perceived sweet can also be used in certain comestibles to suppress other taste qualities such as bitter (e.g., in medications) or sour (e.g., in certain fruit products). On the other hand, perceived sweetness can also be suppressed (e.g., decreased) by including volatile compounds that decrease the perceived sweetness of a comestible by reducing the perception of sweet taste without reduction of natural sugars or addition of other compounds (e.g., salt) that increase other taste qualities.

Thus, embodiments of the present disclosure include methods of modifying the perceived sweetness of a comestible by including in the comestible one or more volatile compounds chosen from the group including: neral, 4-carene, 3-methyl-1-butanol, 6-methyl-5-hepten-2-ol, isovaleric acid, geranial, 1-penten-3-one, (E)-pent-2-en-1-al, (Z)-pent-2-en-1-al, 5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, S-methyl butanethioate, 3-methyl-2-buten-1-yl acetate, 4-methyl-2-pentanone, ethyl octanoate, and 2-methylbutanal.

The examples below illustrate that the above listed compounds produce a positive effect on perceived sweetness. In other words, these volatile compounds act to increase the perceived sweetness of a comestible. Thus, embodiments of the present disclosure for methods of increasing the perceived sweetness of a comestible include adding one or more volatile compounds chosen from neral, 4-carene, 3-methyl-1-butanol, 6-methyl-5-hepten-2-ol, isovaleric acid, geranial, 1-penten-3-one, (E)-pent-2-en-1-al, (Z)-pent-2-en-1-al, 5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, and S-methyl butanethioate to the comestible to increase the perceived sweetness without increasing the amount of natural or artificial sweetener in the comestible. In embodiments, the volatile compound positively associated with sweetness is chosen from the group including: neral, 4-carene, 3-methyl-1-butanol, 6-methyl-5-hepten-2-ol, isovaleric acid, geranial, 1-penten-3-one, 5-octyldihydro-2(3H)-furanone, pentyl butyrate, hexyl butyrate, hexyl acetate, and 2-pentanyl butyrate or combinations of those compounds.

2-methybutanal, 3-methyl-2-buten-1-yl acetate, 4-methyl-2-pentanone, and ethyl octanoate, on the other hand, have a negative effect on perceived sweetness, and thus act to decrease/suppress the perceived sweetness of a comestible. Methods of the present disclosure for decreasing the perceived sweetness of a comestible include producing a comestible having one or more of the volatile compounds selected from: 2-methylbutanal, 3-methyl-2-buten-1-yl acetate, 4-methyl-2-pentanone, and ethyl octanoate, where the comestible has a decreased perceived sweetness as compared to a comestible with less of any of these compounds.

As demonstrated by the examples below, these volatile compounds make an independent contribution to perceived sweetness, and thus, modify the perceived sweetness of a comestible without any alteration in the amount of natural or artificial sweeteners or other taste compounds present in the comestible. Since the effects on the perceived sweetness induced by these flavor volatiles appears to be additive, a combination of two or more of the volatile compounds of the present disclosure associated with an increase in perceived sweetness can produce an even greater modification of perceived sweetness. Thus, in embodiments of the present disclosure, the perceived sweetness of a comestible is modified by including in the comestible two or more volatile compounds chosen from neral, 4-carene, 3-methyl-1-butanol, 6-methyl-5-hepten-2-ol, isovaleric acid, geranial, 1-penten-3-one, (E)-pent-2-en-1-al, (Z)-pent-2-en-1-al, 5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, and S-methyl butanethioate.

Embodiments of the present disclosure also include compositions for increasing the perceived sweetness of a comestible including two or more volatile compounds chosen from: neral, 4-carene, 3-methyl-1-butanol, 6-methyl-5-hepten-2-ol, isovaleric acid, geranial, 1-penten-3-one, (E)-pent-2-en-1-al, (Z)-pent-2-en-1-al, 5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, and S-methyl butanethioate. In embodiments, a comestible of the present disclosure with two or more of the volatile compounds of the present disclosure has a greater perceived sweetness than a comestible including only one of the volatile compounds. Compositions of the present disclosure can also include a sweetener composition that includes a sugar or sugar-substitute (e.g., artificial sweetener) in combination with one or more of the volatile compounds of the present disclosure.

Embodiments of the present disclosure also include methods of producing natural food products with modified perceived sweetness. Natural food products include consumable plants and plant products, such as fruits, vegetables, grains, and the like. In embodiments, the consumable plant product has a greater amount of at least one of the volatile compounds positively associated with sweet taste and/or a lesser amount of at least one of the volatile compounds negatively associated with sweet taste than the amount of the volatile compound in an ancestor plant or comparable wild type plant. In embodiments, the present disclosure includes hybrid plants and methods of breeding plants to produce a hybrid plant having a greater amount of at least one volatile compound associated with modified perceived sweetness in the edible portion of the plant than the amount of that volatile compound an edible portion of an ancestor cultivar of the plant. In embodiments the edible portion of the plant is a fruit or vegetable.

In embodiments, the hybrid plant produces a greater amount of at least one volatile compound positively associated with perceived sweetness than an ancestor plant, where the volatile compound includes, but is not limited to, neral, 4-carene, 3-methyl-1-butanol, 6-methyl-5-hepten-2-ol, isovaleric acid, and geranial. In embodiments the hybrid plant produces a greater amount of at least one volatile compound positively associated with perceived sweetness than an ancestor plant, where the volatile compound includes, but is not limited to: 1-penten-3-one, (E)-pent-2-en-1-al, (Z)-pent-2-en-1-al, 5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, and S-methyl butanethioate. The edible portion of the hybrid plants of the present disclosure has a greater perceived sweetness than the edible portion of the ancestor plant. In embodiments, the hybrid plant produces a greater amount of two or more of the volatile compounds positively associated with perceived sweetness than an ancestor plant.

In other embodiments, the hybrid plant of the present disclosure has a lower amount of a volatile compound negatively associated with perceived sweetness than an ancestor plant, in the edible portion than the amount of the compound in the edible portion produced by an ancestor cultivar of the plant. In embodiments, the volatile compound negatively associated with perceived sweetness can be selected from the group including, but not limited to: 2-methylbutanal, 3-methyl-2-buten-1-yl acetate, 4-methyl-2-pentanone, and ethyl octanoate.

Methods of the present disclosure also include using introgression (either by traditional breeding techniques, genetic modification, or a combination of both) to introduce a gene responsible for the production of at least one volatile compound associate with perceived sweetness into the genome of a plant to produce a plant that produces an edible portion with a modified perceived sweetness relative to a wild type plant. Thus, in embodiments, the gene or genes associated with production of one or more of the volatile compounds selected from: neral, 4-carene, 3-methyl-1-butanol, 6-methyl-5-hepten-2-ol, isovaleric acid, geranial, 1-penten-3-one, (E)-pent-2-en-1-al, (Z)-pent-2-en-1-al, 5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, S-methyl butanethioate, 2-methylbutanal, 3-methyl-2-buten-1-yl acetate, 4-methyl-2-pentanone, and ethyl octanoate, can be introgressed into the genome of an edible plant, to produce a plant that produces an edible portion with a modified perceived sweetness as compared to a wild type plant.

Additional details regarding the tasting panels, the chemical composition of the tomato cultivars, the analysis of chemical composition and liking scores, the volatile analysis and regression analysis for association with sweet perception can found in the Examples below.

The specific examples below are to be construed as merely illustrative, and not limitative of the remainder of the disclosure in any way whatsoever. Without further elaboration, it is believed that one skilled in the art can, based on the description herein, utilize the present disclosure to its fullest extent. All publications recited herein are hereby incorporated by reference in their entirety.

It should be emphasized that the embodiments of the present disclosure, particularly, any “preferred” embodiments, are merely possible examples of the implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure, and protected by the following embodiments.

The following examples are put forth so as to provide those of ordinary skill in the art with a complete disclosure and description of how to perform the methods and use the compositions and compounds disclosed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

### Example 1

### Tomato Liking and Volatile Assessment

The present example, targeted metabolomics and natural variation in flavor-associated sugars, acids and aroma volatiles were analyzed to evaluate the chemistry of tomato fruits, creating a predictive and testable model of liking. This non-traditional approach provided novel insights into flavor chemistry, the interactions between taste and retronasal olfaction and a paradigm for enhancing liking of natural products. The results demonstrated that some of the most abundant volatiles do not contribute to consumer liking while other less abundant ones do. The results and analysis below also show that aroma some volatiles make contributions to perceived sweetness independent of sugar concentration, providing novel methods to increase perception of sweetness without adding sugar or other natural or artificial sugar-substitute.

### Experimental Procedures

Plant material. Commercial tomato seeds were obtained from Seeds of Change (Santa Fe, N. Mex.), Totally Tomatoes (Randolph, Wis.) or Victory Seed Co. (Molalla, Oreg.). Most varieties selected were described as heirloom, open-pollinated varieties. Plants were grown in the field at the University of Florida North Florida Research and Education Center-Suwannee Valley in the spring or fall seasons or the greenhouse at Gainesville, FL. Supermarket tomatoes were obtained from a local supermarket in Gainesville, Fla.

Biochemical analysis. Volatile collection was performed as described (16). Volatile compound identification was determined by GC-MS and co-elution with known standards (Sigma-Aldrich, St. Louis, Mo.). Sugars, acids and Brix were determined as described in (13).

Sensory analysis. Fully ripe fruit were harvested, and used for taste panels. A random subset of fruit was used for biochemical analysis. Three biological replicates, each consisting of 2-20 fruit (depending on fruit size), were assayed for each variety. A group of 170 tomato consumers (64 male, 106 female) were recruited to evaluate all the varieties. Panelists were between the ages of 18 and 78 with a median age of 22. Panelists self-classified themselves as 101 White/Caucasian, 14 Black/African-American, 32 Asian/Pacific and 25 Other. An average of 85 (range of 66-95) of these panelists evaluated between 4-6 varieties in a session. All panelists went through a training session to familiarize them with the scaling and procedures. Tomatoes were sliced into wedges (or in halves for grape/cherry types) and each panelist was given two pieces for evaluation. Panelists took a bite of each sample, chewed and swallowed it, and rated overall liking and liking for texture. They then rated the perceived intensities of sweetness, sourness, saltiness, umami sensation, bitterness and overall tomato flavor. They were free to take as many bites as necessary to complete the assessments. They were instructed to take a bite of an unsalted cracker and a sip of water between samples. Samples were presented to the panelists in a randomized order. Hedonic ratings used the hedonic gLMS. This scale assesses the liking for tomatoes in the context of all pleasure/displeasure experiences: 0=neutral, −100=strongest disliking of any kind experienced, and +100=strongest liking of any kind experienced. Sensory intensity ratings used the gLMS (7, 8, 19).This scale assesses taste and flavor sensations in the context of all sensory experience (7): 0=no sensation, 100=strongest sensation of any kind experienced. Both scales were devised to provide valid comparisons across subjects.

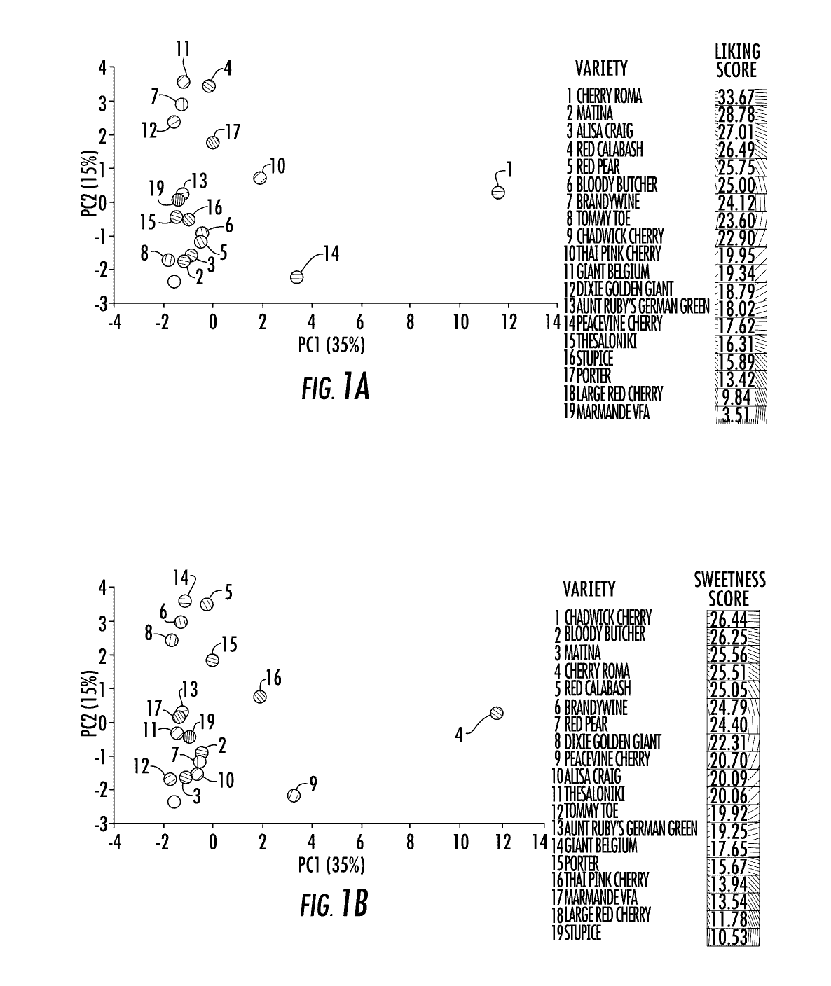

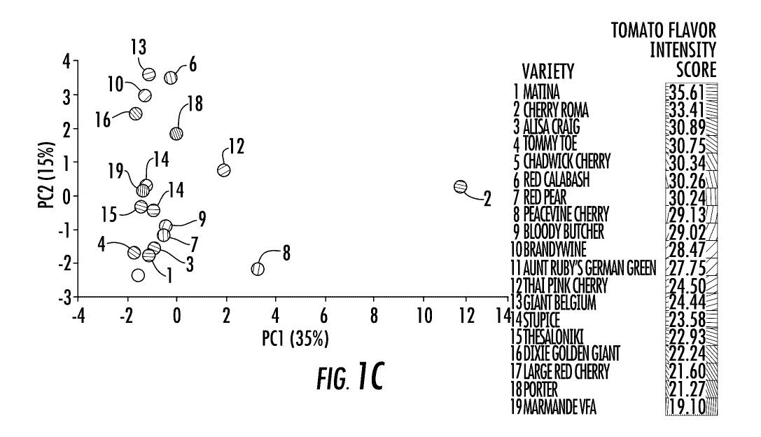

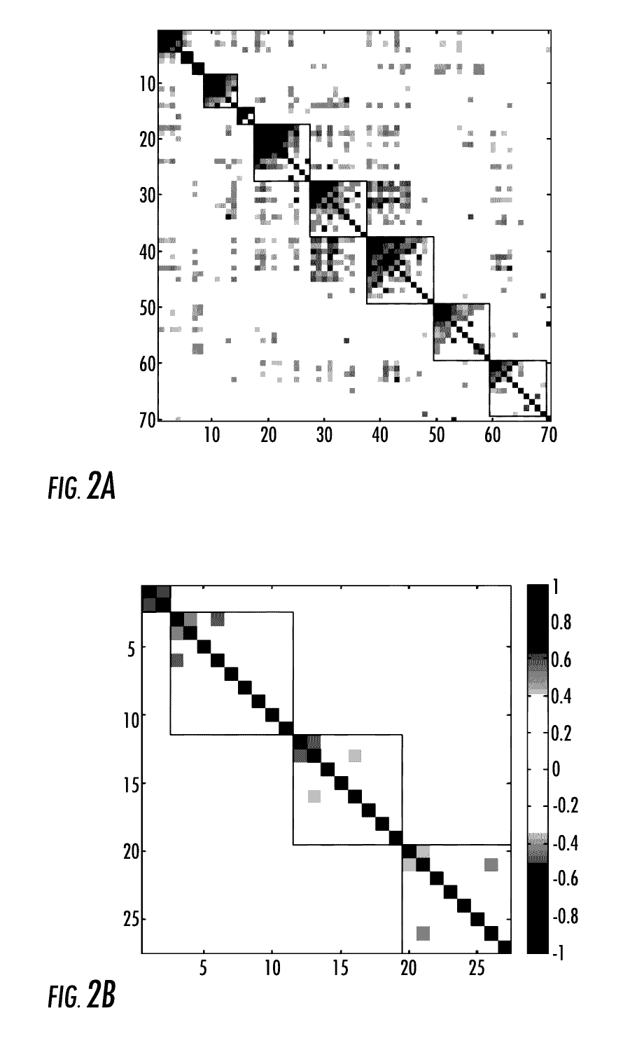

Statistical analysis. The 68 chemical compounds measured in this experiment were divided into six groups based upon biochemical properties: sugars, branched chain amino acids, lipids, carotenoids, phenolics, and acids. A small number of compounds for which biosynthetic pathways are not established were assigned to one of the six classes based upon their correlations with other classified compounds. All pairwise correlations among the set of 68 compounds were calculated. Correlation coefficients were sorted using Modulated Modularity Clustering (MMC) (9) as a visual aid for identifying compounds that are closely related in this sample (FIG. 1; Table 4). Biochemical groups were examined for compounds within the group that were highly correlated and compounds that were upstream in the relevant metabolic pathways were preferentially selected. The selection process resulted in 27 compounds (FIG. 2) that were representative of each of the 6 biochemical groups, and limited the amount of correlation between compounds. The set of 27 was examined using MMC and the result confirmed that the pairwise correlation had been reduced (FIG. 1). An exploratory factor analysis did not reveal obvious structure among the remaining compounds (data not shown). For example, the lipids did not all load together on a single factor.

Benzothiazole, butylacetate, cis-3-hexen-1-ol, citric acid, fructose, geranial, methional, 3-methyl-1-butenol, 2-methylbutanal, 1-octen-3-one, phenylacetaldehyde and trans,trans-2,4,decadienal were associated with flavor intensity in univariate models. 2-Butylacetate, cis-3-hexen-1-ol, citric acid, 3-methyl-1-buteno1,2-methylbutanal, 1-octen-3-one and trans, trans-2,4-decadienal were significant after accounting for fructose. Butylacetate, 4-carene, cis-3-hexen-1-ol, eugenol, fructose, geranial guaiacol, heptaldehyde, methional, 3-methyl-1-butenol, 2-methylbutanal, and phenylacetaldehyde all showed evidence for association with sweetness in univariate models, and geranial, 3-methyl-1-butenol,2-methylbutanal were significant after accounting for fructose. All analyses were performed in SAS v 9.2.

LoxC transgenic tomatoes. A transformation vector containing the constitutive FMV 35S promoter (22)a full-length antisense tomato 13-lipoxygenase LoxC (12) open reading frame was introduced into S. lycopersicum var. M82 (23). Total RNA from fruit tissue was extracted with a Qiagen (Valencia, Calif.) Plant RNeasy kit followed by DNase treatment to remove contaminating DNA. RNA levels from 200 ng total RNA were measured using an Applied Biosystems (Carlsbad, Calif.) PowerSYBR Green RNA to C_{T} 1-step kit with forward primer 5′-GCAATGCATCATGTGTGCTA (SEQ ID NO: 1) and reverse primer 5′-GTAAATGTCGAATTCCCTTCG (SEQ ID NO: 2). LoxC antisense tomato fruit RNA levels were 5% of control M82 fruit. Levels of the C6 volatiles hexyl alcohol, cis-3-hexenal, and cis-3-hexen-1-ol in LoxC antisense ripe fruit were less than 1% of control M82 fruit, whereas hexanal levels were less than 2% of control (Table 3, below). Homozygous T2 plants were used for sensory analysis. Transgenic and M82 control fruits were harvested at the ripe stage. Seeds and locular material were removed and the remainder of the fruits used for taste panels. Random fruits were used for biochemical analysis. Seventy panelists (39% male, 61% female) were given two tomato samples (control v. transgenic) and asked to evaluate the texture, flavor and to describe how much they liked the sample using a 9-point hedonic scale. They were subsequently asked to identify the one that they preferred. No sample was preferred over the other in any of these evaluations (α=0.05). In a triangle test set-up, 59 panelists (42% male, 58% female) were given three samples (a triple combination of control and transgenic sample) and asked to identify the non-matching sample. The number of correct responses (29) was significant at α=0.01 (data not shown).

### Results and Discussion

The chemical diversity within tomato varieties. Tomato flavors are primarily generated by a diverse set of chemicals including sugars (glucose and fructose), acids (citrate, malate and glutamate) and multiple, less well defined volatiles (4). Of the more than 400 volatiles that are detectable in fruits, only about 16 were predicted to contribute to tomato flavor based on their concentrations in fruit and odor thresholds (odor units)(3). To bring focus on which chemicals truly drive liking and establish a molecular blueprint of tomato flavor, a chemical profile of 278 samples was assembled, representing 152 heirloom varieties. These varieties mostly predate intensive breeding of modern commercial tomatoes (5). Levels of glucose, fructose, citrate, malate, and 28 volatiles were determined, most over multiple seasons (full data not included). Molecular studies indicate that there is a relatively low rate of DNA sequence diversity within the cultivated tomato, Solanum lycopersicum (6), consistent with a genetic bottleneck associated with two periods of domestication in Central America and Europe (5). The observed variation in volatile contents of as much as three thousand-fold across the cultivars was therefore somewhat surprising (Table 2, below).

This unexpectedly large chemical diversity within the heirloom population provided an unprecedented opportunity to examine the interactions between sugars, acids and volatiles with taste and olfaction. Sensory analyses were conducted with a consumer panel on a subset of the cultivars exhibiting the most chemical diversity. Panelists rated overall liking of each variety as well as the overall tomato flavor intensity, sweetness and sourness on sensory and hedonic versions of the general Labeled Magnitude Scale (gLMS)(7,8). Thirteen panels rated 66 different cultivars as well as supermarket-purchased varieties over three seasons (full taste panel data not presented here). Several cultivars were repeated in multiple seasons. Random samples of each set were removed for chemical analysis with the number of measured chemical attributes expanded to 68. The taste panels were performed over three seasons and fruit were either grown in the field or a greenhouse or purchased from a local supermarket were also tasted and analyzed. The full taste panel and biochemical data are too voluminous for reproduction here, but the analyzed results are presented in the data and tables below. The full data set is available in provisional patent application 61/637,362, and in Tieman, D., et al. The Chemical Interactions Underlying Tomato Flavor Preferences. Current Biology 22(11) pp. 1035-1039, both which are hereby incorporated by reference herein in their entirety.

Despite its popularity and important contribution to human nutrition, the commercially produced tomato is widely viewed as having poor taste and its flavor is a major source of consumer dissatisfaction. In contrast, there is a public perception that the term heirloom indicates great taste. Our results indicate that this is not always the case. Some heirlooms received liking scores well below those of supermarket-purchased tomatoes. The results with respect to supermarket tomatoes present an interesting contrast. They were highly variable even within a single season, possibly reflecting the variation in harvest, handling and storage among different lots.

The Relationship between Chemistry and Preferences.

Due to the large number of chemicals potentially influencing liking, a multivariate analysis of the data was performed. The attributes were initially partitioned into six groups based upon chemical properties and biosynthetic pathways: sugars, branched chain amino acids, fatty acids, carotenoids, phenolics, and acids. Compounds for which biosynthetic pathways are not established were assigned to one of the six classes based upon their correlations with other classified compounds (9). Groups of structurally related chemicals with known metabolic links were examined for compounds within each module that were highly colinear and compounds that were upstream in relevant metabolic pathways were preferentially selected. The selection process reduced the set to 27 compounds (Table 4). Flavor intensity was associated with 12 different compounds, seven of which were independently significant after accounting for fructose: 2-butylacetate, cis-3-hexen-1-ol, citric acid, 3-methyl-1-butenol, 2-methylbutanal, 1-octen-3-one and trans,trans-2,4-decadienal. Sweetness was associated with 12 compounds, eight of which overlap with those associated with flavor. At least three of these compounds were independent predictors of sweetness after accounting for fructose: geranial, 2-methylbutanal and 3-methyl-1-butanol.

Interactions between taste (sweetness) and retronasal olfaction are of considerable interest in the chemical senses (10). The present example provides evidence for these interactions in a natural food product: the tomato. Although sweetness of tomatoes is widely thought to result from sugars, volatiles proved to be important contributors to sweetness. Volatiles are perceived in two ways. They can be sniffed through the nostrils (orthonasal olfaction)or when foods containing volatiles and chewed and swallowed, volatiles are forced up behind the palate into the nasal cavity from the back (retronasal olfaction). Orthonasal olfaction is commonly called “smell;” retronasal olfaction contributes to “flavor.” Retronasal olfaction and taste interact in the brain. Commonly paired taste and retronasal olfactory sensations can become associated such that either sensation can induce the other centrally. Although instances of volatile-induced tastes of sweet, sour, bitter and salty have been observed, sweet is the most common (11). Multiple regression with sweetness as the dependent variable showed that the perception of tomato flavor (retronasal olfaction) made a significant contribution to sweetness after accounting for fructose (p<0.0001). Similarly, tomato flavor made a significant contribution to sourness that was independent of citric acid (p<0.001). Interestingly, one of the volatiles that contributed to this sourness, 2-methylbutanal, was negatively correlated with sweetness. This result provides some insight into how different tastes, induced centrally by volatiles, may interact.

The contributions, or lack thereof, for certain volatiles were somewhat unexpected. Prior lists of important tomato flavor volatiles were compiled based largely on odor unit values (3). These data indicate that some of these volatiles with high odor unit values, such as β-damascenone and phenylacetaldehyde, are not associated with tomato flavor intensity although they have historically been considered to be important contributors to flavor (3). Damascenone, in particular, was considered to be important to tomato flavor because of its extremely low reported odor threshold. Our results indicate that these volatiles should not be considered high priority targets for genetic manipulations.

Given the growing understanding of interactions between taste and retronasal olfaction, it was not unexpected that the correlations between certain volatiles and sugars contribute to the perceived sweetness of tomato fruits. Notably, the apocarotenoid geranial was positively correlated with sweetness. This aspect of the model was then independently validated; tomato mutants specifically deficient in carotenoid biosynthesis are deficient in apocarotenoid volatiles, including geranial, 6-methyl-5-hepten-2-one and β-ionone, but unaltered in sugars, acids and non-apocarotenoid volatiles. They are perceived as less sweet by consumers, validating the contribution of geranial to sweetness (13). Consistent with a model in which liking is a function of sweetness and flavor, apocarotenoid-deficient fruits are also significantly less liked by consumers. In a complementary experiment, Baldwin et al., (14) have shown that adding sugars or acids can alter the perception of tomato aroma volatiles.

The positive association of sweet perception with volatiles, such as geranial, suggests that consumer liking of tomatoes could be enhanced by increasing the concentrations of certain volatiles such as geranial in the fruit. The results also demonstrate that these volatiles could be used as a replacement for a portion of the sugars used in processed foods, thus reducing caloric content.

### Conclusions

The present example exploited the natural chemical variation within tomato to determine the chemical interactions that drive consumer liking. These data illustrate the challenge of understanding flavor, and consumer preferences in particular, in a natural product. Starting with a large set of chemically distinct volatiles, efforts can now be focused at genetic improvement on a smaller set than previously thought possible. Despite the large number of QTL that impact flavor chemicals (15-17), it should be possible with molecular-assisted breeding techniques to exploit the natural variation present within the heirloom population, combining desirable alleles of multiple genes to significantly improve flavor quality. It must be noted that not everyone will agree on the “best” tasting tomato. While consumer liking was averaged across the entire population for the present example, the data permit separation of preferences by age, sex, body mass and genetics (18). The collected data permit defining the parameters of a consensus best tomato in the United States, with the future possibility of optimization for specific groups. Taken together, the results provide new insights into flavor and liking and illustrate the flaws in a traditional approach based on odor units. The presence of a molecule, even at a relatively high level, does not mean that it significantly contributes to either flavor or liking. Models based on concentration and odor thresholds of individual volatiles cannot account for synergistic and antagonistic interactions that occur in complex foods such as a tomato fruit. Previous concepts of the most important volatile contributors to human food preferences based on odor units must be reevaluated.

### Example 2

### Multiple Regression Analysis of Tomato Liking Data

Application of multiple regression analysis to the tomato data from Example 1 above led to the discovery that a surprising amount of the sweetness of the tomato resulted from an independent contribution of the volatiles. Although the primary contribution of the perceived sweetness in tomato is contributed by the sugars, it was found that some volatiles and combinations contributed to the perception of sweetness independent of the amount of sugar in the tomato. Multiple regression analysis demonstrated that the flavor (retronasal olfaction) is contributing independently to the perceived sweetness.

### Multiple Regression Analysis

In conducting the multiple regression analysis on the tomato data set, the independent variables were the sugar content (glucose+fructose), and the flavor (indicated by the retronasal perception of volatiles), while the dependent variable was the perceived sweetness.

The results of the analysis are presented in Table 5, with volatile compounds having a score of less than about 0.05 considered as having a significant independent contribution to perceived sweetness, though compounds with a score greater than 0.05 may still contribute to perceived sweetness (e.g., geranial). Appendix A presents the results of the analysis of individual volatile compounds that demonstrated a contribution to induced sweetness.

As demonstrated by the data, both sugar and flavor were significant, independent contributors to sweetness.
Sugar: p<0.001
Flavor: p<0.001
   Based on this analysis: the sugars contribute 63.9% of the variance in sweetness, while flavor contributes 7.6%. This demonstrates sweet enhancement caused by the retronasal olfactory input from all of the volatiles in the tomato. While some earlier studies have recognized that certain specific individual volatiles can contribute to the perception of sweet taste, they had not identified many of the contributing volatiles demonstrated in the present disclosure as having a significant contribution (positive or negative) to the perception of sweet taste. Nor had previous studies considered how the individual flavor/taste effects might add. The additivity of the volatiles represents another mechanism for further enhancing or inhibiting perceived sweetness without the addition of sugars or other sugar substitutes.

Multiple regression analysis was also conducted using the volatiles. Although this does not take into consideration the known retronasal olfactory contribution to sweet, the analysis identified two additional significant volatiles: geranial and 2-methylbutanal. While geranial was a positive contributor to perceived sweetness (induced sweetness), 2-mehtylbutanal had an inhibitory effect (e.g., reduced perception of sweet taste).

Not only can the volatiles be used to enhance sweet, but since an increased sweet sensation can inhibit other tastes, such as bitter and sour, adding sweet-inducing volatiles in bitter or sour products can produce a central sweet that inhibits the sour or bitter taste (e.g., of medications).

### REFERENCES FOR EXAMPLES 1 AND 2, EACH OF WHICH IS INCORPORATED HEREIN BY REFERENCE

1. Moncrieff, R. W. (1967). The Chemical Senses. (London: Leonard Hill).

2. Small, D. M., Voss, J., Mak, Y. E., Simmons, K. B., Parrish,T., Gitelman, D. (2004). Experience-dependent neural integration of taste and smell in thehuman brain. J. Neurophysiol. 92, 1892-1903.

3. Buttery, R. G., Teranishi, R., Flath, R. A., Ling, L. C. (1987). Fresh tomato volatiles: composition and sensory studies. In: Teranishi R., Buttery R., Shahidi R., eds. Flavor chemistry: Trends and developments. (Amer. Chem. Soc. Symposium Series, Washington, D.C.). pp. 213-222.

4. Baldwin, E. A., Scott, J. W., Shewmaker, C. K, Schuch, W. (2000). Flavor trivia and tomato aroma: biochemistry and possible mechanisms for control of important aroma components. Hortsci. 35, 1013-1022.

5. Rick, C. M. (1995). Lycopersicon esculentum. In: Evolution of crop plants, Smartt J. and Simmonds N. W. eds. (Longman Scientific and Technical, Harlow UK). pp 452-457.

6. Jiménez-Gómez, J. M., Maloof, J. N. (2009). Sequence diversity in three tomato species: SNPs, markers, and molecular evolution. BMC Plant Biol.9, 85

7. Bartoshuk, L. M., Duffy, V. B., Fast, K., Green, B. G., Prutkin, J., Snyder, D. J.(2003). Labeled scales (e.g., category, Likert, VAS) and invalid across-group comparisons. What we have learned from genetic variation in taste. Food Qual. Pref. 14, 125-138.

8. Bartoshuk, L. M., Fast, K., Snyder,D. J.(2005). Differences in our sensory worlds: Invalid comparisons with labeled scales. Current Directions in Psychological Science 14, 122-125.

9. Stone, E. A., Ayroles, J. M. (2009). Modulated Modularity Clustering as an Exploratory Tool for Functional Genomic Inference. PLoS Genet 5(5): e1000479. doi:10.1371/journal.pgen.1000479.

10. Noble, A. C. (1996). Taste-aroma interactions. Trends Food Sci. Technol. 7, 439-444.

11. Salles, C. (2006) Odour-taste interactions in flavor perception. In: Voilley, A., Etievant, P. eds. Flavour in Food.(Woodhead Publishing Ltd., Cambridge, UK), pp 345-368.

12. Chen, G., Hackett, R., Walker, D., Taylor, A., Lin, Z., Grierson, D. (2004). Identification of a specific isoform of tomato lipoxygenase (TomloxC) involved in the generation of fatty acid-derived flavor compounds. Plant Physiol. 136, 2641-2651.

13. Vogel, J., Tieman, D. M., Sims, C., Odabasi, A., Clark, D. G., Klee, H. J.(20100. Carotenoid content impacts flavor acceptability in tomato (Solanum lycopersicum). J. Sci. Food Agric. 90, 2233-2240.

14. Baldwin, E. A., Goodner, K., Plotto, A. (2008). Interaction of volatiles, sugars, and acids on perception of tomato aroma and flavor descriptors. J. Food Sci. 73, S294-S307.

15. Causse, M., Saliba-Colombani, V., Buret, M., Lesschaeve, I., lssanchou, S.(2001). Genetic analysis of organoleptic quality in fresh market tomato. 2. Mapping QTLs for sensory attributes. Theor. Appl. Genet. 102, 273-283.

16. Tieman, D., Zeigler, M., Schmelz, E., Taylor, M., Bliss, P., Kirst, M., Klee H.(2006). Identification of loci affecting flavor volatile emissions in tomato fruits. J. Exp. Bot. 57, 887-896.

17. Mathieu, S., Dal Cin, V., Fei, Z., Li, H.,Bliss, P., Taylor, M. G., Klee, H. J., Tieman, D. M.(2008). Flavor compounds in tomato fruits: identification of loci and potential pathways affecting volatile composition. J. Exp. Bot. 60, 325-337.

18. Bartoshuk, L. M., Blandon, A., Bliss, P. L., Clark, D. G., Colquhoun, T. A., Klee, H. J., Moskowitz, H. K., Sims, C. A. Snyder, D. K., and Tieman, D. M. (2011). Better tomatoes through psychophysics. Chem. Senses, 31, A118.

19. Snyder, D. J., Puentes, L. A., Sims, C. A., Bartoshuk L. M. (2008). Building a better intensity scale: Which labels are essential? Chem. Senses 33, S142.

20. Rodriguez, G. R., Munos, S., Anderson, C., Sim, S.-C., Michel, A., Causse, M., McSpadden Gardener, B. B., Francis, D., van der Knaap, E. (2011). Distribution of SUN, OVATE, LC, and FAS in the Tomato Germplasm and the Relationship to Fruit Shape Diversity. Plant Physiol. 156, 275-285.

21. Robbins, M. D., Sim, S.-C., Yang, W., Van Deynze, A., Van der Knaap, E., Joobeur, T., Francis, D. M. (2011).Mapping and linkage disequilibrium analysis with a genome-wide collection of SNPs that detect polymorphismin cultivated tomato. J. Exp. Bot. 62, 1831-1845.

22. Richins, R. D., Scholthof, H. B., Shepard, R. J. (1987) Sequence of figwort mosaic virus DNA (caulimovirus group). Nucleic Acids Res.15, 8451-8466.

23. McCormick S, Niedermeyer J, Fry J, Barnason A, Horsch R, Fraley R. (1986) Leaf disc transformation of cultivated tomato (L. esculentum) using Agrobacterium tumefaciens. Plant Cell Rep. 5:81-84.

24. BARTOSHUK L M. TASTE MIXTURES-IS MIXTURE SUPPRESSION RELATED TO COMPRESSION. PHYSIOLOGY & BEHAVIOR Volume: 14 Issue: 5 Pages: 643-649 DOI: 10.1016/0031-9384(75)90193-6 Published: 1975

25. JONES F N; WOSKOW M H. ON INTENSITY OF ODOR MIXTURES. ANNALS OF THE NEW YORK ACADEMY OF SCIENCES Volume: 116 Issue: A2 Pages: 484-& D01:10.1111/j.1749-6632.1964.tb45078.x Published: 1964

26. Sjostrom L B & Cairncross S E (1955). Role of sweeteners in food flavor. In: Use of sugars and other carbohydrates in the food industry pp 108-113. Washington D.C., American Chem. Soc.

TABLE 2
Observed variation in flavor volatiles within
S. lycopersicumheirloom varieties.

| | | | Fold | |
|---|---|---|---|---|
| Volatile | High | Low | difference | Median |
| 1-penten-3-one | 9.37 | 0.17 | 55 | 1.18 |
| isovaleronitrile | 68.45 | 0.58 | 117 | 7.63 |
| trans-2-pentenal | 5.16 | 0.31 | 17 | 1.23 |
| trans-2-heptenal | 2.71 | 0.09 | 30 | 0.42 |
| isovaleraldehyde | 51.08 | 1.55 | 33 | 8.59 |
| 3-methyl-1-butanol | 184.46 | 3.20 | 58 | 27.26 |
| methional | 1.616 | 0.012 | 137 | 0.07 |
| isovaleric acid | 0.953 | 0.004 | 262 | 0.09 |
| 2-isobutylthiazole | 63.61 | 0.37 | 174 | 8.34 |
| 6-methyl-5-hepten-2-one | 20.07 | 0.17 | 120 | 3.38 |
| β-ionone | 0.396 | 0.008 | 47 | 0.05 |
| phenylacetaldehyde | 1.90 | 0.00 | 654 | 0.24 |
| geranylacetone | 28.96 | 0.03 | 1095 | 1.22 |
| 2-phenylethanol | 5.269 | 0.002 | 3142 | 0.05 |
| isobutyl acetate | 11.93 | 0.14 | 85 | 1.67 |
| cis-3-hexen-1-ol | 124.15 | 10.00 | 12 | 40.00 |
| 1-nitro-2-phenylethane | 2.59 | 0.02 | 149 | 0.25 |
| trans,trans-2,4- | 0.30 | 0.00 | 211 | 0.02 |
| decadienal | | | | |
| 2-methylbutanal | 14.66 | 1.14 | 13 | 3.47 |
| hexyl alcohol | 84.03 | 0.99 | 85 | 13.86 |
| guaiacol | 8.09 | 0.03 | 290 | 0.77 |
| hexanal | 381.05 | 15.55 | 25 | 88.65 |
| 1-octen-3-one | 0.312 | 0.017 | 18 | 0.07 |
| cis-3-hexenal | 399.66 | 8.29 | 48 | 71.09 |
| methylsalicylate | 14.16 | 0.00 | 3354 | 0.40 |
| trans-2-hexenal | 48.01 | 0.39 | 123 | 3.54 |
| β-damascenone | 0.1733 | 0.0020 | 86 | 0.01 |
| 2-methyl-1-butanol | 115.69 | 1.93 | 60 | 15.08 |

TABLE 3
C6 volatile emission in fruit of control (M82) and LoxC antisense
plants. Volatile emissions (ng gFW⁻¹ h⁻¹) from ripe control
(M82) and transgenic (LoxCAS) fruits were measured.

| | cis-3- | | cis-3-hexen-1- | | |
|---|---|---|---|---|---|
| | hexenal | hexanal | ol | hexyl alcohol | hexyl acetate |
| M82 | 139 ± 55 | 202 ± 43 | 59.0 ± 14.6 | 38.7 ± 11.2 | 2.61 ± 0.85 |
| LoxCAS-0966 | 0.6 ± 0.1 | 1.9 ± 0.3 | 0.07 ± 0.01 | 0.08 ± 0.01 | 0.014 ± 0.002 |

TABLE 4
List of the 68 chemical measurements used in flavor analysis.
Correlation coefficients were sorted into 11 modules using
MMC (Stone et al., 2009). The 27 individual compounds used
in the multivariate models are shown in bold.

| | | | Average | |
|---|---|---|---|---|
| Chemical | Module | EntryIndex | Degree | Degree |
| glucose | 1 | 4 | 0.79652 | 0.87055 |
| fructose | 1 | 5 | 0.79652 | 0.85714 |
| Solublesolids | 1 | 1 | 0.79652 | 0.78411 |
| Sugar:acidratio | 1 | 8 | 0.79652 | 0.67427 |
| salicylaldehyde | 2 | 61 | 0.70129 | 0.70129 |
| eugenol | 2 | 70 | 0.70129 | 0.70129 |
| cis-3-hexenylacetate | 3 | 58 | 0.69388 | 0.69388 |
| hexylacetate | 3 | 59 | 0.69388 | 0.69388 |
| phenylacetaldehyde | 4 | 28 | 0.6015 | 0.70973 |
| 2-phenylethanol | 4 | 31 | 0.6015 | 0.67879 |
| benzylcyanide | 4 | 63 | 0.6015 | 0.67478 |
| 1-nitro-2-phenylethane | 4 | 33 | 0.6015 | 0.5788 |
| benzaldehyde | 4 | 55 | 0.6015 | 0.49608 |
| nonylaldehyde | 4 | 62 | 0.6015 | 0.47085 |
| Citric:malicratio | 5 | 7 | 0.5326 | 0.68885 |
| Citric acid | 5 | 2 | 0.5326 | 0.45591 |
| Malic acid | 5 | 3 | 0.5326 | 0.45304 |
| isovaleronitrile | 6 | 12 | 0.48128 | 0.61834 |
| trans-3-hexen-1-ol | 6 | 49 | 0.48128 | 0.60896 |
| 1-nitro-3-methylbutane | 6 | 53 | 0.48128 | 0.58995 |
| 3-methyl-1-butanol | 6 | 13 | 0.48128 | 0.56904 |
| isovaleraldehyde | 6 | 9 | 0.48128 | 0.54462 |
| heptaldehyde | 6 | 52 | 0.48128 | 0.50809 |
| 2-isobutylthiazole | 6 | 27 | 0.48128 | 0.45552 |
| Isovalericacid | 6 | 19 | 0.48128 | 0.43208 |
| Glutamic acid | 6 | 6 | 0.48128 | 0.27246 |
| benzylalcohol | 6 | 60 | 0.48128 | 0.21373 |
| geranial | 7 | 69 | 0.43585 | 0.57172 |
| β-cyclocitral | 7 | 65 | 0.43585 | 0.54336 |
| 6-methyl-5-hepten-2-one | 7 | 26 | 0.43585 | 0.53271 |
| β-ionone | 7 | 37 | 0.43585 | 0.51036 |
| 6-methyl-5-hepten-2-ol | 7 | 57 | 0.43585 | 0.49241 |
| neral | 7 | 66 | 0.43585 | 0.4174 |
| methional | 7 | 23 | 0.43585 | 0.35934 |
| hexanal | 7 | 18 | 0.43585 | 0.35458 |
| geranylacetone | 7 | 36 | 0.43585 | 0.35061 |
| 4-carene | 7 | 56 | 0.43585 | 0.22603 |
| trans-2-heptenal | 8 | 24 | 0.43028 | 0.60483 |
| 2,5-dimethyl-4-hydroxy-3- | 8 | 29 | 0.43028 | 0.57533 |
| furanone | | | | |
| 1-pentanol | 8 | 44 | 0.43028 | 0.5473 |
| trans-2-pentenal | 8 | 15 | 0.43028 | 0.50386 |
| cis-3-hexen-1-ol | 8 | 21 | 0.43028 | 0.49881 |
| 1-penten-3-one | 8 | 11 | 0.43028 | 0.47961 |
| hexylalcohol | 8 | 22 | 0.43028 | 0.44961 |
| cis-4-decenal | 8 | 64 | 0.43028 | 0.38099 |
| trans,trans-2,4- | 8 | 34 | 0.43028 | 0.35884 |
| decadienal | | | | |
| trans-2-hexenal | 8 | 20 | 0.43028 | 0.35151 |
| 1-octen-3-one | 8 | 25 | 0.43028 | 0.29723 |
| p-anisaldehyde | 8 | 68 | 0.43028 | 0.11544 |
| isobutylacetate | 9 | 16 | 0.36278 | 0.53598 |
| 2-methylbutylacetate | 9 | 51 | 0.36278 | 0.5311 |
| propylacetate | 9 | 41 | 0.36278 | 0.46039 |
| 2-methyl-2-butenal | 9 | 42 | 0.36278 | 0.37115 |
| butylacetate | 9 | 47 | 0.36278 | 0.3455 |
| isopentylacetate | 9 | 50 | 0.36278 | 0.32623 |
| 2-methyl-1-butanol | 9 | 14 | 0.36278 | 0.32153 |
| prenylacetate | 9 | 54 | 0.36278 | 0.29625 |
| 3-methyl-2-butenal | 9 | 46 | 0.36278 | 0.29397 |
| 2-butylacetate | 9 | 43 | 0.36278 | 0.14571 |
| cis-2-penten-1-ol | 10 | 45 | 0.2872 | 0.46808 |
| 1-penten-3-ol | 10 | 38 | 0.2872 | 0.41541 |
| cis-3-hexenal | 10 | 17 | 0.2872 | 0.35648 |
| 3-pentanone | 10 | 39 | 0.2872 | 0.32567 |
| 3-methyl-1-pentanol | 10 | 48 | 0.2872 | 0.27314 |
| 2-ethylfuran | 10 | 40 | 0.2872 | 0.26516 |
| guaiacol | 10 | 30 | 0.2872 | 0.23619 |
| benzothiazole | 10 | 67 | 0.2872 | 0.2024 |
| methylsalicylate | 10 | 32 | 0.2872 | 0.19102 |
| β-damascenone | 10 | 35 | 0.2872 | 0.13845 |
| 2-methylbutanal | 11 | 10 | 0 | 0 |

TABLE 5
Multiple regression analysis for volatiles identified in tomatoes.
For p < about.05, the volatile makes a contribution to
sweetness that is independent of the measures of sugar.

| Volatile | t | p | Odor description |
|---|---|---|---|
| neral | 2.716 | 0.008 | lemon |
| 4-carene | 2.635 | 0.01 | dry, woody, sage, thyme |
| isopentyl acetate | 2.303 | 0.024 | juicy fruit, banana, pear |
| 3-methyl-1-butanol | 2.109 | 0.038 | whiskey |
| 6-methyl-5-hepten-2-ol | 2.118 | 0.038 | oily green coriander |
| isovaleric acid | 2.039 | 0.045 | cheesy or sweaty |
| 2-methylbuteraldehyde | −1.937 | 0.056 | chocolate |
| ethyl vinyl ketone | 1.623 | 0.109 | earthy, green, pungent |
| geranial | 1.469 | 0.146 | |
| trans-2-heptenal | 1.458 | 0.149 | |
| hexanal | 1.39 | 0.169 | |
| propyl acetate | 1.38 | 0.172 | |
| geranylacetone | 1.297 | 0.199 | |
| trans-2-pentenal | 1.265 | 0.21 | |
| 2,5-dimethyl-4-hydroxy- | 1.224 | 0.225 | |
| 3(2H)-furanone | | | |
| p-anisaldehyde | 1.194 | 0.236 | |
| beta-cyclocitral | 1.186 | 0.239 | |
| methional | 1.177 | 0.243 | |
| cis-3-hexenal | 1.168 | 0.246 | |
| nonyl aldehyde | 1.148 | 0.255 | |
| β-ionone | 1.135 | 0.26 | |
| trans,trans-2,4-decadienal | 1.106 | 0.272 | |
| 2-methylbutyl acetate | 1.043 | 0.3 | |
| cis-3-hexen-1-ol | 1.037 | 0.303 | |
| 1-octen-3-one | 1.016 | 0.313 | |
| benzyl alcohol | −1.015 | 0.314 | |
| β-damascenone | 1.012 | 0.315 | |
| 1-pentanol | 0.924 | 0.358 | |
| unknown | 0.862 | 0.391 | |
| isovaleraldehyde | 0.837 | 0.405 | |
| hexyl alcohol | 0.835 | 0.406 | |
| trans-3-hexen-1-ol | 0.835 | 0.406 | |
| 2-methyl-1-butanol | 0.805 | 0.423 | |
| guaiacol | 0.804 | 0.424 | |
| benzothiazole | 0.714 | 0.477 | |
| sec-butyl acetate | 0.707 | 0.482 | |
| isovaleronitrile | 0.674 | 0.503 | |
| benzyl cyanide | −0.605 | 0.547 | |
| cis-4-decenal | 0.582 | 0.562 | |
| 6-methyl-5-hepten-2-one | 0.551 | 0.583 | |
| prenyl acetate | −0.542 | 0.59 | |
| 3-methyl-2-butenal | 0.53 | 0.598 | |
| 2-isobutylthiazole | 0.528 | 0.599 | |
| eugenol | 0.528 | 0.599 | |
| cis-2-penten-1-ol | 0.522 | 0.603 | |
| 1-penten-3-ol | 0.488 | 0.627 | |
| isobutyl acetate | 0.433 | 0.666 | |
| 2-phenyl ethanol | −0.433 | 0.666 | |
| hexyl acetate | 0.407 | 0.685 | |
| cis-3-hexenyl acetate | 0.346 | 0.73 | |
| 2-ethylfuran | −0.273 | 0.786 | |
| butyl acetate | 0.271 | 0.787 | |
| phenylacetaldehyde | −0.268 | 0.79 | |
| 3-methyl-1-pentanol | 0.267 | 0.79 | |
| 2-methyl-2-butenal | 0.223 | 0.825 | |
| heptaldehyde | 0.187 | 0.852 | |
| 3-pentanone | −0.16 | 0.873 | |
| salicylaldehyde | 0.13 | 0.897 | |
| methylsalicylate | 0.121 | 0.904 | |
| benzaldehyde | 0.051 | 0.959 | |
| trans-2-hexenal | 0.051 | 0.96 | |

### Example 3

### Strawberry Flavor, Volatile Compounds, Seasonal Influence, and their Effect on Sensory Perception

Sensory input of flavor includes primarily the chemical senses of taste and retronasal-olfaction, which have been shown to project to the same brain area for integration (Small 2004), as well as to tactician (Prescott 2004). Modern ripe strawberry fruit is characterized by large size (Whitaker 2011), red color (Hong and Wrolstad 1990), reduced firmness (Brummell and Harpster 2001), distinct aroma (Ulrich 1997), and sweet fruity flavor (Schiebrle and Hoffman 1997); all of which is the result of a highly dynamic (Fiat 2008), molecularly driven (Aharonic 2000), environmentally malleable (Watson 2002) development of a biochemically complex (Zhang 2011, Maarse 1991) prized fruit. Genetic and environmental variation of strawberry was exploited for psychophysical analysis by simultaneously assaying fruit for: hedonic and sensory measures; biochemical inventory of volatile compounds, sugars, and organic acids; and physical measures of TA, SSC, color, and firmness. A wide range of liking, texture, sweetness, and strawberry flavor were derived from consumer panels, which is supported by the diversity in flavor attributes quantified. Relationships to likability have been constructed based upon sugar and volatile influence on perceived intensity of sweetness and flavor, respectively and combinatorial. Seasonal trends of a subtropical winter productions system are addressed, particularly in the chemical constituents shown to contribute to hedonic and sensory responses.

### Introduction

As early as 1955 the food industry was noting the intensification of volatile sensations by the addition of small amounts of sweeteners (Sjöström and Cairncross 1955). Recognition of the ability of volatiles to enhance taste came later; the effects were small and even called an “illusion” initially (Murphy et al. 1977; Burdach et al. 1984). Later studies showed volatile specificity (Frank and Byram 1988). Over the last thirty years volatiles associated with sweetness include: citral (Murphy and Cain 1980), amyl acetate (banana) (Burdach et al. 1984), whole strawberry (Frank et al. 1989; Stevenson et al. 1999), peach (Cliff and Noble 1990), pineapple, raspberry and maracuja (passion fruit) (Stevenson et al. 1999), lychee (Stevenson et al. 1999), vanilla (Lavin and Lawless 1998; Labbe et al. 2006), caramel (Prescott 1999; Stevenson et al. 1999) and maltol (Bingham et al. 1990; Kato 2003).

Modern fully ripe strawberry fruit is characterized by its large size (Whitaker 2011), vibrant red color (Hong and Wrolstad 1990), reduced firmness (Brummell and Harpster 2001), distinct aroma (Ulrich 1997), and sweet fruity flavor (Schieberle and Hoffman 1997). The three stages of non-climacteric, auxin dependent strawberry fruit development; division, expansion and ripening, involve gains in diameter and fresh weight; during which color shifts from green to white to dark red in about forty days after anthesis (Zhang 2011). Ripening of strawberry fruit results in the accumulation of multiple sugars and organic acids, culminating with peak volatile emission (Menager 2004).

Flavor is the perceptual and hedonic response to the synthesis of sensory signals of taste, odor, and tactile sensation (Prescott 2004). The senses of taste and olfaction directly sample the chemicals present in food; sugars, acids, and volatiles. These metabolites are primary sensory elicitors of taste and olfaction which attenuate the perception and hedonics of flavor. A role developing experimentation of 36 attributes of strawberry indicated sweetness and complex flavor as consistent favorable attributes of the “ideal” strawberry experience (Colquhoun 2011). Thus a ripe strawberry is metabolically poised to elicit the greatest sensory and hedonic responses from consumers.

During strawberry fruit development sucrose is continually imported from photosynthetic tissue. A consistently high sucrose invertase activity contributes to carbon sink strength in all developmental stages of fruit (Basson 2010). Delivered sucrose is hydrolyzed into glucose and fructose and these three carbohydrates constitute the major soluble sugars of ripe strawberries, a result of their continual accumulation during fruit development (Fait 2008). In fact, an approximately 150% increase in their sum during ripening has been observed (Basson 2010, Menager 2004). The influx of carbon initiates a complex network of primary and secondary metabolism specific to ripening strawberry fruit (Fait 2008),

Ripening of strawberry is metabolically active, illustrated by the late accumulation of the predominant red pigment, pelargonidin 3-glucoside (Hoffman 2006), an anthocyanin synthesized from the primary metabolite phenylalanine (Fait 2008). The dynamics of fruit development are even further exemplified by the nearly 250 cDNAs with significant differential expression (177 up, 70 down) in red compared to green fruit (Aharoni 2000). One up regulated gene, Polygalacturonase 1 (FaPG1), contributes to fruit softening (Quesada 2009) by aiding in catalytic cell wall disassembly (Trainottie 1999). Reduced firmness is also attributed to dissolution of middle lamella, which functions in cell-to-cell adhesion (Brummel and Harpster 2001). Active shifts in transcription throughout ripening result in metabolic network reconfiguration altering the chemical and physical properties.

Metabolic profiling has determined alkanes, alcohols, aldehydes, anthocyanins, ketones, esters, and furanones increase in concentration during fruit development, most likely due to accumulation of sugars, organic acids, and fatty acids as well as the consumption of amino acids (Zhang 2011). Many of these chemical classes serve as precursors to volatile synthesis (Perez 2002), thus facilitating a metabolic flux through biosynthetic pathways for increased and diverse volatile emissions in ripe strawberry fruit, characterized by furanones, acids, esters, lactones, and terpenes (Menager 2004). Over 350 volatile compounds have been identified across Fragaria (Maarse, 1991), however within a single fruit, far fewer compounds are detected and even less contribute to perceived aroma.

A cross comparison of five previous studies which analyzed strawberry volatiles depicts the lack of agreement in defining chemical constituents of strawberry aroma, as each source considers a highly variable subset of total volatiles (Schieberle and Hofmann 1997, Ulrich 1997, Hakala 2002, Jetti 2007, Olbricht 2008). Mutual volatiles across studies include ethyl butyrate, methyl butyrate, ethyl caproate, methyl caproate, linalool, 2-methylbutyric acid, and 2,5-dimethyl-4-methoxy-2,3-dihydrofuran-3-one (DMF) and are the current consensus of integral strawberry aroma compounds. Comparisons of consumer preference among a variety of fresh strawberries and their volatile profiles has described less preferable varieties as possessing less esters, more decalactones and hexanoic acid (Ulrich 1997). The extent of volatile phenotype diversity is great enough across strawberry genotypes to not only be discerned but be preferred.

The horticulture of subtropical strawberry production in Florida allows continual harvest of ripe fruit from late December through March. The mild winter production environment effects fruit quality as gradually increasing temperature beginning in mid-January result in late season decline of SSC (MacKenzie 2011). In fact, increased temperature is known to be responsible for increased fruit maturation rate and decreased SSC (MacKenzie and Chandler 2008) independent of flowering date. Previous work has also identified variability of SSC, as well as TA and multiple classes of volatile compounds across harvest dates (Joaquand 2008). The complex fruit biochemistry which is variably affected by genetic, environmental, and developmental factors coupled with individual's perceptional biases of flavor has made defining strawberry flavor cumbersome.

The present example utilizes the genetic and within-season variability of fruit quality to provide as many unique strawberry experiences as possible to a large sample of consumers. Fifty-four fully ripe unique strawberry samples (cultivar X date) were assayed for TA, pH, SSC, firmness, internal and external color, as well as the concentrations of malic acid, citric acid, glucose, fructose, sucrose, and eighty one volatile compounds (chemical structures of some of the volatile compounds are illustrated in FIG. 3), all of which potentially contribute to fruit quality. Simultaneously, a subset of tissue was evaluated for perceived sensory intensity of sourness, sweetness, and strawberry flavor and the hedonic responses to liking of texture and overall likability by consumer panelists across the 2011 and 2012 winter seasons in Florida. Data sets were analyzed for harvest week effects, gross variation of strawberry experiences, and using psychophysics to determine factors influencing hedonics and sensory perception of strawberry fruit consumption. The full tasting panel and chemical analysis results are not presented here, but additional discussion is included in provisional patent application 61/781,254, which is hereby incorporated by reference in its entirety.

### Results

The inventory of fifty-four fully ripe unique strawberry samples (35 cultivars, 12 harvests, 2 seasons) were assayed for titratable acidity (TA), pH, soluble solids content (SSC), firmness, as well as the concentrations of malic acid, citric acid, glucose, fructose, sucrose, and quantity of eighty-one volatile compounds (full data set not shown). Cluster analysis of relative chemical composition of all samples and derived hierarchy of both cultivar and metabolite relatedness was also conducted.

### Seasonal Influence

Ranges of weather parameters were consistent between both 2011 and 2012 season, except for slightly more precipitation during late January of 2011 (data not shown). Solar radiation, minimum and maximum temperature all increased gradually during a season and maintained similar slopes in both seasons. Relative humidity however remained fairly constant during and across seasons. Increasing solar radiation and temperature during the season likely altered whole plant physiology and more specifically fruit biochemistry during development and ripening effecting fruit quality.

One manifestations of these environmental changes is the negative relationship between soluble solids content (SSC) and harvest week (R²=0.44). The sugars glucose, fructose, and sucrose were enzymatically quantified, and their sum (total sugar) was strongly positively correlated at an R²=0.73 to SSC and R²=0.29 to harvest week. Biochemical differences as a result of harvest week include a reduction in sucrose concentration across harvests (R²=0.35); however, glucose and fructose did not show as strong of an effect (data not shown). Total volatile concentrations also decrease as the seasons progress (R²=0.34) (data not shown), which is likely due to volatile emission's dependence of surplus carbon in the form of sucrose (R²=0.31), but not glucose or fructose. The simultaneous waning of sugars, especially sucrose, and volatiles is perceivable, in that overall likability decreases (R²=0.419) as the season progresses (data not shown).

The hedonic response to strawberry samples was measured as overall likability using the hedonic general labeled magnitude scale (gLMS) that ranges from −100 to +100, i.e. least to most pleasurable experience (full data not shown). The strawberry with the highest overall likability was a Festival sampled on the first harvest of 2012, which elicited an average hedonic response of 36.6. The lowest, a late season Red Merlin (season 1, harvest 5), was scored at 13.3 while the sample set median was 23.5. The benchmarking Festival sample contained 3.5 fold more sucrose and 27% more total volatiles than the least pleasurable fruit, demonstrating the disparity between early and late season fruit quality and its effect on consumers.

The genetic and environmental variation in strawberry samples provides a wide range of metabolite profiles, which act individually or collectively to influence the hedonics and perception of strawberry consumption. The developmental complexity of strawberry is greatly altered by environmental factors such as light levels and harvest dates, which results in significantly different flavor associated metabolite profiles (Watson 2002). Consumer, physical, and chemical variation observed across harvests could be result of seasonally induced environmental conditions or progression of plant life cycle and their systematic influence. A negative effect (R²=0.419) in likability was observed as the season progressed indicating a possible environmental influence on quality of fruit.

### Driving Likability

Nearly 70% of sweetness intensity is accounted for by the sum of sucrose, glucose, and fructose; however, other metabolites were also demonstrated to contribute to sweetness perception. The hedonic qualities of strawberry are collectively positive, with adverse texture having a strong effect. The sensory perceptions of sweetness and flavor have a higher magnitude than sourness, marking their greater perception intensity. Functional genomic work has characterized strawberry enzymes responsible for the synthesis of furaneol (Raab 2006), methoxyfuraneol (Lavid 2002), multiple esters (Aharoni 2004, Cumplido-Laso 2012), linalool and nerolidol (Aharoni 2004).

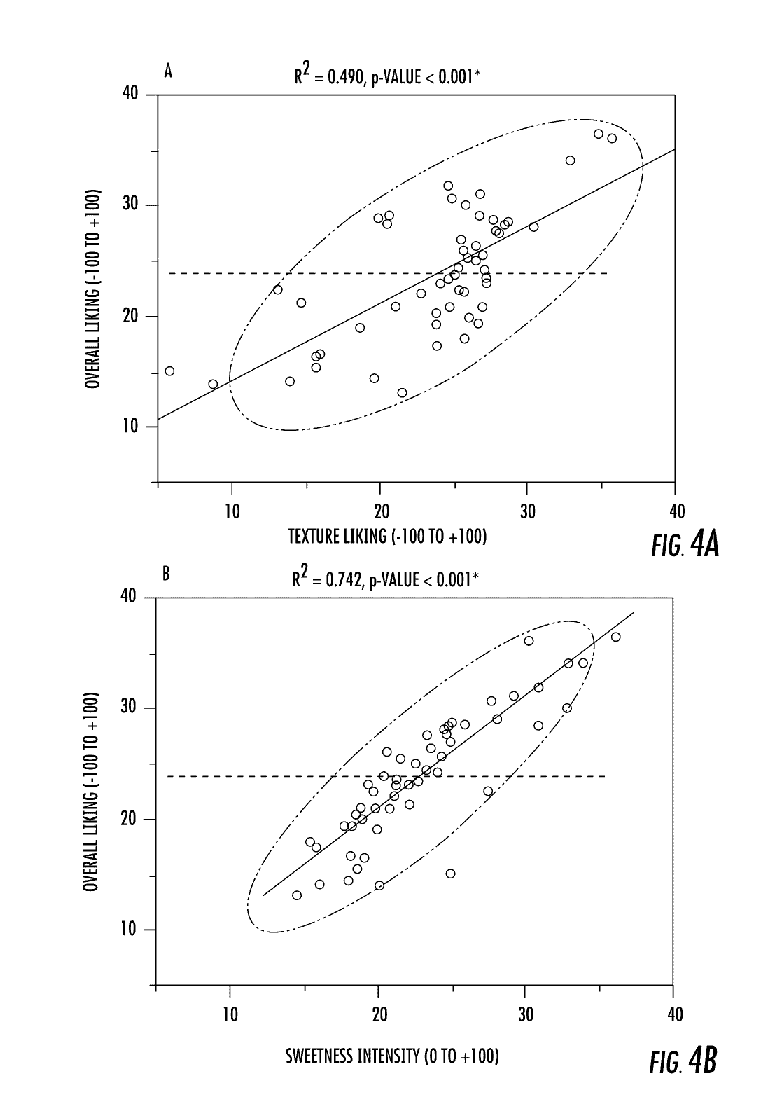

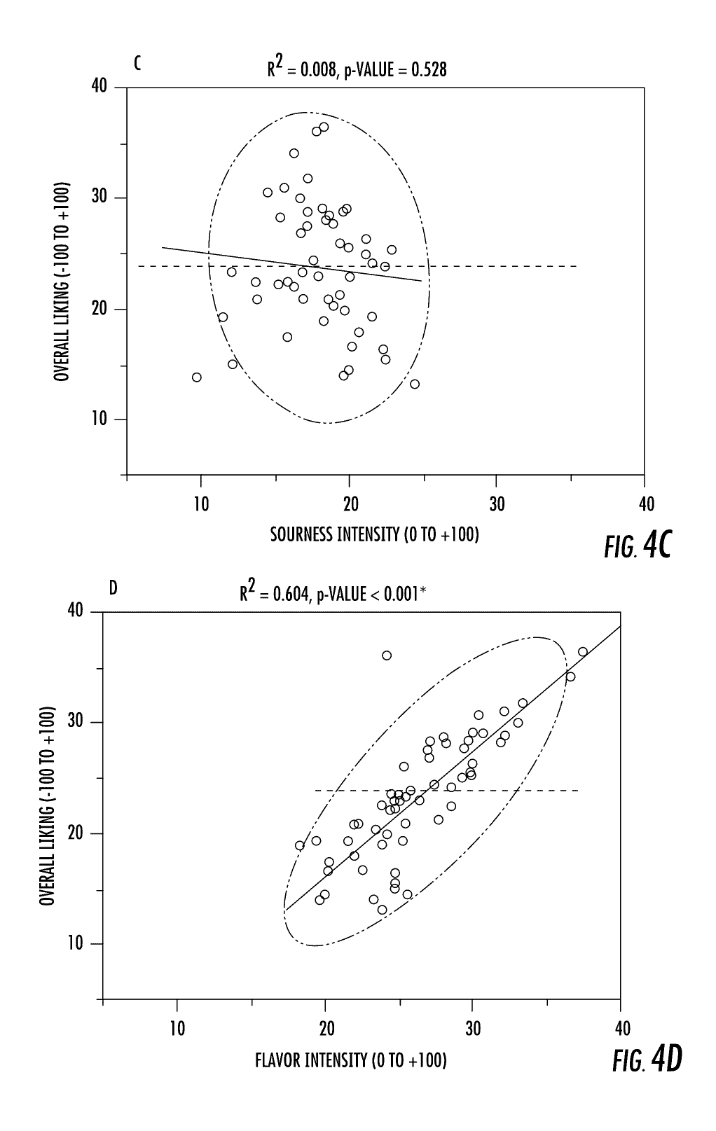

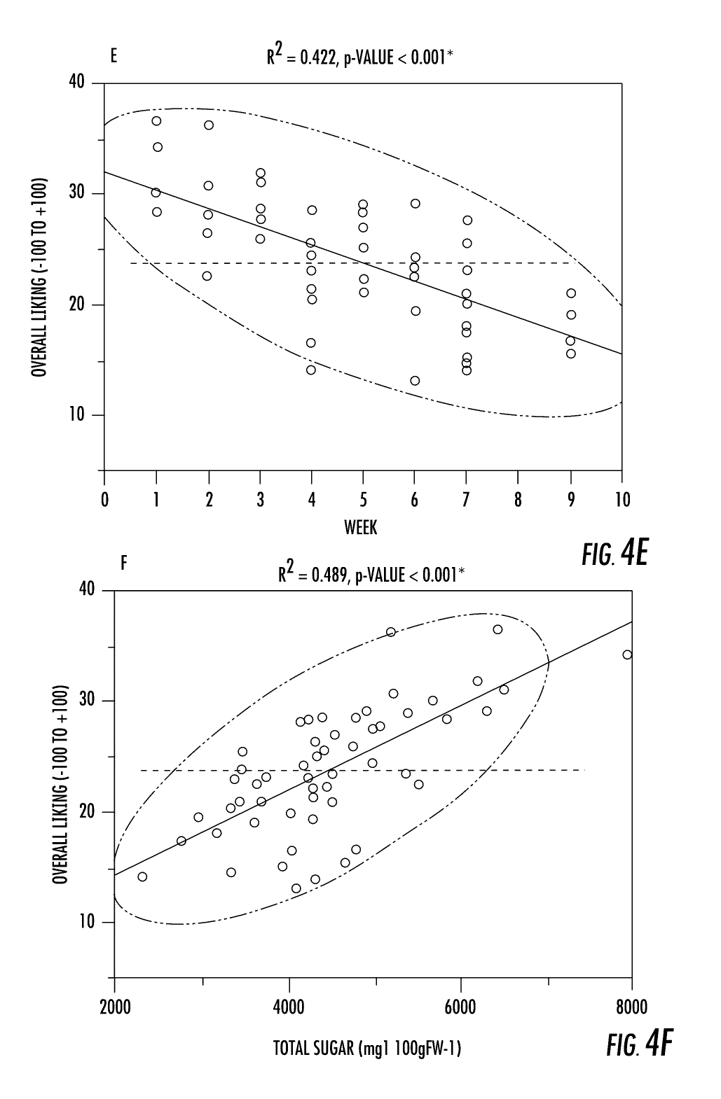

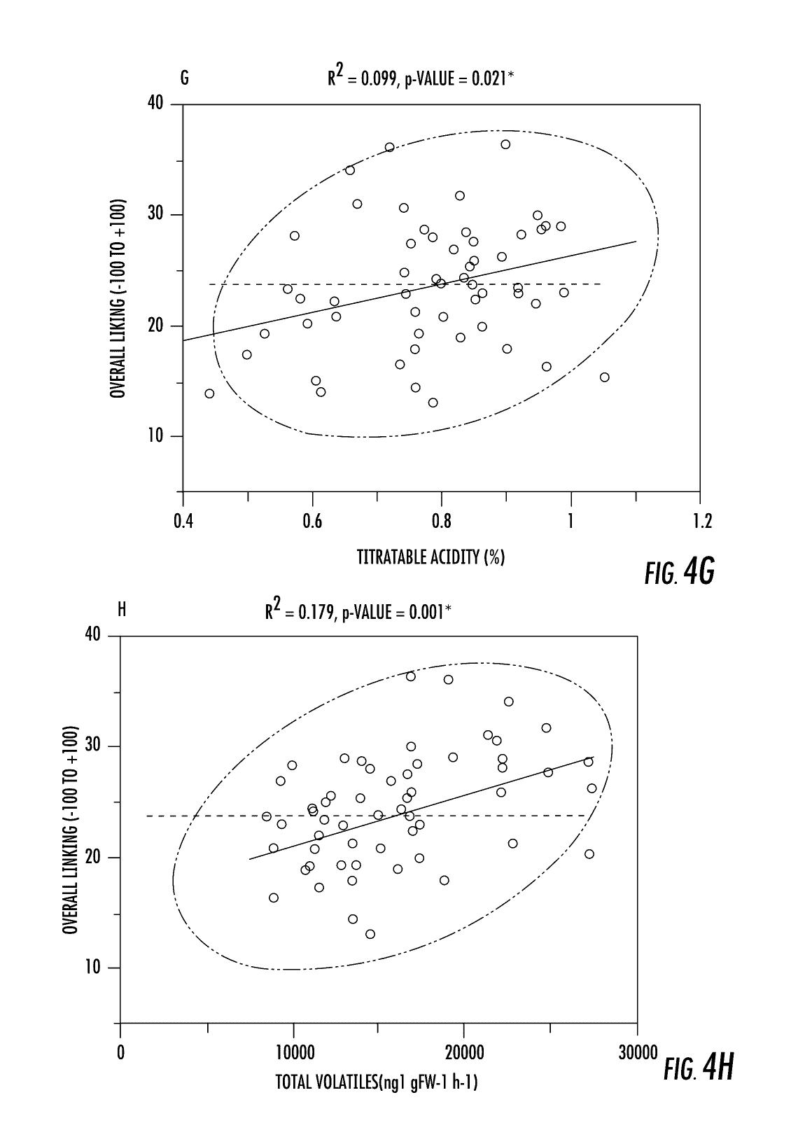

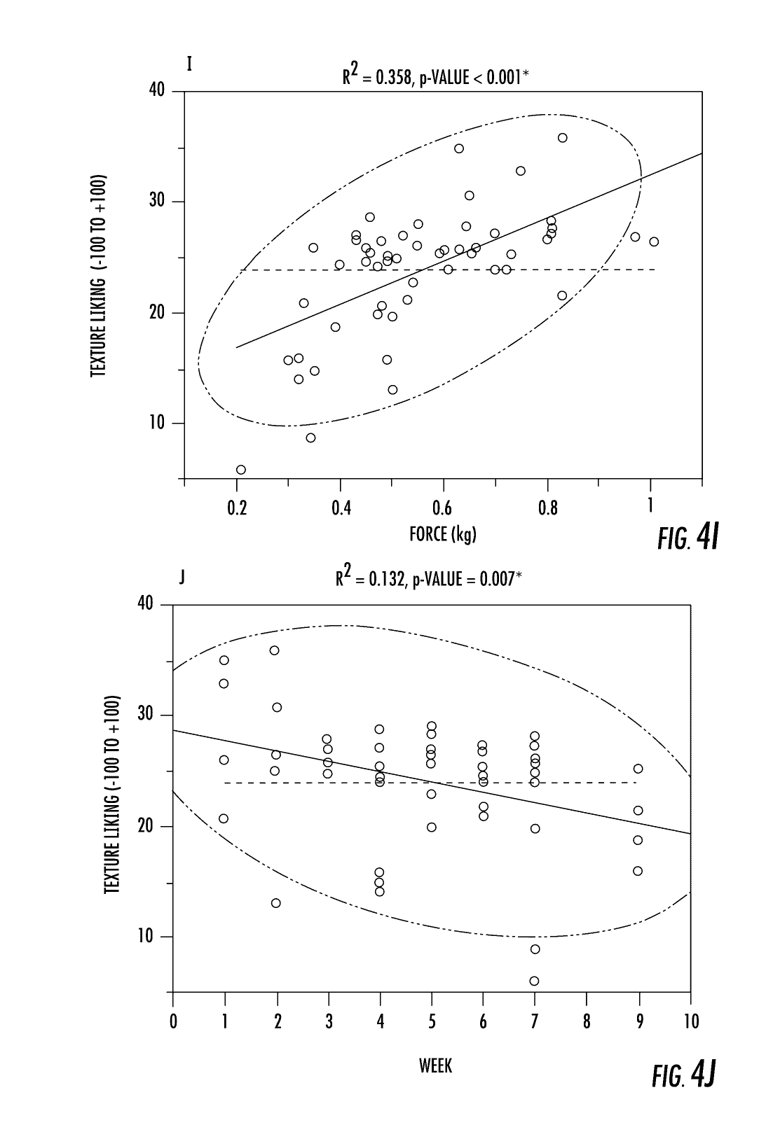

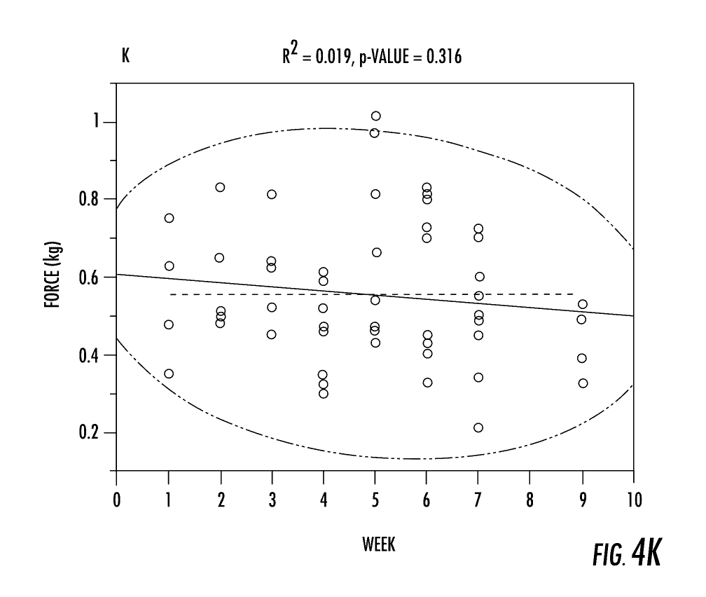

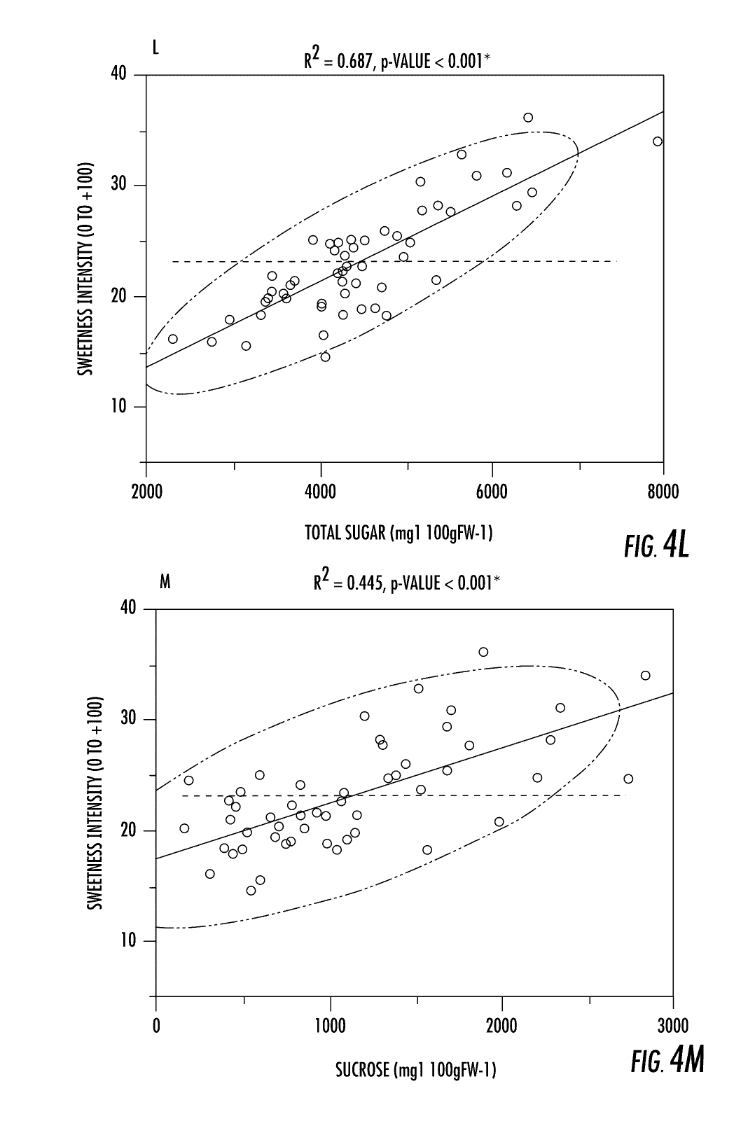

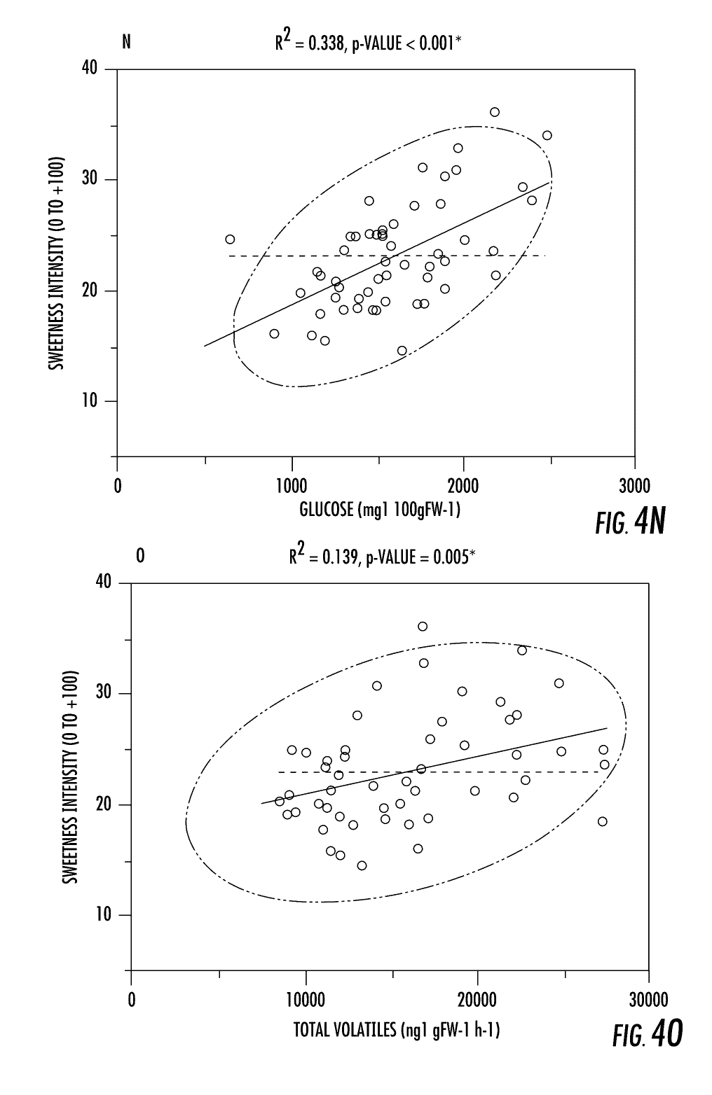

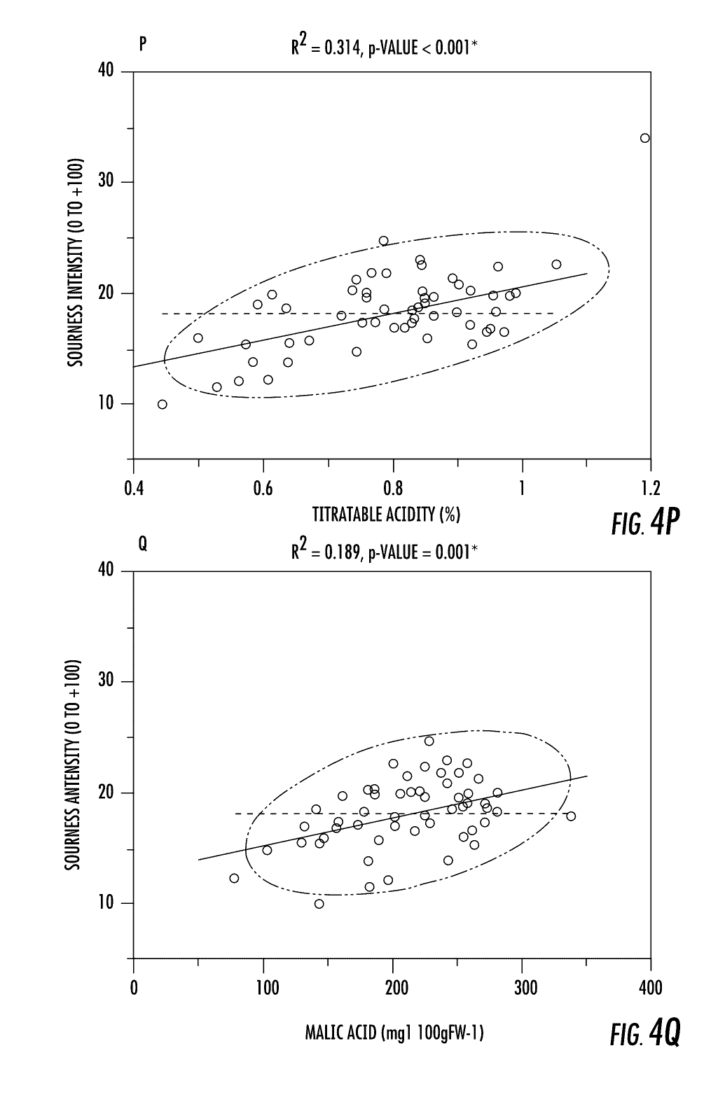

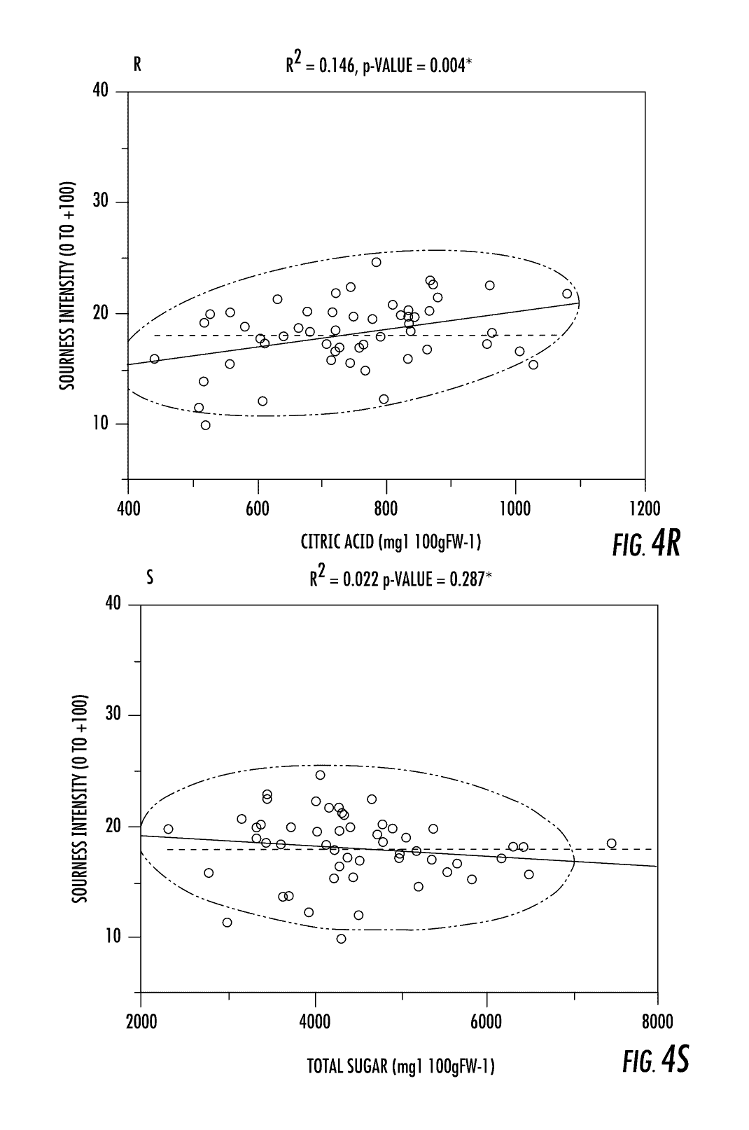

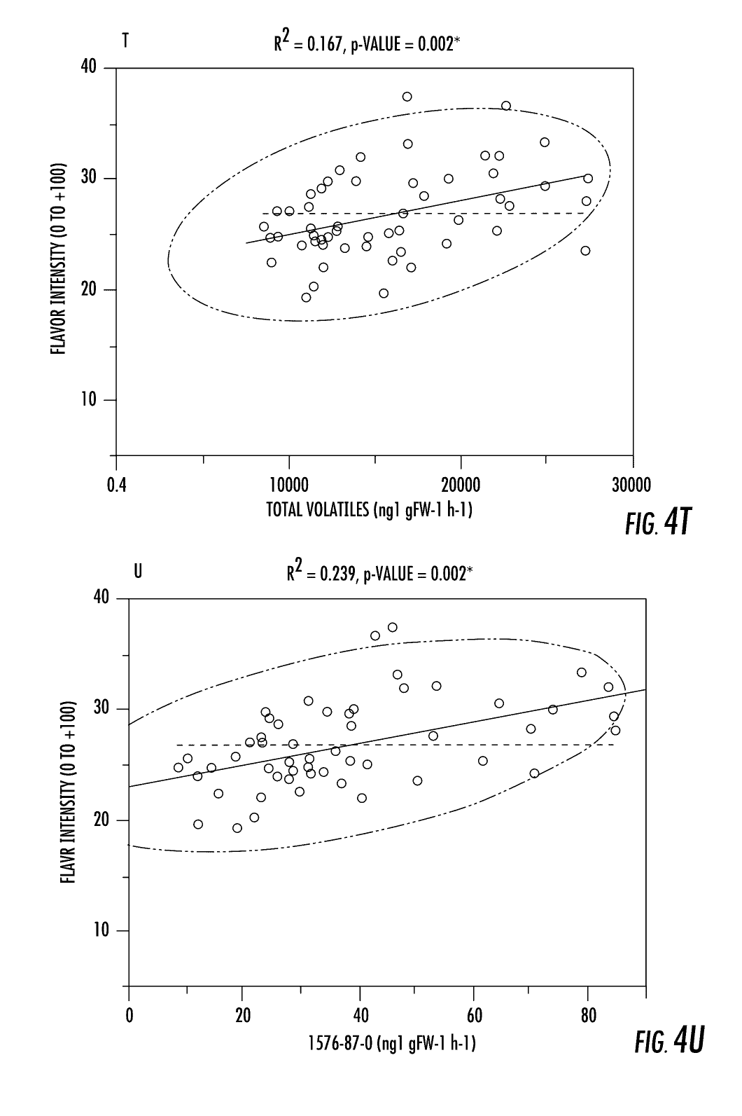

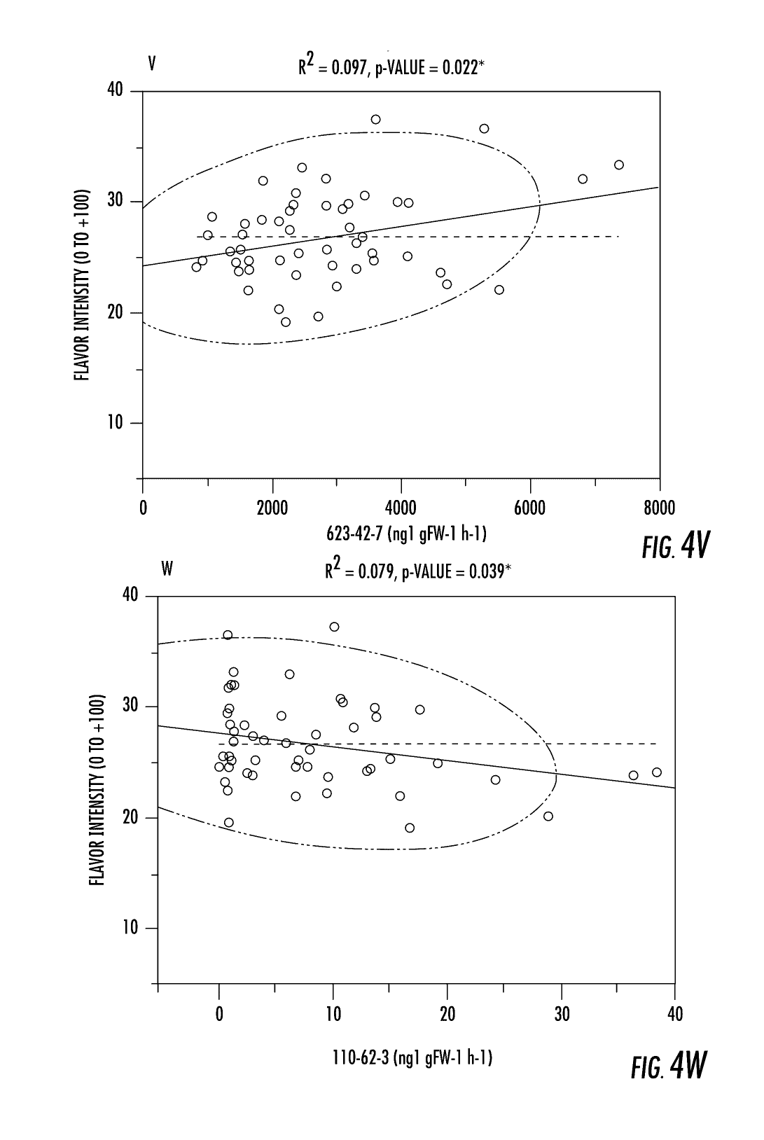

In order to elucidate factors contributing to strawberry experience, overall likability of strawberry samples was plotted against the hedonic measure liking of texture and the sensory intensities of sweetness, sourness, and strawberry flavor (See Tables 7-11 and FIG. 4A-D). High correlations with a significant fit was found for liking of texture (R²=0.490) (FIG. 4A), strawberry flavor intensity (R²=0.604) (FIG. 4D), and sweetness (R²=0.742) (FIG. 4B); however, sourness showed little to no correlation to overall likability (R²=0.008) (FIG. 4C). Liking of texture has a noted influence on likability, but sourness appears to have little to no influence on the hedonic response to strawberry fruit. Perceived intensity of sweetness and strawberry flavor emerged as the strongest drivers of overall likability.

Texture The upper limit for hedonics of texture is comparable to that of overall likability and was observed from a Festival sample (season 1, harvest 1) with an average of 35.7; however, the low texture liking value of 5.8 for Mara Des Bois (season 1, harvest 6) indicates a more intense disliking of irregular textures. (data not shown).

Firmness of samples was assayed by measuring the force required for a set depression of the epidermis, acting as a proxy for texture. The firmness of the fresh berries exhibited nearly a fivefold difference in depression force, 0.2 kg in March 2011 for Mara des Bois and 1.0 kg for a Festival sample (season 1, harvest 4).

Increasing force of depression/penetration, i.e. increasing firmness of berries, was positively correlated with texture liking, indicating a preference for firmer fruit (R²=0.36) (FIG. 4I). Liking of texture decreased slightly over season (FIG. 4J), but firmness did not appear to have a significant negative trend throughout the season (FIG. 4K). It is likely that harvest date had a negative impact on other factors contributing texture quality independent of firmness.

Sourness

The perceived sensory intensity of sourness intensity was assayed using the sensory general labeled magnitude scale (gLMS), which ranges from 0 to +100, (0 equating to no sensation, and 100 to most intense sensation). The sourness intensity of Red Merlin (season 1, harvest 5) provoked the lowest maximum sensory or hedonic mean of 24.6. This same sample was ranked as the lowest in terms of overall likability and sweetness.

Acidity of strawberry fruit was assayed using chemical measures of pH and titratable acidity (TA) and biochemical determination of citric and malic acid. The pH of strawberry samples ranged from 3.35 to 4.12, while TA from 0.44% to 1.05%. The range of malic acid across samples was 0.078% to 0.338% while citric acid ranged from 0.441% to 1.080%. TA has the greatest correlation to sourness intensity (R²=0.314***) (FIG. 4P), even compared to pH (R²=0.118*), malic acid (R²=0.189**) (FIG. 4Q), or citric acid (R²=0.146**) (FIG. 4R) concentration. Citric acid concentration in general is approximately three-fold greater than malic acid and had a significant correlation to TA (R²=0.49***) (data not shown). There was no correlation of malic acid to TA (R²=0.01) (data not shown). Citric acid does not show any significant correlation to overall liking (R²=0.056), presumably due to the minimal relationship among sourness intensity and overall liking (R²=0.008) (FIG. 4C).

Sweetness

In the present study, perceived sweetness intensity was the greatest predictor of overall liking. In fact, the same samples scoring the highest and lowest for overall liking, ‘Festival’ (sn 2, wk 1) and ‘Red Merlin’ (sn 1, wk 6), elicited the greatest (36.2) and least (14.59) intense sensations of sweetness (full data set from tasting panels not shown). The early and late harvest week samples support the observable decline in perceived sweetness intensity across harvest weeks (R²=0.471***), which was also observed for multiple sugar measures (seasonal data not shown).

In the fifty-four samples assayed, the total sugar concentration ranged from 2.29-7.93%, a 3.5-fold difference. Glucose and fructose concentrations exhibit highly similar ranges to each other, 0.66-2.48% and 0.75-2.61%, respectively, and near-perfect correlation (R²=0.984***) (data not shown) within a sample. However, the concentration of glucose or fructose was not predictive of sucrose concentration (R²=0.011 and 0.004, respectively) (data not shown). Sucrose demonstrated a more dynamic state as its concentration dipped as low as 0.16% and up to 2.84%, nearly a seventeen-fold difference among all samples.

Sucrose is the single metabolite with the most significant contribution to overall liking (R²=0.442***). Individually, sucrose (R²=0.445***) (FIG. 4M), glucose (R²=0.337***) (FIG. 4N), and fructose (R²=0.300***) all significantly influence the variation in sweetness intensity. However, total sugar actually only accounts for slightly more than two-thirds of sweetness intensity variation (R²=0.687***) (FIG. 4L), likely a result of covariation of glucose and fructose. Interestingly, the total volatiles for a sample correlates positively with sweetness intensity, potentially accounting for up to 13.9%** of variation in sweetness intensity (FIG. 40).

Strawberry Flavor Intensity

Strawberry flavor intensity accounts for the retronasal olfaction component of chemical senses complimented by taste; including sourness and sweetness intensity in this study. The overall highest sensory intensity was 37.5 for strawberry flavor of ‘Festival’ (sn 2, wk 1), which also rated highest for overall liking and sweetness intensity. Opposite this, FL-05-85 (sn 1, wk 6) delivered the least intense strawberry flavor experience with a score of 19.4. Total volatiles in ‘Festival’ (sn 2, wk 1) was over 50% greater and seven more volatiles compounds were detected than in FL 05-85. Total volatiles within a sample contribute to strawberry flavor intensity (R²=0.167**)(FIG. 4T), but it is not simply the sum of volatile constituents that explain the effect. For instance, the maximum total volatiles detected within a sample, 27.3 μg¹ gFW⁻¹ hr⁻¹ collected from ‘Camarosa’ (sn 1, wk 2), does not result in the greatest flavor intensity (30.5) and the minimum, 8.5 μg¹ gFW⁻¹ hr⁻ from ‘Sweet Anne’ (sn 2, wk 9), does not rate as the least flavorful (25.8).

The chemical diversity of the resources analyzed allowed for the identification of eighty-one volatile compounds from fresh strawberry fruit (Table 6). The majority of compounds are lipid related esters, while lipid related aldehydes account for the majority of volatile mass. Terpenes, furans, and ketones are also represented in the headspace of strawberry. Forty three of the eighty-one volatile compounds were not detected (<0.06 ng¹ gFW⁻¹ hr⁻¹) in at least one sample i.e. 38 volatiles were measured in all samples and appear to be constant in the genetic resources analyzed. No cultivar emitted all volatiles. At least one sample of ‘Festival’, ‘Camino Real’, PROPRIETARY 6, and FL 06-38 have detectable amounts of all volatiles, except for 134-20-3, which was only identified in ‘Mara des Bois’ and ‘Charlotte’ from the final harvest (wk 7) of season 1. ‘Chandler’ (sn 2, wk 4) is qualitatively the most deficient sample, lacking detectable amounts of 19 of 81 compounds, having the second lowest amount of total volatiles, and a flavor intensity of 24.8.

One ester deficient in ‘Chandler’, 60415-61-4, is not detectable in eight samples, and significantly correlated to flavor intensity (R²=0.233***), despite maximum mass of only 11.5 ng¹ gFW⁻¹ hr⁻¹. Interestingly, the most abundant ester, 623-42-7 is measured at over 7 μg¹ gFW⁻¹ hr⁻¹ from PROPRIETARY 2 (sn 1, wk 3) and has less correlation to flavor (R²=0.097*) (FIG. 4V) than 60415-61-4. 123-66-0, an ester that exhibits over 200-fold difference across samples, has no bearing on sensory perception. Likewise, 66-25-1 is the second most abundant individual compound, an aldehyde detected in all samples, exceeds 11 μg¹ gFW⁻¹ hr⁻¹, and does not have a significant correlation to flavor intensity (R²=0.016). Conversely, two minor level aldehydes demonstrate a disparity in effect: 1576-87-0 is enhancing toward flavor intensity (R²=0.239**) (FIG. 4U), while 110-62-3 is the only compound negatively correlated to flavor (R²=0.079*) (FIG. 4W). The significant contribution of the terpenes 40716-66-3 and 78-70-6 is enhancing for flavor intensity (R²=0.112* and R2=0.074*, respectively), as well as, the level of a characteristic strawberry furan, 4077-47-8 (R²=0.108*). In total, thirty volatiles diverse in structure and degree of presence are found to have a positive relationship to flavor intensity (α=0.05).

Volatile Enhanced Sweetness

Step-wise multiple regressions of all volatile compounds against perceived intensity of sweetness is performed independent of either glucose, fructose, or sucrose concentration, separately (Table 6). Twenty four volatile compounds showed significant correlations (α=0.05) to perceived sweetness intensity independent of glucose or fructose concentration, twenty-two of which are mutual between the two monosaccharides. Thirty volatiles were found to enhance sweetness intensity independent of at least one of sucrose, glucose, and/or fructose (noted with an asterisk in Table 6). Twenty volatiles are found to enhance sweetness intensity independent of sucrose concentration. Six of these volatiles are shared with those independent of glucose and fructose: 1629-58-9 (1-penten-3-one), 2305-05-7 (5-octyldihydro-2(3H)-furanone), 540-18-1 (pentyl butyrate), 2639-63-6 (hexyl butyrate), 142-92-7 (hexyl acetate), and 60415-61-4 (2-pentanyl butyrate). Only three compounds were found to be negatively related to sweetness independent of at least one of the sugars: 106-32-1 (ethyl octanoate) exclusively independent of glucose, 108-10-1 (4-Methyl-2-pentanone) mutually independent of glucose and fructose, and 1191-16-8 (3-methyl-2-buten-1-yl acetate) exclusively independent of sucrose.

### Discussion

Exploitation of genetic diversity and environmental variation allowed for a wide range of consumer hedonic and sensory responses. A nearly three-fold difference in overall liking of strawberry was observed within all samples. The highest and lowest rating samples are ‘Festival’ of the first week of season 2 and ‘Red Merlin’ of week six in the first season; two cultivars that were grown under the same conditions, but were developed by separate breeding programs and harvested at opposite ends of the season. The cultivars in this study represent a large proportion of commercial strawberry acreage in North America, breeding selections, and European cultivars; a genetic collection to enhance the range of diversity for flavors and chemical constituents. Despite the perennial life cycle of strawberry, much commercial production uses annual methods, which in sub-tropical Florida allows for continual harvest of ripe fruit from late November through March. In general, progression of harvest of non-determinant, non-climacteric fruit throughout a season results in decreased overall liking, attributed to perceivable differences in fruit quality (FIG. 4E).

Increasing texture liking, sweetness intensity, and strawberry flavor intensity significantly increase overall liking, while sourness intensity has no relationship (FIG. 4A-D). Therefore, overall liking is the cumulative measure of the experience from eating a strawberry fruit. Integration and synthesis of response to sensory signals of taste, olfaction, and tactile sensation constitute an eating experience (Prescott 2004) and drive overall liking. The senses of taste and olfaction sample the chemicals present in food such as, sugars, acids, and volatile chemical compounds; these elicitors attenuate the perception and hedonics of food (Lindemann 2001) (Fujimaru and Lim 2013). Ratings of strawberry fruit are correlated to specific chemical or physical attributes, especially sweetness and flavor intensity, the two greatest drivers of overall liking.

Much work has been done to measure sugars and volatile compounds in strawberry fruit in attempt of understanding sweetness and flavor, and these aims are in line with consumer demand. A consumer survey using 36 attributes of strawberry determined “sweetness” and “complex flavor” as consistent favorable characteristics of the ideal strawberry experience (Colquhoun 2012). Using the same gLMS scales employed in the current study, scores for ideal strawberry and tomato (Tieman 2012) overall liking, sourness intensity, and flavor intensity are highly similar. Ideal flavor evoked the highest mean response of 45 for both, exemplifying its importance to the consumer. Interestingly, a large disparity for ideal sweetness intensity was found; 42 and 33 for strawberry and tomato, respectively. Ideal sweetness intensity is much greater in strawberry, potentially due to differences in consumption. Strawberry is often consumed fresh and is a delicacy or dessert fruit, while tomato is savory and often an ingredient in complex recipes. Therefore, the desire for sweetness is much greater in strawberry.

The overall liking of strawberry fruit is significantly related to texture liking (FIG. 4A), and increasing fruit firmness accounts for more than a third of increasing texture liking (FIG. 4I). The five-fold variation in firmness could be attributed to variation in fruit development or softening. Strawberry fruit development includes division, expansion, and ripening (Zhang 2011). Developmentally regulated, ripening associated fruit softening is multifaceted (Quesada 2009), including catalytic cell wall disassembly (Trainottie 1999) and dissolution of cell-to-cell adhesion (Brummel and Harpster 2001). The relationship between texture liking and firmness does not appear entirely linear, because the two firmest samples are close to average texture liking (FIG. 4I). Excessively firm fruits may be perceived as under ripe while those with less firmness may be considered over ripe; affecting texture liking. Fruit can progress through ripening, from under to over ripe, in ten days (Zhang 2011), exemplifying the narrow window in which multiple facets of fruit quality can synchronize.

Even with a moderate range of intensity, perceived sourness has little to no bearing on overall liking (FIG. 4C). Just over 30% of sourness intensity variation can be accounted for by positive correlation with TA. The concentrations of citric acid and malic acid metabolites are likely additive toward the effect of TA on sourness intensity, and both organic acids have significant correlations to TA (data not shown). Despite a lack of influence by sourness intensity on overall liking, metabolites of sourness have a role in fruit biochemistry, as increased TA shows a significant minor correlation with overall liking (FIG. 4G) and is significantly correlated with SSC (data not shown). This co-linearity is likely due to accumulation of sugars and subsequent biosynthesis of organic acids during ripening of fruit (Menager 2004, Zhang 2011, Fait 2008). Citric acid is the predominant organic acid in ripe fruit (Mikulic-Petkovsek 2012), and its concentration is fairly stable during ripening. Also, it is known to act as an intermediate between imported sucrose and fatty acid biosynthesis (Fiat 2008), which may facilitate enhancement of overall liking.

The consumer rating of sweetness intensity is the primary factor of overall liking, and sweetness is the component of taste perception facilitating the detection of sugars. Sugars are simple carbohydrates, a readily available form of energy, and the degree of correlation among sweetness and overall liking is due to hedonic effect (Lindemann 2001). Variation in sweetness intensity is best explained by sugar content (FIG. 4L), a valid indicator of sweetness in strawberry (Jouquand 2008), which is often used to estimate sugar concentration (Jouquand 2008) (Whitaker 2011). Previous quantification of individual sugars within a strawberry identifies sucrose, glucose, and fructose as the predominant soluble solids (Menager 2004) (Basson 2010) (Whitaker 2011) (Mikulic-Petkovsek 2012). Sucrose concentrations observed across samples is responsible for most variation in SSC, sweetness intensity and overall liking than any other individual compound. Metabolites contributing to perceived sweetness intensity have the greatest influence on the overall hedonics of strawberry; unfortunately a significant decrease in sweetness intensity was documented during the seasons.

The extended harvest season of strawberry has an effect on fruit quality (FIG. 4E) likely due to environmental changes or plant maturity, resulting in the observed decrease in sweetness intensity as the season progresses. SSC, the best predictor of sweetness intensity, decreases during the season as the plant is subjected to increasing temperatures, which likely altered whole plant physiology and more specifically fruit biochemistry during development and ripening, affecting fruit quality. Development of fruit under elevated temperature causes increased fruit maturation rate and decreased SSC independent of flowering date i.e. plant maturity (MacKenzie and Chandler 2009, MacKenzie 2011). A significant and strong decrease in sucrose and a lack of change in glucose and fructose indicates sucrose as the waning constituent of SSC within a season. Sucrose concentration has greatest variability among the three sugars and shows no significant relationship to glucose or fructose concentration. However, a near perfect statistical relationship observed between glucose and fructose is likely due to their biosynthetic association. During strawberry fruit development sucrose is continually translocated from photosynthetic tissue, while a consistently high sucrose invertase activity in fruit hydrolyzes sucrose into glucose and fructose, maintaining sink strength of fruit (Basson 2010) and in turn feeding biosynthetic pathways (Fait 2008).

Increased maturation rate hastens fruit development, potentially decreasing the cumulative period during which sucrose is imported to fruit, and inhibiting sucrose accumulation and affecting other fruit quality attributes. Total volatiles have an indirect dependence on sucrose concentration (data not shown), and a decrease in total volatiles is observed as the seasons progress (not shown). Generation of glucose and fructose initiates a complex network of primary and secondary metabolism specific to ripening strawberry fruit, in which sucrose is principal and limiting to the strawberry fruit biosynthetic pathways (Fait 2008). Terminal primary biosynthetic pathways derived from sucrose include fatty acids and amino acids, whose concentrations decrease in the final stage of ripening (Fait 2008). Interestingly, culmination of ripening coincides with peak concentration of volatile secondary metabolites (Menager 2004) and upregulation of associated biosynthetic genes (Cumplido-Laso 2012). Influence of harvest date on headspace of fresh strawberry fruit is known (Watson 2002) (Pelayo-Zaldivar 2005), and one hypothesis suggests that more free sucrose, i.e. a larger imported reserve, facilitates greater flux through primary and secondary metabolism. Glucose and fructose concentrations are tightly correlated, show less variation, less seasonal influence, and lack of correlation to sucrose, indicative of tighter biochemical regulation.

Strawberry flavor intensity is the second greatest determinant of overall liking (FIG. 4D) and accounts for perception of volatile compounds through retronasal olfaction. A significant positive relationship exists among total volatile content and the flavor intensity for a given sample; however, total volatile content is not entirely explanatory of flavor intensity. The maximum rating for strawberry flavor intensity by ‘Festival’ (sn 2, wk1) is the greatest consumer response evoked within this study (data not shown), highlighting the significance of sensory perception of aroma. However, this sample only had slightly more than 60% of total volatile mass of the greatest sample. The extent of volatile phenotype diversity is great enough across strawberry fruit to not only be discerned but be preferred.

Within the genetic resources of Fragaria x ananassa analyzed in this study 81 compounds were reproducibly detected, but not one cultivar had detectable amounts of all compounds. Accumulation of sugars, organic acids, and fatty acids, as well as the consumption of amino acids occurs during ripening (Zhang 2011). Many of these chemical classes serve as precursors to volatile synthesis (Perez 2002), thus facilitating a flux through biosynthetic pathways for increased and diverse volatile emissions in ripe strawberry fruit, characterized by acids, aldehydes, esters, furanones, lactones, and terpenes (Menager 2004)(Jetti 2007). Over 350 volatile compounds have been identified across Fragaria (Maarse 1991). The concentrations of individual volatile compounds within fruit can have a significant influence on flavor intensity, but a lack of consensus has existed as to which volatiles are determinant of flavor.

Previous determination of flavor relevance was determined using approaches that determine importance of volatiles based on analytical signal intensity and/or human perception of single isolated volatile compound via orthonasal olfaction (Schieberle and Hofmann 1997) (Ulrich 1997) (Hakala 2002) (Jetti 2007) (Olbricht 2008), negating the complex system of strawberry fruit or actual flavor relevant retronasal olfaction. Of the forty-six volatile compounds cited as relevant to strawberry flavor in five studies (Schieberle and Hofmann 1997, Ulrich 1997, Hakala 2002, Jetti 2007, Olbricht 2008) only seven were mutual to at least three of the studies, exemplifying the lack of agreement in defining flavor-relevant constituents. This consensus includes 623-42-7, 105-54-4, 106-70-7, 123-66-0, 78-70-6, 116-53-0, and 4077-47-8, all of which are quantified in this report. These compounds exhibit adequate variability in fruit samples to discern dose dependent effect on flavor intensity. However, only 78-70-6, 105-54-4, 623-42-7, and 4077-47-8 show significant positive correlation with flavor intensity. These compounds that were found to influence flavor intensity represent diverse classes, terpenoid alcohol, two esters, and a furan, respectively, while the three compounds not fitting to flavor are all esters. With esters accounting for the majority of chemical compounds detected in strawberry it is possible that too much emphasis was placed on the chemical class for flavor, or that, in a complex mixture, less are perceivable than when smelled individually. These volatiles may have no bearing on strawberry flavor, but have been targets due to quantity, threshold ratios, or simply identity.

Over one third of volatiles in this study are significantly correlated with strawberry flavor intensity, potentially enhancing perception of a complex and highly variable volatile mixture, seventeen of which are not of previous flavor focus. Two of these unrecognized compounds, 111-71-7 and 109-19-3, are present in the most flavorful strawberry sample but undetected in the least flavorful. This pair of compounds as well as 539-82-2 and 7789-58-5, also present/absent in the most/least flavorful, have relatively minor amounts but show evidence of enhancing perceived sweetness intensity independent of individual sugars. Relatively low concentration volatiles are indicated as new impactful components of strawberry flavor.

Thirty-eight volatile compounds were found to significantly enhance the perceived intensity of sweetness; twenty-two mutually independent of glucose and fructose, fourteen uniquely independent of sucrose, and six compounds mutually independent of all three sugar: 1629-58-9, 2305-05-7, 540-18-1, 2639-63-6, 142-92-7, and 60415-61-4 (Table 6). In tomato, similar analysis of a volatile subset identified three compounds enhancing sweetness intensity independent of fructose: geranial, 123-51-3, and 96-17-3 (Tieman 2012). These compounds were not identified in this strawberry work. Botanically, tomato is considered a true fruit and demonstrates climacteric ripening, while strawberry fruit is non-climacteric and considered an aggregate accessory fruit. The developmental origin of the flesh which is consumed is divergent, exhibiting unique biochemistries.

Orthonasal (smell) and retronasal (flavor) olfaction each project to different brain areas for processing (Small and Jones-Gotman 2001). Taste projects to the same brain area as retronasal olfaction, for integration to produce flavor (Small 2004). This integration has a remarkable consequence: taste and retronasal olfaction can intensify one another. The food industry knows of the intensification of volatile sensations by the addition of small amounts of sweeteners (Sjöström and Cairncross 1955). The ability of volatiles to enhance taste was identified later (Murphy 1977) (Burdach 1984) (Lindemann 2001), and one study shows the ability of whole strawberry aroma to intensify the sweetness of a sugar solution (Frank and Byram 1988). The results of this present example take the complex, variable mixture of compounds in strawberry aroma, and identify individual volatile compounds in the fruit capable of producing the enhanced sweetness effect. These volatiles are not present at the highest amounts in fruits, most are not targets of flavor analysis, and a majority appear to be associated with lipid metabolism, yet their presence or increased concentration has an enhancing effect on perceived sweetness, an effect independent of sugars. Technically, sweetness is a facet of taste (Lindemann 2001). Therefore, a means to convey sweetness via aroma could serve as an attractant to seed dispersers of wild strawberry, or perhaps it is a result of artificial selection (Aharoni 2004) to enhance a limited sugar capacity in commercial fruit.

### Conclusion

Strawberry fruit ripening culminates as the flesh softens, volatile emission peaks, and sugars accumulate. This highly coordinated process results in fruit with strong liking due primarily to texture, flavor, and sweetness. However, cultivar, environmental conditions, and their interactions influence fruit attributes, altering the composition of strawberry. This diversity allows for a gamut of experiences such that the hedonics and intensities of these sensations can vary greatly. The importance of sucrose to sweetness intensity is evident, and the correlation of total volatiles to sucrose highlights the dependence of secondary metabolism to primary metabolism. Individual volatiles were shown to correlate to strawberry flavor intensity, helping to better define distinct, perceptually impactful compounds from the larger mixture the fruit. The dependence of liking on sweetness and strawberry flavor is undermined by environmental pressures that reduce sucrose and total volatile content. A cultivar that exhibits minimal seasonal environmental influence presents itself as a breeding ideotype, as maintenance of sucrose concentration should alleviate loss of overall liking. Selection for increased concentrations of volatile compounds that act independently of sugars to enhance sweetness is another approach. The volatiles described herein were sampled mainly from current commercial cultivars and represent feasible targets for varietal improvement. Additional studies may identify other sweet-enhancing volatiles not already present in elite germplasm.

### Experimental Procedures

### Plant Material

Thirty-five strawberry cultivars were grown during the 2010-2011 and 2011-2012 winter seasons according to current commercial practices for annual strawberry plasticulture in Florida (Whitaker, 2011; Santos, 2012). Fully-ripe fruit by commercial standards (Strand 2008) was harvested from three to five cultivars on Mondays, delivered to respective laboratories, and stored at 4° C. dark overnight for simultaneous analysis of fresh strawberry fruit volatiles, exterior and interior color, firmness, and sensory analysis on Tuesdays; as well as sample, preparation for later sugar and acid measurements. Six harvests in both seasons allowed for the complete analysis of fifty-four samples. Weather data was obtained from the Balm, Fla. station of the Florida Automated Weather Network (fawn.ifas.ufl.edu). Temperature recording height at 60 centimeters and relative humidity, rain, and solar radiation at 2 meters.

### Volatile Analysis

At least 100 grams or seven berries of each sample were removed from 4° C. dark overnight storage prior to volatile collection. Samples were homogenized in a blender prior to splitting into three 15 gram replicates for immediate capturing of volatile emission and remainder of sample frozen in N₂ (I) and stored at −80° C. for later sugar and acid quantification. A two hour collection in a dynamic headspace volatile collection system (Underwood, 2005) allowed for concentration of emitted volatiles on HaySep 80-100 porous polymer adsorbent (Hayes Seperations Inc., Bandera, Tex., USA). Elution from polymer previously described in Schmelz, 2003.

Quantification of volatiles in an elution was performed on an Agilent 7890A Series gas chromatograph (GC) (carrier gas; He at 3.99 mL min⁻¹; splitless injector, temperature 220° C., injection volume 2 μl) equipped with a DB-5 column ((5%-Phenyl)-methylpolysiloxane, 30 m length×250 μm i.d.×1 μm film thickness; Agilent Technologies, Santa Clara, Calif., USA). Oven temperatures programmed from 40° C. (0.5 min hold) at 5° C. min⁻¹ to 250° C. (4 min hold). Signals captured with a flame ionization detector (FID) at 280° C. Peaks from FID signal were integrated manually with Chemstation B.04.01 software (Agilent Technologies, Santa Clara, Calif.). Volatile emission (ng gFW⁻¹ h⁻¹) calculated based on individual peak area relative to sample elution standard peak area. GC-Mass Spectrometry (MS) analysis of elution on an Agilent 6890N GC in tandem with an Agilent 5975 MS (Agilent Technologies, Santa Clara, Calif., USA) and retention time comparison with authentic standards (Sigma Aldrich, St Louis, Mo., USA) for volatile identification (Schmelz, 2001).

### Sugars and Acids Quantification

Titratable acidity (TA), pH, and soluble solids content (SSC) were averaged from four replicates of the supernatant of centrifuged thawed homogenates (Whitaker, 2011). An appropriate dilution of the supernatant from a separate homogenate (centrifugation of 1.5 ml at 16,000×g for 20 minutes) was analyzed using biochemical kits (per manufacturer's instructions) for quantification of citric acid, L-malic acid, D-glucose, D-fructose, and sucrose (CAT# 10-139-076-035, CAT# 10-139-068-035, and CAT# 10-716-260-035; R-Biopharm, Darmstadt, Germany) with absorbance measured at 365 nm on an Epoch Microplate Spectrophotometer (BioTek, Winooksi, Vt., USA). Metabolite average concentration (mg 100 gFW⁻¹) determined from two to six technical replicates per pooled sample. Derived sucrose concentration via D-glucose and D-fructose were mathematically pooled.

### Color Measurement

Fruit was removed from overnight 4° C. dark storage on the day of sensory evaluation. 8 berries were sampled and allowed to warm up to room temperature for color and texture measurements. A Konica Minolta Chromameter (CR-400, Tokyo, Japan) with an 8 mm aperture, diffuse illumination and 0° viewing angle was used to measure external and internal color. CIE L*a*b* values were obtained for a D₆₅ illuminant simulating daylight. Two readings of external color were made on the opposite sides of each berry at the widest part. Internal color was measured at the equatorial part of the flesh under the epidermis after the berries were cut in half longitudinally (one on each side). Both external color and internal color were recorded as the average of two readings from the same fruit, further averaged across eight fruit per cultivar.

### Firmness Determination

Firmness of the strawberries was determined as the resistance of the fruit to compression (7 mm deformation) at its equator with a TA.XTPIus Texture Analyzer (Texture Technologies Corp., Scarsdale, N.Y., USA/Stable Micro Systems, Godalming, Surrey, UK). The Texture Analyzer was equipped with a 50 kg load cell and an 8 mm diameter convex tip probe. Whole fruit was punctured on the side to 7 mm down from the epidermis at a test speed of 2 mm/sec; a flap cut off the opposite provided stability. Maximum force in kg for eight pieces of fruit, was averaged and reported as a measure of firmness.

### Sensory Analysis

All consumer panels were approved by the University of Florida Institutional Review Board. Over the course of two annual seasons 166 strawberry consumers (58 male, 108 female) were recruited to evaluate strawberry cultivars. Ages of panelist ranged from 18 to 71, with a median age of 24. Panelists self-classified themselves as 98 White or Caucasian, 11 Black or African-American, 1 Native American, Alaska Native or Aleutian, 41 Asian/Pacific Islander, and 15 Other. An average of 106 (range of 98-113) panelists evaluated between three and five cultivars per session (Tieman, 2012). Fresh, fully-ripe strawberry fruit was removed from overnight 4° C. dark storage and allowed to warm to room temperature prior to sensory analysis. Each panelist was given one to two whole strawberries for evaluation, depending on cultivar availability. Panelist took a bite of each sample, chewed, and swallowed it. Ratings for overall liking and liking for texture were scaled on hedonic general labeled magnitude scale (gLMS) in the context of all pleasure/displeasure experiences. Perceived intensity of sweetness, sourness, and strawberry flavor were scaled in context of all sensory experiences using sensory gLMS (Bartoshuk, 2003; Bartoshuk, 2005; Tieman, 2012). Scales were employed to mediate valid comparisons across subjects and sessions.

### Statistical Analysis

Means and standard errors for consumer, physical, and metabolite measurements were determined from all replicates using JMP (Version 8. SAS Institute Inc., Cary, N.C., 1989-2008). Bivariate analysis among individual measurements of samples allowed for linear fit, which includes summary of fit, analysis of variance, t-test, and correlation analysis for density ellipse. Two-way Ward hierarchical cluster analysis of all metabolite concentrations and strawberry samples accomplished in JMP.

Multiple regressions were performed with the “enter” method in SPSS for identification of sweetness enhancing volatiles. Individual volatile compound concentrations were regressed using the “enter” method in SPSS Statistics (IBM Corp, Armonk, N.Y., USA). This was done individually for each of the three sugars: glucose, fructose or sucrose to identify which compounds had an effect on sweetness (positive or negative) independent of each of the sugars. For p values of about ≦0.05, the volatile made a contribution to perceived sweetness that was independent of the sugar tested.

TABLE 6
Multiple regression for identification of sweetness enhancing volatiles. Individual
volatile compound concentrations were regressed against perceived sweetness intensity
independent of effect from glucose, fructose, or sucrose, separately. Thirty compounds
(asterisk) were found to enhance intensity of sweetness independent of at least one of the three
sugars. Six compounds (bold) were found to significantly enhance intensity of sweetness
independent of all three sugars.

| | FRUCTOSE | FRUCTOSE | | SUCROSE | SUCROSE | | GLUCOSE | GLUCOSE | |
|---|---|---|---|---|---|---|---|---|---|
| CAS # | t RATIO | p-VALUE | | t RATIO | p-VALUE | | t RATIO | p-VALUE | |
| 1629-58-9 | 5.097 | 0 | * | 2.41 | 0.02 | * | 4.696 | 0 | * |
| 1576-87-0 | 4.566 | 0 | * | 1.024 | 0.311 | | 4.301 | 0 | * |
| 1576-86-9 | 4.16 | 0 | * | 0.935 | 0.354 | | 3.915 | 0 | * |
| 2305-05-7 | 3.933 | 0 | * | 2.784 | 0.008 | * | 3.549 | 0.001 | * |
| 3913-81-3 | 3.694 | 0.001 | * | 1.411 | 0.164 | | 3.494 | 0.001 | * |
| 124-19-6 | 3.696 | 0.001 | * | 0.226 | 0.822 | | 3.402 | 0.001 | * |
| 6728-26-3 | 3.349 | 0.002 | * | −0.816 | 0.418 | | 3.314 | 0.002 | * |
| 591-78-6 | 2.807 | 0.007 | * | 0.767 | 0.447 | | 2.788 | 0.007 | * |
| 5881-17-4 | 2.894 | 0.006 | * | 0.608 | 0.546 | | 2.662 | 0.01 | * |
| 540-18-1 | 2.71 | 0.009 | * | 2.292 | 0.026 | * | 2.515 | 0.015 | * |
| 2639-63-6 | 2.865 | 0.006 | * | 2.892 | 0.006 | * | 2.512 | 0.015 | * |
| 105-54-4 | 2.533 | 0.014 | * | 0.034 | 0.973 | | 2.493 | 0.016 | * |
| 564-94-3 | 2.588 | 0.013 | * | −1.322 | 0.192 | | 2.455 | 0.018 | * |
| 111-71-7 | 2.599 | 0.012 | * | 1.342 | 0.186 | | 2.283 | 0.027 | * |
| 4077-47-8 | 2.414 | 0.019 | * | 0.299 | 0.766 | | 2.185 | 0.034 | * |
| 110-93-0 | 2.527 | 0.015 | * | 1.43 | 0.159 | | 2.165 | 0.035 | * |
| 638-11-9 | 2.311 | 0.025 | * | 1.256 | 0.215 | | 2.14 | 0.037 | * |
| 142-92-7 | 2.346 | 0.023 | * | 2.943 | 0.005 | * | 2.096 | 0.041 | * |
| 60415-61-4 | 2.309 | 0.025 | * | 2.119 | 0.039 | * | 2.062 | 0.044 | * |
| 116-53-0 | 2.01 | 0.05 | * | −0.286 | 0.776 | | 2.035 | 0.047 | * |
| 123-86-4 | 2.179 | 0.034 | * | 1.147 | 0.257 | | 2.008 | 0.05 | * |
| 7452-79-1 | 1.959 | 0.056 | | −0.785 | 0.436 | | 1.993 | 0.052 | * |
| 109-21-7 | 2.181 | 0.034 | * | 1.65 | 0.105 | | 1.961 | 0.055 | |
| 109-19-3 | 2.005 | 0.05 | * | 1.662 | 0.103 | | 1.954 | 0.056 | |
| 616-25-1 | 1.773 | 0.082 | | 0.795 | 0.43 | | 1.628 | 0.11 | |
| 5454-09-1 | 1.804 | 0.077 | | 2.085 | 0.042 | * | 1.579 | 0.12 | |
| 96-22-0 | 1.82 | 0.075 | | 0.912 | 0.366 | | 1.576 | 0.121 | |
| 5989-33-3 | 1.869 | 0.067 | | 1.953 | 0.056 | | 1.561 | 0.125 | |
| 2548-87-0 | 1.76 | 0.084 | | 0.067 | 0.947 | | 1.509 | 0.138 | |
| 623-42-7 | 1.455 | 0.152 | | 0.419 | 0.677 | | 1.452 | 0.153 | |
| 29674-47-3 | 1.339 | 0.187 | | 0.035 | 0.972 | | 1.362 | 0.179 | |
| 53398-83-7 | 1.482 | 0.144 | | 2.556 | 0.014 | * | 1.283 | 0.205 | |
| 40716-66-3 | 1.521 | 0.134 | | 1 | 0.322 | | 1.202 | 0.235 | |
| 66-25-1 | 1.229 | 0.225 | | 0.21 | 0.835 | | 1.178 | 0.244 | |
| 104-76-7 | 1.189 | 0.24 | | 2.046 | 0.046 | * | 0.982 | 0.331 | |
| 556-24-1 | 0.732 | 0.468 | | 0.972 | 0.336 | | 0.88 | 0.383 | |
| 706-14-9 | 1.247 | 0.218 | | 1.65 | 0.105 | | 0.879 | 0.384 | |
| 110-39-4 | 0.96 | 0.341 | | 2.645 | 0.011 | * | 0.814 | 0.419 | |
| 628-63-7 | 0.882 | 0.382 | | 0.427 | 0.671 | | 0.749 | 0.457 | |
| 78-70-6 | 0.872 | 0.387 | | −0.1 | 0.921 | | 0.7 | 0.487 | |
| 124-13-0 | 0.871 | 0.388 | | 0.169 | 0.866 | | 0.685 | 0.497 | |
| 75-85-4 | 0.736 | 0.465 | | −0.306 | 0.761 | | 0.667 | 0.508 | |
| 110-43-0 | 1.054 | 0.297 | | 1.899 | 0.063 | | 0.657 | 0.514 | |
| 105-66-8 | 0.88 | 0.383 | | 2.421 | 0.019 | * | 0.638 | 0.526 | |
| 623-43-8 | 0.248 | 0.805 | | −1.396 | 0.169 | | 0.54 | 0.592 | |
| 1534-08-3 | 0.488 | 0.628 | | 1.035 | 0.305 | | 0.429 | 0.67 | |
| 71-41-0 | 0.448 | 0.656 | | 1.938 | 0.058 | | 0.296 | 0.769 | |
| 10522-34-6 | 0.536 | 0.594 | | 2.049 | 0.046 | * | 0.288 | 0.775 | |
| 112-14-1 | 0.413 | 0.681 | | 2.292 | 0.026 | * | 0.284 | 0.777 | |
| 4887-30-3 | 0.392 | 0.697 | | 2.71 | 0.009 | * | 0.254 | 0.801 | |
| 7786-58-5 | 0.362 | 0.718 | | 2.027 | 0.048 | * | 0.227 | 0.821 | |
| 103-09-3 | 0.172 | 0.864 | | −1.053 | 0.297 | | 0.21 | 0.835 | |
| 134-20-3 | −0.009 | 0.993 | | 1.386 | 0.172 | | 0.2 | 0.842 | |
| 15111-96-3 | 0.23 | 0.819 | | 0.927 | 0.358 | | 0.192 | 0.849 | |
| 110-38-3 | 0.281 | 0.78 | | 2.621 | 0.012 | * | 0.055 | 0.956 | |
| 96-04-8 | 0.142 | 0.887 | | −0.646 | 0.521 | | 0.002 | 0.998 | |
| 123-66-0 | 0.066 | 0.948 | | 1.064 | 0.292 | | −0.001 | 0.999 | |
| 2311-46-8 | 0.238 | 0.813 | | 2.211 | 0.032 | * | −0.058 | 0.954 | |
| 29811-50-5 | 0.016 | 0.987 | | 0.358 | 0.722 | | −0.098 | 0.922 | |
| 1576-95-0 | −0.186 | 0.853 | | −0.304 | 0.762 | | −0.231 | 0.819 | |
| 2497-18-9 | −0.313 | 0.756 | | −0.056 | 0.955 | | −0.331 | 0.742 | |
| 20664-46-4 | −0.17 | 0.865 | | 1.383 | 0.173 | | −0.395 | 0.694 | |
| 624-24-8 | −0.406 | 0.686 | | 0.662 | 0.511 | | −0.416 | 0.679 | |
| 589-38-8 | −0.217 | 0.829 | | 0.592 | 0.557 | | −0.427 | 0.671 | |
| 109-60-4 | −0.491 | 0.626 | | −0.224 | 0.823 | | −0.454 | 0.652 | |
| 821-55-6 | −0.267 | 0.791 | | 1.192 | 0.239 | | −0.467 | 0.642 | |
| 624-41-9 | −0.433 | 0.667 | | −1.323 | 0.192 | | −0.494 | 0.624 | |
| 140-11-4 | −0.361 | 0.72 | | −1.357 | 0.181 | | −0.513 | 0.61 | |
| 1191-16-8 | −0.581 | 0.564 | | −2.268 | 0.028 | * | −0.529 | 0.599 | |
| 106-70-7 | −0.321 | 0.75 | | 0.802 | 0.426 | | −0.531 | 0.598 | |
| 110-62-3 | −0.572 | 0.57 | | 0.997 | 0.323 | | −0.568 | 0.573 | |
| 105-37-3 | −0.623 | 0.536 | | 1.964 | 0.055 | | −0.674 | 0.503 | |
| 55514-48-2 | −0.644 | 0.523 | | −0.889 | 0.378 | | −0.675 | 0.502 | |
| 123-92-2 | −0.725 | 0.472 | | 0.108 | 0.914 | | −0.771 | 0.444 | |
| 539-82-2 | −0.48 | 0.633 | | 2.273 | 0.027 | * | −0.802 | 0.426 | |
| 2432-51-1 | −0.956 | 0.344 | | 2.033 | 0.047 | * | −1.092 | 0.28 | |
| 128-37-0 | −0.856 | 0.396 | | 0.482 | 0.632 | | −1.17 | 0.247 | |
| 111-27-3 | −1.253 | 0.216 | | −0.542 | 0.59 | | −1.481 | 0.145 | |
| 928-95-0 | −1.842 | 0.071 | | −0.516 | 0.608 | | −1.521 | 0.134 | |
| 108-10-1 | −2.185 | 0.034 | * | 0.898 | 0.374 | | −2.138 | 0.037 | * |
| 106-32-1 | −1.436 | 0.157 | | 0.193 | 0.848 | | −2.36 | 0.022 | * |

TABLE 7
Parameter Estimates-fit to Overall Liking

| X | Y | Term | Estimate | Std error | T ratio | Prob > \|t\| |
|---|---|---|---|---|---|---|
| Sweetness | Flavor | Sweetness | 0.696329891 | 0.058628059 | 11.87707554 | 1.97185e−16 |
| intensity | Intensity | intensity | | | | |
| | (FI) | | | | | |
| Overall liking | FI | Overall liking | 0.53546122 | 0.060098802 | 8.90968208 | 4.78907e−12 |
| Ssc | FI | Ssc | 2.099589408 | 0.245813014 | 8.541408664 | 1.79296e−11 |
| Total_sugar | FI | Total_sugar | 0.002857192 | 0.000344594 | 8.291472572 | 4.42006e−11 |
| Sucrose | FI | Sucrose | 0.004285612 | 0.000597156 | 7.176698734 | 2.58651e−09 |
| 1629-58-9 | FI | 1629-58-9 | 0.035544377 | 0.006631857 | 5.359641874 | 1.93398e−06 |
| 2305-05-7 | FI | 2305-05-7 | 0.311425932 | 0.06865815 | 4.535891704 | 3.411e−05 |
| 540-18-1 | FI | 540-18-1 | 0.627408558 | 0.146965271 | 4.269093995 | 8.34566e−05 |
| Ta | FI | Ta | 14.05787626 | 3.323604622 | 4.229707759 | 9.50719e−05 |
| 1576-87-0 | FI | 1576-87-0 | 0.095612684 | 0.023687 | 4.036504535 | 0.000178863 |
| 2639-63-6 | FI | 2639-63-6 | 0.146480632 | 0.036608961 | 4.001223404 | 0.000200472 |
| Citric | FI | Citric | 0.012934516 | 0.003236474 | 3.996484206 | 0.00020356 |
| 60415-61-4 | FI | 60415-61-4 | 1.196755673 | 0.301481486 | 3.969582636 | 0.00022198 |
| 142-92-7 | FI | 142-92-7 | 0.037684008 | 0.009634417 | 3.911394599 | 0.00026749 |
| 1576-86-9 | FI | 1576-86-9 | 0.085384434 | 0.022140228 | 3.85652922 | 0.000318556 |
| 5989-33-3 | FI | 5989-33-3 | 0.737768374 | 0.199451615 | 3.698984208 | 0.000522767 |
| Glucose | FI | Glucose | 0.004702108 | 0.001284198 | 3.661513606 | 0.000587285 |
| 123-86-4 | FI | 123-86-4 | 0.0209242 | 0.005717137 | 3.659909059 | 0.000590212 |
| 111-71-7 | FI | 111-71-7 | 0.775017373 | 0.21429633 | 3.616568581 | 0.000674752 |
| 109-21-7 | FI | 109-21-7 | 0.010994568 | 0.003111558 | 3.533461346 | 0.000870308 |
| 591-78-6 | FI | 591-78-6 | 0.119593926 | 0.035362697 | 3.381923251 | 0.00137365 |
| 109-19-3 | FI | 109-19-3 | 0.433436524 | 0.128570394 | 3.371200087 | 0.001418185 |
| 706-14-9 | FI | 706-14-9 | 0.020486232 | 0.006085074 | 3.366636417 | 0.001437551 |
| Total_volatiles | FI | Total_volatiles | 0.000306496 | 9.48862e−05 | 3.23014314 | 0.002147129 |
| Fructose | FI | Fructose | 0.0041928 | 0.001303875 | 3.215646489 | 0.002239435 |
| 638-11-9 | FI | 638-11-9 | 0.023685459 | 0.00740427 | 3.198891807 | 0.002350777 |
| 3913-81-3 | FI | 3913-81-3 | 1.106559919 | 0.353612616 | 3.129299886 | 0.002871462 |
| 616-25-1 | FI | 616-25-1 | 0.209654304 | 0.068162074 | 3.075820481 | 0.003343245 |
| 5881-17-4 | FI | 5881-17-4 | 0.610092382 | 0.198981025 | 3.066083225 | 0.003436606 |
| Texture liking | FI | Texture liking | 0.259669074 | 0.087872647 | 2.955061469 | 0.004688336 |
| 110-93-0 | FI | 110-93-0 | 0.953100428 | 0.332295146 | 2.868234583 | 0.005950522 |
| 124-19-6 | FI | 124-19-6 | 0.187605625 | 0.067599407 | 2.775255481 | 0.00764655 |
| 40716-66-3 | FI | 40716-66-3 | 0.012225224 | 0.004774339 | 2.560610681 | 0.013391686 |
| 4077-47-8 | FI | 4077-47-8 | 0.155234712 | 0.062009848 | 2.503388047 | 0.015479382 |
| 2311-46-8 | FI | 2311-46-8 | 0.285289891 | 0.116460735 | 2.449665898 | 0.01770312 |
| 110-43-0 | FI | 110-43-0 | 0.063511302 | 0.026287634 | 2.416014405 | 0.019238908 |
| 623-42-7 | FI | 623-42-7 | 0.000890521 | 0.00037581 | 2.369604579 | 0.021553415 |
| 6728-26-3 | FI | 6728-26-3 | 0.000362515 | 0.000154123 | 2.352119763 | 0.022488154 |
| 105-54-4 | FI | 105-54-4 | 0.068437707 | 0.030320241 | 2.257162367 | 0.028225439 |
| 110-39-4 | FI | 110-39-4 | 0.015764008 | 0.007468286 | 2.110793302 | 0.039617353 |
| 78-70-6 | FI | 78-70-6 | 0.00945742 | 0.004636911 | 2.039595043 | 0.046486455 |
| 29674-47-3 | FI | 29674-47-3 | 0.207006828 | 0.105396875 | 1.96406989 | 0.054877757 |
| 5454-09-1 | FI | 5454-09-1 | 0.164626472 | 0.085193569 | 1.932381439 | 0.058768153 |
| 96-22-0 | FI | 96-22-0 | 0.054430582 | 0.028283517 | 1.924462954 | 0.059776331 |
| 104-76-7 | FI | 104-76-7 | 0.20297162 | 0.107965952 | 1.879959528 | 0.065721041 |
| 10522-34-6 | FI | 10522-34-6 | 0.881701404 | 0.482181723 | 1.828566622 | 0.073202624 |
| 7786-58-5 | FI | 7786-58-5 | 0.033623309 | 0.018618412 | 1.805917137 | 0.076720744 |
| 124-13-0 | FI | 124-13-0 | 0.309079905 | 0.173845731 | 1.777897579 | 0.08126819 |
| 112-14-1 | FI | 112-14-1 | 0.038752369 | 0.022019379 | 1.759921112 | 0.08430261 |
| 2548-87-0 | FI | 2548-87-0 | 0.603902619 | 0.345231767 | 1.749267238 | 0.086145102 |
| 628-63-7 | FI | 628-63-7 | 0.489153312 | 0.32242086 | 1.517126753 | 0.13529108 |
| 105-66-8 | FI | 105-66-8 | 0.204900665 | 0.144382328 | 1.419153353 | 0.161821044 |
| 20664-46-4 | FI | 20664-46-4 | 0.039848695 | 0.028102724 | 1.417965561 | 0.162165888 |
| 564-94-3 | FI | 564-94-3 | 0.101778765 | 0.072261153 | 1.408485214 | 0.164938746 |
| 4887-30-3 | FI | 4887-30-3 | 0.022412348 | 0.01648244 | 1.35977123 | 0.179769288 |
| 110-38-3 | FI | 110-38-3 | 0.261078873 | 0.203011174 | 1.286032031 | 0.204128981 |
| 53398-83-7 | FI | 53398-83-7 | 0.147050978 | 0.117136685 | 1.255379379 | 0.21495325 |
| 539-82-2 | FI | 539-82-2 | 0.163161085 | 0.139359792 | 1.170790241 | 0.247020557 |
| Sourness | FI | Sourness | 0.191627196 | 0.175891847 | 1.089460363 | 0.280974138 |
| intensity | | intensity | | | | |
| 29811-50-5 | FI | 29811-50-5 | 0.105533085 | 0.101374977 | 1.041017112 | 0.3026837 |
| 556-24-1 | FI | 556-24-1 | 0.009437781 | 0.009471347 | 0.996456132 | 0.323643024 |
| 589-38-8 | FI | 589-38-8 | 0.462104636 | 0.468176731 | 0.987030336 | 0.328198355 |
| 821-55-6 | FI | 821-55-6 | 0.062519944 | 0.066075819 | 0.94618493 | 0.348430479 |
| 7452-79-1 | FI | 7452-79-1 | 0.015810581 | 0.01743614 | 0.906770705 | 0.368710944 |
| 66-25-1 | FI | 66-25-1 | 0.000284247 | 0.000313822 | 0.905759531 | 0.369241001 |
| 116-53-0 | FI | 116-53-0 | 0.030002783 | 0.033817704 | 0.887191614 | 0.379060843 |
| 128-37-0 | FI | 128-37-0 | 0.122681353 | 0.146717756 | 0.8361725 | 0.406883915 |
| Ph | FI | Ph | 1.87907784 | 2.549336361 | 0.737085097 | 0.464383469 |
| 106-70-7 | FI | 106-70-7 | 0.002290944 | 0.003305805 | 0.693006285 | 0.491389326 |
| 1534-08-3 | FI | 1534-08-3 | 1.808187041 | 2.895480928 | 0.62448591 | 0.535039031 |
| 71-41-0 | FI | 71-41-0 | 0.244542457 | 0.403970195 | 0.605347771 | 0.547580932 |
| 123-66-0 | FI | 123-66-0 | 0.002385596 | 0.004241953 | 0.562381505 | 0.576272599 |
| 75-85-4 | FI | 75-85-4 | 0.105118006 | 0.245597992 | 0.428008409 | 0.670412524 |
| 140-11-4 | FI | 140-11-4 | 0.022035617 | 0.063278921 | 0.348229973 | 0.729073349 |
| 2497-18-9 | FI | 2497-18-9 | 0.008247786 | 0.025315978 | 0.325793695 | 0.745887892 |
| 624-41-9 | FI | 624-41-9 | 0.009695911 | 0.030015933 | 0.323025469 | 0.747971351 |
| 96-04-8 | FI | 96-04-8 | 0.019585827 | 0.068404621 | 0.286323152 | 0.775768293 |
| 123-92-2 | FI | 123-92-2 | 0.005815982 | 0.025280458 | 0.230058392 | 0.818949026 |
| Malic | FI | Malic | 0.001142469 | 0.010557933 | 0.108209547 | 0.914245935 |
| 103-09-3 | FI | 103-09-3 | 0.019652674 | 0.486981222 | 0.040356123 | 0.96796376 |
| 1576-95-0 | FI | 1576-95-0 | −0.006041966 | 0.27670679 | −0.021835266 | 0.982662936 |
| 928-95-0 | FI | 928-95-0 | −0.000637898 | 0.008832411 | −0.072222372 | 0.942702019 |
| 55514-48-2 | FI | 55514-48-2 | −0.1505507 | 1.030864654 | −0.14604313 | 0.884452026 |
| 109-60-4 | FI | 109-60-4 | −0.05307496 | 0.20009876 | −0.265243824 | 0.791870326 |
| 111-27-3 | FI | 111-27-3 | −0.0018865 | 0.005748936 | −0.328147589 | 0.744117777 |
| Puncture | FI | Puncture force | −1.078845267 | 3.104866186 | −0.347469167 | 0.729641387 |
| force | | | | | | |
| 108-10-1 | FI | 108-10-1 | −0.072978472 | 0.209224799 | −0.348804119 | 0.728644778 |
| 105-37-3 | FI | 105-37-3 | −0.013710834 | 0.038501458 | −0.356112069 | 0.723197424 |
| 1191-16-8 | FI | 1191-16-8 | −0.035891159 | 0.077755853 | −0.461587875 | 0.646302095 |
| 106-32-1 | FI | 106-32-1 | −0.092492463 | 0.183129853 | −0.505064911 | 0.615647208 |
| 15111-96-3 | FI | 15111-96-3 | −0.236480496 | 0.458271776 | −0.516026751 | 0.608023105 |
| 623-43-8 | FI | 623-43-8 | −0.100966561 | 0.159353652 | −0.633600548 | 0.529118704 |
| 624-24-8 | FI | 624-24-8 | −0.100012454 | 0.146523439 | −0.682569658 | 0.497908421 |
| 2432-51-1 | FI | 2432-51-1 | −0.08748755 | 0.093014621 | −0.940578471 | 0.351269944 |
| 134-20-3 | FI | 134-20-3 | −0.848408207 | 0.802706543 | −1.05693446 | 0.295427129 |
| 110-62-3 | FI | 110-62-3 | −0.124867795 | 0.059031204 | −2.115284566 | 0.039215403 |

TABLE 8
Parameter Estimates-fit to Texture Liking

| X | Y | Term | Estimate | Std error | T ratio | Prob > \|t\| |
|---|---|---|---|---|---|---|
| Overall liking | Texture liking | Overall liking | 0.704423751 | 0.099585244 | 7.073575623 | 3.77694e−09 |
| Puncture | Texture liking | Puncture | 19.57505136 | 3.638097081 | 5.380574218 | 1.79498e−06 |
| force | | force | | | | |
| Malic | Texture liking | Malic | 0.059054928 | 0.013064723 | 4.520182153 | 3.5975e−05 |
| 104-76-7 | Texture liking | 104-76-7 | 0.564456817 | 0.142895485 | 3.95013751 | 0.000236287 |
| 1629-58-9 | Texture liking | 1629-58-9 | 0.033758989 | 0.011121147 | 3.035567204 | 0.00374525 |
| 1576-87-0 | Texture liking | 1576-87-0 | 0.108853388 | 0.036653294 | 2.969811839 | 0.004500465 |
| Flavor | Texture liking | Flavor | 0.553722856 | 0.187381163 | 2.955061469 | 0.004688336 |
| intensity | | intensity | | | | |
| 638-11-9 | Texture liking | 638-11-9 | 0.032009586 | 0.010963915 | 2.919539873 | 0.005171149 |
| 40716-66-3 | Texture liking | 40716-66-3 | 0.019405835 | 0.006891578 | 2.815876966 | 0.006857044 |
| 2548-87-0 | Texture liking | 2548-87-0 | 1.344965739 | 0.484066631 | 2.77847233 | 0.007581096 |
| 111-71-7 | Texture liking | 111-71-7 | 0.881398277 | 0.328052903 | 2.686756525 | 0.009664799 |
| Sweetness | Texture liking | Sweetness | 0.406891376 | 0.155014751 | 2.624855849 | 0.011355282 |
| intensity | | intensity | | | | |
| 110-38-3 | Texture liking | 110-38-3 | 0.742143881 | 0.282997853 | 2.622436441 | 0.011426537 |
| 2305-05-7 | Texture liking | 2305-05-7 | 0.291182135 | 0.11134981 | 2.615021391 | 0.011647472 |
| 60415-61-4 | Texture liking | 60415-61-4 | 1.167266601 | 0.47576074 | 2.453473988 | 0.017536478 |
| Sucrose | Texture liking | Sucrose | 0.002837567 | 0.001165651 | 2.434320123 | 0.018389216 |
| 5454-09-1 | Texture liking | 5454-09-1 | 0.262063317 | 0.123562317 | 2.120899993 | 0.038717861 |
| 5989-33-3 | Texture liking | 5989-33-3 | 0.660511112 | 0.314261738 | 2.101786609 | 0.040434269 |
| 110-62-3 | Texture liking | 110-62-3 | 0.178885825 | 0.086341226 | 2.071847173 | 0.043256314 |
| 109-21-7 | Texture liking | 109-21-7 | 0.009477602 | 0.004886235 | 1.939653546 | 0.057855106 |
| Total_sugar | Texture liking | Total_sugar | 0.001436085 | 0.000740489 | 1.939372551 | 0.057890159 |
| 124-19-6 | Texture liking | 124-19-6 | 0.195205656 | 0.102249621 | 1.909108856 | 0.061773305 |
| 110-93-0 | Texture liking | 110-93-0 | 0.962719962 | 0.50486605 | 1.906881958 | 0.062067605 |
| 540-18-1 | Texture liking | 540-18-1 | 0.45075568 | 0.241438975 | 1.866954911 | 0.067550156 |
| 105-66-8 | Texture liking | 105-66-8 | 0.387261406 | 0.208063808 | 1.861262705 | 0.068364231 |
| 110-43-0 | Texture liking | 110-43-0 | 0.072617259 | 0.03921211 | 1.851908974 | 0.069719981 |
| 1576-86-9 | Texture liking | 1576-86-9 | 0.063724257 | 0.035583228 | 1.790850906 | 0.079138673 |
| 4077-47-8 | Texture liking | 4077-47-8 | 0.166395996 | 0.093034221 | 1.788546131 | 0.079514125 |
| Ph | Texture liking | Ph | 6.407679141 | 3.635112219 | 1.762718385 | 0.083824322 |
| Ssc | Texture liking | Ssc | 0.937754637 | 0.541029328 | 1.733278748 | 0.08897288 |
| 10522-34-6 | Texture liking | 10522-34-6 | 1.143214207 | 0.70889454 | 1.612671762 | 0.112869192 |
| 109-19-3 | Texture liking | 109-19-3 | 0.317826899 | 0.202511942 | 1.569422996 | 0.122615111 |
| 706-14-9 | Texture liking | 706-14-9 | 0.014846554 | 0.009588068 | 1.548440549 | 0.127581442 |
| 2639-63-6 | Texture liking | 2639-63-6 | 0.088209156 | 0.059901252 | 1.472576152 | 0.146892662 |
| 2432-51-1 | Texture liking | 2432-51-1 | 0.184422292 | 0.134569265 | 1.370463694 | 0.176429609 |
| 564-94-3 | Texture liking | 564-94-3 | 0.144505616 | 0.105631498 | 1.368016347 | 0.177189782 |
| 110-39-4 | Texture liking | 110-39-4 | 0.015090215 | 0.011169053 | 1.35107383 | 0.182521313 |
| 3913-81-3 | Texture liking | 3913-81-3 | 0.74692113 | 0.553286643 | 1.349971375 | 0.182872435 |
| 539-82-2 | Texture liking | 539-82-2 | 0.256879447 | 0.203068257 | 1.264990648 | 0.21151436 |
| 624-24-8 | Texture liking | 624-24-8 | 0.259649832 | 0.211883939 | 1.225434234 | 0.225933162 |
| 116-53-0 | Texture liking | 116-53-0 | 0.058394418 | 0.049092266 | 1.189483038 | 0.239652668 |
| Ta | Texture liking | Ta | 6.537355857 | 5.553172434 | 1.177229041 | 0.24446444 |
| 123-86-4 | Texture liking | 123-86-4 | 0.010826602 | 0.009241187 | 1.171559633 | 0.246714109 |
| Total_volatiles | Texture liking | Total_volatiles | 0.000172863 | 0.000149922 | 1.153018188 | 0.254175626 |
| 5881-17-4 | Texture liking | 5881-17-4 | 0.358064643 | 0.311813863 | 1.148328171 | 0.256088352 |
| 66-25-1 | Texture liking | 66-25-1 | 0.000509898 | 0.000456424 | 1.117158519 | 0.269061803 |
| 78-70-6 | Texture liking | 78-70-6 | 0.007728781 | 0.006954719 | 1.111300154 | 0.271551139 |
| 142-92-7 | Texture liking | 142-92-7 | 0.01748378 | 0.015820607 | 1.105127005 | 0.274191748 |
| 2311-46-8 | Texture liking | 2311-46-8 | 0.195374152 | 0.177555046 | 1.10035821 | 0.276243958 |
| Sourness | Texture liking | Sourness | 0.279733118 | 0.256853347 | 1.089077177 | 0.281141482 |
| intensity | | intensity | | | | |
| 821-55-6 | Texture liking | 821-55-6 | 0.095078119 | 0.096418933 | 0.986093873 | 0.328653259 |
| 53398-83-7 | Texture liking | 53398-83-7 | 0.16649108 | 0.172083119 | 0.96750385 | 0.337770715 |
| 128-37-0 | Texture liking | 128-37-0 | 0.200867521 | 0.213878265 | 0.939167524 | 0.351986907 |
| 4887-30-3 | Texture liking | 4887-30-3 | 0.022310859 | 0.024296952 | 0.918257512 | 0.362723805 |
| 75-85-4 | Texture liking | 75-85-4 | 0.321878958 | 0.35648935 | 0.902913251 | 0.370735636 |
| Glucose | Texture liking | Glucose | 0.001743629 | 0.002089239 | 0.834576227 | 0.407774215 |
| 6728-26-3 | Texture liking | 6728-26-3 | 0.000185022 | 0.000235338 | 0.786198066 | 0.435319637 |
| 71-41-0 | Texture liking | 71-41-0 | 0.37269126 | 0.589724072 | 0.631975661 | 0.530171616 |
| 589-38-8 | Texture liking | 589-38-8 | 0.430620648 | 0.687454904 | 0.626398394 | 0.533793951 |
| 616-25-1 | Texture liking | 616-25-1 | 0.064014756 | 0.107847376 | 0.593568042 | 0.555374334 |
| 7452-79-1 | Texture liking | 7452-79-1 | 0.01324401 | 0.025596351 | 0.517417905 | 0.607058643 |
| 105-54-4 | Texture liking | 105-54-4 | 0.022681469 | 0.046287627 | 0.490011482 | 0.626186885 |
| 591-78-6 | Texture liking | 591-78-6 | 0.022105416 | 0.056954016 | 0.388127425 | 0.699506179 |
| Fructose | Texture liking | Fructose | 0.000751002 | 0.002082152 | 0.360685369 | 0.719795789 |
| 1576-95-0 | Texture liking | 1576-95-0 | 0.136937368 | 0.403624748 | 0.339269007 | 0.735773476 |
| 29674-47-3 | Texture liking | 29674-47-3 | 0.026929113 | 0.159471893 | 0.168864319 | 0.866558518 |
| 108-10-1 | Texture liking | 108-10-1 | 0.050685024 | 0.305803217 | 0.165743921 | 0.86900121 |
| 623-42-7 | Texture liking | 623-42-7 | 6.89219e−05 | 0.000577579 | 0.119329005 | 0.905474528 |
| 96-22-0 | Texture liking | 96-22-0 | 0.004596032 | 0.042742611 | 0.107528105 | 0.914783841 |
| 1534-08-3 | Texture liking | 1534-08-3 | 0.064492476 | 4.244028686 | 0.015196051 | 0.987933927 |
| 123-66-0 | Texture liking | 123-66-0 | −0.000335389 | 0.006213073 | −0.05398122 | 0.957156988 |
| 15111-96-3 | Texture liking | 15111-96-3 | −0.105615131 | 0.670756443 | −0.157456753 | 0.87549471 |
| 105-37-3 | Texture liking | 105-37-3 | −0.010617876 | 0.056272161 | −0.188687894 | 0.851071931 |
| 112-14-1 | Texture liking | 112-14-1 | −0.00657451 | 0.033085668 | −0.198711713 | 0.84326316 |
| Citric | Texture liking | Citric | −0.001830743 | 0.005397483 | −0.339184476 | 0.73583678 |
| 7786-58-5 | Texture liking | 7786-58-5 | −0.010566629 | 0.027989388 | −0.377522665 | 0.707321754 |
| 628-63-7 | Texture liking | 628-63-7 | −0.190731118 | 0.480404359 | −0.397022038 | 0.692976086 |
| 106-70-7 | Texture liking | 106-70-7 | −0.002646628 | 0.004835734 | −0.547306314 | 0.586509734 |
| 106-32-1 | Texture liking | 106-32-1 | −0.16392656 | 0.267110387 | −0.613703427 | 0.542086814 |
| 2497-18-9 | Texture liking | 2497-18-9 | −0.024559184 | 0.036849073 | −0.666480369 | 0.508050479 |
| 624-41-9 | Texture liking | 624-41-9 | −0.035121739 | 0.043604451 | −0.805462256 | 0.424220903 |
| 1191-16-8 | Texture liking | 1191-16-8 | −0.098986895 | 0.112946589 | −0.876404458 | 0.384840992 |
| 140-11-4 | Texture liking | 140-11-4 | −0.084900404 | 0.091760381 | −0.925240316 | 0.359115021 |
| 29811-50-5 | Texture liking | 29811-50-5 | −0.14114033 | 0.148284315 | −0.95182238 | 0.345590494 |
| 20664-46-4 | Texture liking | 20664-46-4 | −0.041211733 | 0.041431393 | −0.994698226 | 0.324489359 |
| 96-04-8 | Texture liking | 96-04-8 | −0.099532488 | 0.09901115 | −1.005265441 | 0.319424134 |
| 928-95-0 | Texture liking | 928-95-0 | −0.013295718 | 0.012765978 | −1.041496248 | 0.302463501 |
| 124-13-0 | Texture liking | 124-13-0 | −0.286517794 | 0.258428815 | −1.108691358 | 0.272664876 |
| 111-27-3 | Texture liking | 111-27-3 | −0.012041434 | 0.008236172 | −1.462018372 | 0.149753723 |
| 109-60-4 | Texture liking | 109-60-4 | −0.513736159 | 0.28358596 | −1.811571204 | 0.075829476 |
| 55514-48-2 | Texture liking | 55514-48-2 | −2.984063203 | 1.447676756 | −2.061277278 | 0.044292744 |
| 123-92-2 | Texture liking | 123-92-2 | −0.079967388 | 0.035231263 | −2.269784923 | 0.027394548 |
| 556-24-1 | Texture liking | 556-24-1 | −0.031393249 | 0.01326618 | −2.366412035 | 0.021721447 |
| 103-09-3 | Texture liking | 103-09-3 | −1.954725288 | 0.65744986 | −2.97319295 | 0.0044584 |
| 623-43-8 | Texture liking | 623-43-8 | −0.713253749 | 0.211623452 | −3.370390863 | 0.001421601 |
| 134-20-3 | Texture liking | 134-20-3 | −4.492524789 | 1.007662744 | −4.458361504 | 4.43306e−05 |

TABLE 9
Parameter Estimates-fit to Sweetness Intensity

| X | Y | Term | Estimate | Std error | T ratio | Prob > \|t\| |
|---|---|---|---|---|---|---|
| Overall liking | Sweetness | Overall liking | 0.728202872 | 0.059614208 | 12.2152571 | 6.68455e−17 |
| | intensity | | | | | |
| | (SI) | | | | | |
| Flavor intensity | SI | Flavor intensity | 1.049302293 | 0.088346857 | 11.87707554 | 1.97185e−16 |
| Ssc | SI | Ssc | 2.802364897 | 0.26033879 | 10.76430022 | 7.684e−15 |
| Total_sugar | SI | Total_sugar | 0.003853356 | 0.000360503 | 10.68882031 | 9.9069e−15 |
| Sucrose | SI | Sucrose | 0.004972532 | 0.000770776 | 6.451335171 | 3.70576e−08 |
| 1629-58-9 | SI | 1629-58-9 | 0.044893505 | 0.008008107 | 5.606007135 | 8.00713e−07 |
| Glucose | SI | Glucose | 0.007410268 | 0.001438697 | 5.150679126 | 4.05654e−06 |
| Fructose | SI | Fructose | 0.006922856 | 0.00146617 | 4.721726629 | 1.80838e−05 |
| 2639-63-6 | SI | 2639-63-6 | 0.201568196 | 0.043127998 | 4.673720172 | 2.13227e−05 |
| 2305-05-7 | SI | 2305-05-7 | 0.390107443 | 0.08359066 | 4.666878352 | 2.18283e−05 |
| 540-18-1 | SI | 540-18-1 | 0.761893452 | 0.181084242 | 4.207397858 | 0.000102333 |
| 1576-87-0 | SI | 1576-87-0 | 0.118274969 | 0.029006639 | 4.077513724 | 0.000156571 |
| 142-92-7 | SI | 142-92-7 | 0.047434612 | 0.011736964 | 4.041472207 | 0.000176007 |
| 60415-61-4 | SI | 60415-61-4 | 1.469136275 | 0.370083105 | 3.969746948 | 0.000221863 |
| 1576-86-9 | SI | 1576-86-9 | 0.103616054 | 0.027266694 | 3.800095959 | 0.000380821 |
| 109-21-7 | SI | 109-21-7 | 0.013643415 | 0.003809573 | 3.581349947 | 0.000751861 |
| 111-71-7 | SI | 111-71-7 | 0.936715629 | 0.264071771 | 3.547200919 | 0.000834617 |
| 3913-81-3 | SI | 3913-81-3 | 1.493383575 | 0.425466471 | 3.509991209 | 0.000934666 |
| 109-19-3 | SI | 109-19-3 | 0.538382675 | 0.157415636 | 3.420134676 | 0.001225503 |
| 5989-33-3 | SI | 5989-33-3 | 0.82162569 | 0.250474083 | 3.280282252 | 0.001854796 |
| 123-86-4 | SI | 123-86-4 | 0.022530987 | 0.007223527 | 3.119111526 | 0.002956222 |
| 706-14-9 | SI | 706-14-9 | 0.023087132 | 0.007596681 | 3.039107629 | 0.003708156 |
| 638-11-9 | SI | 638-11-9 | 0.0278255 | 0.009164112 | 3.036355302 | 0.003736963 |
| 110-93-0 | SI | 110-93-0 | 1.228262475 | 0.404604511 | 3.03571127 | 0.003743734 |
| 591-78-6 | SI | 591-78-6 | 0.131017351 | 0.044370986 | 2.952770753 | 0.004718159 |
| Total_volatiles | SI | Total_volatiles | 0.000343659 | 0.000118399 | 2.902551443 | 0.005418048 |
| 124-19-6 | SI | 124-19-6 | 0.238827564 | 0.082517338 | 2.894271328 | 0.005542314 |
| 5454-09-1 | SI | 5454-09-1 | 0.283701505 | 0.100869174 | 2.812568949 | 0.006918404 |
| Citric | SI | Citric | 0.011546426 | 0.004250746 | 2.716329333 | 0.008941548 |
| 110-39-4 | SI | 110-39-4 | 0.024182062 | 0.008944483 | 2.703573072 | 0.009247199 |
| 53398-83-7 | SI | 53398-83-7 | 0.369055998 | 0.13668796 | 2.699989068 | 0.009334785 |
| 104-76-7 | SI | 104-76-7 | 0.338627847 | 0.128662879 | 2.631900114 | 0.011150123 |
| Texture liking | SI | Texture liking | 0.287535749 | 0.109543444 | 2.624855849 | 0.011355282 |
| 5881-17-4 | SI | 5881-17-4 | 0.639641713 | 0.250163432 | 2.556895338 | 0.013519044 |
| 4077-47-8 | SI | 4077-47-8 | 0.192026883 | 0.076049894 | 2.525011845 | 0.014658067 |
| 110-43-0 | SI | 110-43-0 | 0.079978555 | 0.032174701 | 2.485759071 | 0.016179558 |
| Ta | SI | Ta | 10.47789723 | 4.501270618 | 2.327764341 | 0.023850601 |
| 616-25-1 | SI | 616-25-1 | 0.201442895 | 0.086571216 | 2.326903841 | 0.023900057 |
| 10522-34-6 | SI | 10522-34-6 | 1.337507901 | 0.581790067 | 2.298952796 | 0.025557086 |
| 40716-66-3 | SI | 40716-66-3 | 0.013585106 | 0.005927123 | 2.292023792 | 0.025983363 |
| 623-42-7 | SI | 623-42-7 | 0.001020893 | 0.000464503 | 2.197818526 | 0.032438429 |
| 2311-46-8 | SI | 2311-46-8 | 0.316921163 | 0.14444853 | 2.194007531 | 0.032727022 |
| 6728-26-3 | SI | 6728-26-3 | 0.000399602 | 0.000191134 | 2.090688956 | 0.041461016 |
| 105-66-8 | SI | 105-66-8 | 0.362057693 | 0.173519701 | 2.086550932 | 0.041849638 |
| 4887-30-3 | SI | 4887-30-3 | 0.040670655 | 0.01980224 | 2.053841153 | 0.045034754 |
| 110-38-3 | SI | 110-38-3 | 0.482159946 | 0.244150312 | 1.974848782 | 0.05360578 |
| 7786-58-5 | SI | 7786-58-5 | 0.04450125 | 0.022738485 | 1.957089474 | 0.055715234 |
| 112-14-1 | SI | 112-14-1 | 0.051565087 | 0.026888885 | 1.917710099 | 0.060647727 |
| 2548-87-0 | SI | 2548-87-0 | 0.796971764 | 0.421846163 | 1.889247395 | 0.064440557 |
| 96-22-0 | SI | 96-22-0 | 0.064879607 | 0.034790303 | 1.864876187 | 0.06784649 |
| 105-54-4 | SI | 105-54-4 | 0.070098155 | 0.037769782 | 1.855932231 | 0.069134082 |
| 124-13-0 | SI | 124-13-0 | 0.365870022 | 0.213860428 | 1.710788787 | 0.093080384 |
| 29674-47-3 | SI | 29674-47-3 | 0.218405403 | 0.130628937 | 1.671952688 | 0.10054131 |
| Ph | SI | Ph | 4.987403847 | 3.068797221 | 1.625198241 | 0.110166764 |
| 71-41-0 | SI | 71-41-0 | 0.764807562 | 0.486208656 | 1.57300277 | 0.121783541 |
| 628-63-7 | SI | 628-63-7 | 0.580105835 | 0.396374501 | 1.46352965 | 0.149341518 |
| 556-24-1 | SI | 556-24-1 | 0.016750089 | 0.011504984 | 1.455898534 | 0.151432064 |
| 564-94-3 | SI | 564-94-3 | 0.112679385 | 0.089020142 | 1.265774034 | 0.21123588 |
| 20664-46-4 | SI | 20664-46-4 | 0.043446315 | 0.034638327 | 1.254284459 | 0.215347626 |
| 539-82-2 | SI | 539-82-2 | 0.196910118 | 0.171147972 | 1.150525569 | 0.255190911 |
| 1534-08-3 | SI | 1534-08-3 | 3.755262281 | 3.529469086 | 1.0639737 | 0.292256544 |
| 106-70-7 | SI | 106-70-7 | 0.004162372 | 0.004035701 | 1.031387609 | 0.307132455 |
| 116-53-0 | SI | 116-53-0 | 0.039977487 | 0.041457238 | 0.964306566 | 0.339355519 |
| 78-70-6 | SI | 78-70-6 | 0.005529987 | 0.005865468 | 0.942803992 | 0.350140999 |
| 123-66-0 | SI | 123-66-0 | 0.004861165 | 0.005179378 | 0.938561515 | 0.352295139 |
| 7452-79-1 | SI | 7452-79-1 | 0.018000208 | 0.021427564 | 0.840049185 | 0.404726721 |
| 821-55-6 | SI | 821-55-6 | 0.066587022 | 0.081284494 | 0.819184808 | 0.416419719 |
| 66-25-1 | SI | 66-25-1 | 0.00029064 | 0.000386165 | 0.752631471 | 0.455065167 |
| 589-38-8 | SI | 589-38-8 | 0.407044676 | 0.577320865 | 0.705057967 | 0.483920455 |
| 128-37-0 | SI | 128-37-0 | 0.079150564 | 0.180979122 | 0.43734638 | 0.663671219 |
| 29811-50-5 | SI | 29811-50-5 | 0.043876347 | 0.125586638 | 0.349371143 | 0.728221608 |
| 15111-96-3 | SI | 15111-96-3 | 0.194593061 | 0.56334878 | 0.345421998 | 0.731170615 |
| 2432-51-1 | SI | 2432-51-1 | 0.033855313 | 0.115052491 | 0.294259715 | 0.769730919 |
| 624-24-8 | SI | 624-24-8 | 0.050832225 | 0.180532741 | 0.281567903 | 0.779392348 |
| 134-20-3 | SI | 134-20-3 | 0.218317026 | 0.995438366 | 0.219317472 | 0.827261373 |
| 1576-95-0 | SI | 1576-95-0 | 0.043500971 | 0.339622222 | 0.128086351 | 0.898574723 |
| 105-37-3 | SI | 105-37-3 | 0.001615972 | 0.047319923 | 0.03414994 | 0.972888338 |
| 96-04-8 | SI | 96-04-8 | −0.000378325 | 0.084036938 | −0.004501887 | 0.996425253 |
| 75-85-4 | SI | 75-85-4 | −0.001819026 | 0.302016797 | −0.006022929 | 0.995217474 |
| 103-09-3 | SI | 103-09-3 | −0.030079674 | 0.597793564 | −0.050317829 | 0.960061902 |
| 2497-18-9 | SI | 2497-18-9 | −0.002599887 | 0.031106498 | −0.083580174 | 0.933711161 |
| 123-92-2 | SI | 123-92-2 | −0.003716781 | 0.031044795 | −0.11972317 | 0.905163809 |
| 108-10-1 | SI | 108-10-1 | −0.092140162 | 0.256818651 | −0.358775196 | 0.721215892 |
| 623-43-8 | SI | 623-43-8 | −0.071147622 | 0.196121823 | −0.362772592 | 0.718245197 |
| 106-32-1 | SI | 106-32-1 | −0.088932668 | 0.225015921 | −0.395228335 | 0.694291087 |
| Puncture force | SI | Puncture force | −2.03909884 | 3.805340403 | −0.535851888 | 0.594345662 |
| Malic | SI | Malic | −0.008646537 | 0.012906378 | −0.669942913 | 0.505858447 |
| 140-11-4 | SI | 140-11-4 | −0.052423356 | 0.07742867 | −0.677053552 | 0.501373022 |
| 111-27-3 | SI | 111-27-3 | −0.004768989 | 0.007033445 | −0.678044618 | 0.500749578 |
| 109-60-4 | SI | 109-60-4 | −0.167738085 | 0.244696255 | −0.685495104 | 0.496076316 |
| 110-62-3 | SI | 110-62-3 | −0.051596612 | 0.075177954 | −0.686326367 | 0.495556401 |
| 928-95-0 | SI | 928-95-0 | −0.00788094 | 0.010787641 | −0.730552676 | 0.468331301 |
| 55514-48-2 | SI | 55514-48-2 | −1.097025628 | 1.256532097 | −0.873058182 | 0.386645261 |
| 624-41-9 | SI | 624-41-9 | −0.042980069 | 0.036398546 | −1.180818282 | 0.24304788 |
| Sourness | SI | Sourness | −0.381262298 | 0.21187081 | −1.799503657 | 0.077742341 |
| intensity | | intensity | | | | |

TABLE 10
Parameter Estimates-fit to Sourness Intensity

| X | Y | Term | Estimate | Std error | T ratio | Prob > \|t\| |
|---|---|---|---|---|---|---|
| Ta | Sourness | Ta | 12.14084796 | 2.487586422 | 4.880573333 | 1.04441e−05 |
| | intensity | | | | | |
| | (SrI) | | | | | |
| Malic | SrI | Malic | 0.025799683 | 0.007413322 | 3.480178191 | 0.001022973 |
| Citric | SrI | Citric | 0.00793668 | 0.002666384 | 2.976570222 | 0.00441675 |
| 624-41-9 | SrI | 624-41-9 | 0.052518939 | 0.022261738 | 2.359157144 | 0.02210766 |
| 1191-16-8 | SrI | 1191-16-8 | 0.114460075 | 0.058629092 | 1.9522744 | 0.056299288 |
| 78-70-6 | SrI | 78-70-6 | 0.007041627 | 0.00362744 | 1.941211199 | 0.05766112 |
| 589-38-8 | SrI | 589-38-8 | 0.660089033 | 0.356822531 | 1.849908496 | 0.070012864 |
| 928-95-0 | SrI | 928-95-0 | 0.011054513 | 0.006712963 | 1.646741234 | 0.105642337 |
| 128-37-0 | SrI | 128-37-0 | 0.183488403 | 0.112295512 | 1.633978062 | 0.108304166 |
| 2497-18-9 | SrI | 2497-18-9 | 0.026915647 | 0.019399752 | 1.387422177 | 0.171230684 |
| 111-27-3 | SrI | 111-27-3 | 0.006106905 | 0.004405645 | 1.386154446 | 0.171615202 |
| 96-04-8 | SrI | 96-04-8 | 0.070037718 | 0.052476572 | 1.334647345 | 0.187806481 |
| 140-11-4 | SrI | 140-11-4 | 0.062728275 | 0.048615343 | 1.290297914 | 0.202655506 |
| 55514-48-2 | SrI | 55514-48-2 | 0.95889779 | 0.792714208 | 1.209638708 | 0.231888273 |
| 2548-87-0 | SrI | 2548-87-0 | 0.32932048 | 0.273144119 | 1.205665643 | 0.233404062 |
| Flavor | SrI | Flavor | 0.116455727 | 0.106893037 | 1.089460363 | 0.280974138 |
| intensity | | intensity | | | | |
| Texture liking | SrI | Texture liking | 0.079721483 | 0.073200949 | 1.089077177 | 0.281141482 |
| 103-09-3 | SrI | 103-09-3 | 0.352215181 | 0.376483889 | 0.935538521 | 0.353835337 |
| 5989-33-3 | SrI | 5989-33-3 | 0.147950397 | 0.173539501 | 0.852545939 | 0.397820913 |
| 5881-17-4 | SrI | 5881-17-4 | 0.141865984 | 0.167405871 | 0.847437327 | 0.400635099 |
| 1576-95-0 | SrI | 1576-95-0 | 0.176824061 | 0.214313427 | 0.825072246 | 0.41309962 |
| 20664-46-4 | SrI | 20664-46-4 | 0.017913358 | 0.022188781 | 0.807316003 | 0.42316195 |
| 29811-50-5 | SrI | 29811-50-5 | 0.062335787 | 0.079378244 | 0.785300658 | 0.435840833 |
| 123-92-2 | SrI | 123-92-2 | 0.01491487 | 0.019608986 | 0.760614021 | 0.450322931 |
| 110-93-0 | SrI | 110-93-0 | 0.21022057 | 0.277256306 | 0.758217451 | 0.45174364 |
| 29674-47-3 | SrI | 29674-47-3 | 0.063910374 | 0.084694265 | 0.754600964 | 0.453892458 |
| Sucrose | SrI | Sucrose | 0.000469106 | 0.000653549 | 0.717782463 | 0.476103866 |
| 4077-47-8 | SrI | 4077-47-8 | 0.03407402 | 0.05095214 | 0.668745605 | 0.506615846 |
| 539-82-2 | SrI | 539-82-2 | 0.072778999 | 0.109598768 | 0.664049426 | 0.509592495 |
| 591-78-6 | SrI | 591-78-6 | 0.019941652 | 0.030322825 | 0.657644938 | 0.513667084 |
| 111-71-7 | SrI | 111-71-7 | 0.101351563 | 0.186361265 | 0.543844576 | 0.588872696 |
| 106-32-1 | SrI | 106-32-1 | 0.077170987 | 0.142710512 | 0.540751947 | 0.590987523 |
| 66-25-1 | SrI | 66-25-1 | 0.000127975 | 0.000245927 | 0.520378088 | 0.605008746 |
| 564-94-3 | SrI | 564-94-3 | 0.029742056 | 0.057248316 | 0.519527169 | 0.605597672 |
| 109-60-4 | SrI | 109-60-4 | 0.076310694 | 0.15573618 | 0.489999783 | 0.626195107 |
| 1576-86-9 | SrI | 1576-86-9 | 0.009049626 | 0.019532712 | 0.463306167 | 0.645078283 |
| 124-13-0 | SrI | 124-13-0 | 0.06169217 | 0.13931975 | 0.442809938 | 0.659739852 |
| 1629-58-9 | SrI | 1629-58-9 | 0.002688625 | 0.006430766 | 0.418087877 | 0.677604424 |
| 96-22-0 | SrI | 96-22-0 | 0.00818041 | 0.022792282 | 0.358911405 | 0.721114596 |
| 616-25-1 | SrI | 616-25-1 | 0.019916507 | 0.05770251 | 0.34515841 | 0.731367594 |
| 75-85-4 | SrI | 75-85-4 | 0.064796442 | 0.191585733 | 0.338211205 | 0.736565775 |
| 2311-46-8 | SrI | 2311-46-8 | 0.027071215 | 0.095810655 | 0.282549104 | 0.778644151 |
| Total_volatiles | SrI | Total_volatiles | 1.70322e−05 | 8.10175e−05 | 0.210228894 | 0.834310611 |
| 1576-87-0 | SrI | 1576-87-0 | 0.003981949 | 0.021154444 | 0.188232255 | 0.851427248 |
| 124-19-6 | SrI | 124-19-6 | 0.008372149 | 0.056454146 | 0.148299983 | 0.882679622 |
| 108-10-1 | SrI | 108-10-1 | 0.02346442 | 0.163262423 | 0.143722113 | 0.886275441 |
| 6728-26-3 | SrI | 6728-26-3 | 1.45925e−05 | 0.000126362 | 0.115481246 | 0.908508486 |
| 105-66-8 | SrI | 105-66-8 | 0.009029302 | 0.114707418 | 0.078715935 | 0.937560707 |
| Puncture | SrI | Puncture | 0.143065743 | 2.42316941 | 0.059040752 | 0.953145963 |
| force | | force | | | | |
| 821-55-6 | SrI | 821-55-6 | 0.000202617 | 0.051951857 | 0.003900089 | 0.996903111 |
| 623-42-7 | SrI | 623-42-7 | −1.30318e−05 | 0.000308375 | −0.042259736 | 0.966453495 |
| 105-37-3 | SrI | 105-37-3 | −0.001379859 | 0.030050324 | −0.045918283 | 0.963551274 |
| 2305-05-7 | SrI | 2305-05-7 | −0.003021271 | 0.06323015 | −0.047782125 | 0.96207293 |
| 540-18-1 | SrI | 540-18-1 | −0.007254221 | 0.133137036 | −0.054486875 | 0.956756069 |
| 105-54-4 | SrI | 105-54-4 | −0.001915779 | 0.02476601 | −0.077355162 | 0.938637891 |
| 123-86-4 | SrI | 123-86-4 | −0.000569137 | 0.004997429 | −0.113885921 | 0.909766805 |
| 638-11-9 | SrI | 638-11-9 | −0.000804213 | 0.006313566 | −0.12737861 | 0.899132058 |
| 71-41-0 | SrI | 71-41-0 | −0.057888293 | 0.315926383 | −0.183233488 | 0.855327407 |
| 123-66-0 | SrI | 123-66-0 | −0.000635622 | 0.003315744 | −0.191698079 | 0.848725316 |
| 40716-66-3 | SrI | 40716-66-3 | −0.000813622 | 0.003947976 | −0.206085884 | 0.837528581 |
| 706-14-9 | SrI | 706-14-9 | −0.001524328 | 0.005230955 | −0.291405188 | 0.771900737 |
| 7786-58-5 | SrI | 7786-58-5 | −0.005534271 | 0.014942782 | −0.370364171 | 0.712615538 |
| 628-63-7 | SrI | 628-63-7 | −0.096292244 | 0.25650286 | −0.375404171 | 0.708886901 |
| 3913-81-3 | SrI | 3913-81-3 | −0.128982663 | 0.299968164 | −0.429987838 | 0.66898122 |
| 2432-51-1 | SrI | 2432-51-1 | −0.033928333 | 0.072973561 | −0.464940075 | 0.643915488 |
| 116-53-0 | SrI | 116-53-0 | −0.013019377 | 0.026500414 | −0.491289567 | 0.625288931 |
| 142-92-7 | SrI | 142-92-7 | −0.005008229 | 0.008516095 | −0.588089807 | 0.559017606 |
| 60415-61-4 | SrI | 60415-61-4 | −0.162792299 | 0.267329409 | −0.608957688 | 0.54520382 |
| 109-19-3 | SrI | 109-19-3 | −0.068439929 | 0.110233114 | −0.620865427 | 0.537400186 |
| Overall liking | SrI | Overall liking | −0.047093928 | 0.074183653 | −0.63482892 | 0.528323456 |
| 109-21-7 | SrI | 109-21-7 | −0.002039387 | 0.002686366 | −0.759161972 | 0.451183408 |
| 2639-63-6 | SrI | 2639-63-6 | −0.025093991 | 0.032451935 | −0.773266391 | 0.442865795 |
| 110-38-3 | SrI | 110-38-3 | −0.125127408 | 0.159818064 | −0.782936577 | 0.437215616 |
| 7452-79-1 | SrI | 7452-79-1 | −0.011292087 | 0.013609842 | −0.829700139 | 0.410501176 |
| 53398-83-7 | SrI | 53398-83-7 | −0.079932172 | 0.092023807 | −0.868603186 | 0.389055566 |
| 110-43-0 | SrI | 110-43-0 | −0.018935691 | 0.021452385 | −0.882684645 | 0.381469125 |
| 106-70-7 | SrI | 106-70-7 | −0.002340037 | 0.002568543 | −0.911036608 | 0.366480128 |
| 1534-08-3 | SrI | 1534-08-3 | −2.081558015 | 2.247197625 | −0.926290591 | 0.358574244 |
| 112-14-1 | SrI | 112-14-1 | −0.017903789 | 0.017494041 | −1.02342215 | 0.310845948 |
| Ssc | SrI | Ssc | −0.304481223 | 0.294036136 | −1.035523141 | 0.305216441 |
| Total_sugar | SrI | Total_sugar | −0.000435627 | 0.000404872 | −1.075963093 | 0.286910642 |
| 623-43-8 | SrI | 623-43-8 | −0.138147114 | 0.12322469 | −1.121099304 | 0.267396381 |
| 556-24-1 | SrI | 556-24-1 | −0.008997341 | 0.00734851 | −1.224376137 | 0.226328535 |
| 10522-34-6 | SrI | 10522-34-6 | −0.494096294 | 0.381687093 | −1.294506164 | 0.201209765 |
| 104-76-7 | SrI | 104-76-7 | −0.11160113 | 0.085591685 | −1.303878173 | 0.198017863 |
| 110-62-3 | SrI | 110-62-3 | −0.075369318 | 0.046804846 | −1.610288777 | 0.113389329 |
| 624-24-8 | SrI | 624-24-8 | −0.192580819 | 0.11158359 | −1.725888361 | 0.090305745 |
| Sweetness | SrI | Sweetness | −0.153759509 | 0.085445511 | −1.799503657 | 0.077742341 |
| intensity | | intensity | | | | |
| 110-39-4 | SrI | 110-39-4 | −0.011245327 | 0.005862435 | −1.918200642 | 0.060584064 |
| 5454-09-1 | SrI | 5454-09-1 | −0.128515254 | 0.066407219 | −1.935260307 | 0.058405236 |
| 4887-30-3 | SrI | 4887-30-3 | −0.025456696 | 0.012589996 | −2.021978143 | 0.048337551 |
| Glucose | SrI | Glucose | −0.002215863 | 0.001079908 | −2.051898521 | 0.045230367 |
| Fructose | SrI | Fructose | −0.002391333 | 0.001062384 | −2.250912108 | 0.02864508 |
| 15111-96-3 | SrI | 15111-96-3 | −0.839943078 | 0.338696533 | −2.479928182 | 0.016417372 |
| Ph | SrI | Ph | −4.956404953 | 1.875763301 | −2.642340294 | 0.010852287 |
| 134-20-3 | SrI | 134-20-3 | −1.689433923 | 0.587453081 | −2.875861881 | 0.005828141 |

TABLE 11
Parameter Estimates-fit to Flavor Intensity

| X | Y | Term | Estimate | Std error | T ratio | Prob > \|t\| |
|---|---|---|---|---|---|---|
| Sweetness | Flavor | Sweetness | 0.696329891 | 0.058628059 | 11.87707554 | 1.97185e−16 |
| intensity | intensity | intensity | | | | |
| | (FI) | | | | | |
| Overall liking | FI | Overall liking | 0.53546122 | 0.060098802 | 8.90968208 | 4.78907e−12 |
| Ssc | FI | Ssc | 2.099589408 | 0.245813014 | 8.541408664 | 1.79296e−11 |
| Total_sugar | FI | Total_sugar | 0.002857192 | 0.000344594 | 8.291472572 | 4.42006e−11 |
| Sucrose | FI | Sucrose | 0.004285612 | 0.000597156 | 7.176698734 | 2.58651e−09 |
| 1629-58-9 | FI | 1629-58-9 | 0.035544377 | 0.006631857 | 5.359641874 | 1.93398e−06 |
| 2305-05-7 | FI | 2305-05-7 | 0.311425932 | 0.06865815 | 4.535891704 | 3.411e−05 |
| 540-18-1 | FI | 540-18-1 | 0.627408558 | 0.146965271 | 4.269093995 | 8.34566e−05 |
| Ta | FI | Ta | 14.05787626 | 3.323604622 | 4.229707759 | 9.50719e−05 |
| 1576-87-0 | FI | 1576-87-0 | 0.095612684 | 0.023687 | 4.036504535 | 0.000178863 |
| 2639-63-6 | FI | 2639-63-6 | 0.146480632 | 0.036608961 | 4.001223404 | 0.000200472 |
| Citric | FI | Citric | 0.012934516 | 0.003236474 | 3.996484206 | 0.00020356 |
| 60415-61-4 | FI | 60415-61-4 | 1.196755673 | 0.301481486 | 3.969582636 | 0.00022198 |
| 142-92-7 | FI | 142-92-7 | 0.037684008 | 0.009634417 | 3.911394599 | 0.00026749 |
| 1576-86-9 | FI | 1576-86-9 | 0.085384434 | 0.022140228 | 3.85652922 | 0.000318556 |
| 5989-33-3 | FI | 5989-33-3 | 0.737768374 | 0.199451615 | 3.698984208 | 0.000522767 |
| Glucose | FI | Glucose | 0.004702108 | 0.001284198 | 3.661513606 | 0.000587285 |
| 123-86-4 | FI | 123-86-4 | 0.0209242 | 0.005717137 | 3.659909059 | 0.000590212 |
| 111-71-7 | FI | 111-71-7 | 0.775017373 | 0.21429633 | 3.616568581 | 0.000674752 |
| 109-21-7 | FI | 109-21-7 | 0.010994568 | 0.003111558 | 3.533461346 | 0.000870308 |
| 591-78-6 | FI | 591-78-6 | 0.119593926 | 0.035362697 | 3.381923251 | 0.00137365 |
| 109-19-3 | FI | 109-19-3 | 0.433436524 | 0.128570394 | 3.371200087 | 0.001418185 |
| 706-14-9 | FI | 706-14-9 | 0.020486232 | 0.006085074 | 3.366636417 | 0.001437551 |
| Total_volatiles | FI | Total_volatiles | 0.000306496 | 9.48862e−05 | 3.23014314 | 0.002147129 |
| Fructose | FI | Fructose | 0.0041928 | 0.001303875 | 3.215646489 | 0.002239435 |
| 638-11-9 | FI | 638-11-9 | 0.023685459 | 0.00740427 | 3.198891807 | 0.002350777 |
| 3913-81-3 | FI | 3913-81-3 | 1.106559919 | 0.353612616 | 3.129299886 | 0.002871462 |
| 616-25-1 | FI | 616-25-1 | 0.209654304 | 0.068162074 | 3.075820481 | 0.003343245 |
| 5881-17-4 | FI | 5881-17-4 | 0.610092382 | 0.198981025 | 3.066083225 | 0.003436606 |
| Texture liking | FI | Texture liking | 0.259669074 | 0.087872647 | 2.955061469 | 0.004688336 |
| 110-93-0 | FI | 110-93-0 | 0.953100428 | 0.332295146 | 2.868234583 | 0.005950522 |
| 124-19-6 | FI | 124-19-6 | 0.187605625 | 0.067599407 | 2.775255481 | 0.00764655 |
| 40716-66-3 | FI | 40716-66-3 | 0.012225224 | 0.004774339 | 2.560610681 | 0.013391686 |
| 4077-47-8 | FI | 4077-47-8 | 0.155234712 | 0.062009848 | 2.503388047 | 0.015479382 |
| 2311-46-8 | FI | 2311-46-8 | 0.285289891 | 0.116460735 | 2.449665898 | 0.01770312 |
| 110-43-0 | FI | 110-43-0 | 0.063511302 | 0.026287634 | 2.416014405 | 0.019238908 |
| 623-42-7 | FI | 623-42-7 | 0.000890521 | 0.00037581 | 2.369604579 | 0.021553415 |
| 6728-26-3 | FI | 6728-26-3 | 0.000362515 | 0.000154123 | 2.352119763 | 0.022488154 |
| 105-54-4 | FI | 105-54-4 | 0.068437707 | 0.030320241 | 2.257162367 | 0.028225439 |
| 110-39-4 | FI | 110-39-4 | 0.015764008 | 0.007468286 | 2.110793302 | 0.039617353 |
| 78-70-6 | FI | 78-70-6 | 0.00945742 | 0.004636911 | 2.039595043 | 0.046486455 |
| 29674-47-3 | FI | 29674-47-3 | 0.207006828 | 0.105396875 | 1.96406989 | 0.054877757 |
| 5454-09-1 | FI | 5454-09-1 | 0.164626472 | 0.085193569 | 1.932381439 | 0.058768153 |
| 96-22-0 | FI | 96-22-0 | 0.054430582 | 0.028283517 | 1.924462954 | 0.059776331 |
| 104-76-7 | FI | 104-76-7 | 0.20297162 | 0.107965952 | 1.879959528 | 0.065721041 |
| 10522-34-6 | FI | 10522-34-6 | 0.881701404 | 0.482181723 | 1.828566622 | 0.073202624 |
| 7786-58-5 | FI | 7786-58-5 | 0.033623309 | 0.018618412 | 1.805917137 | 0.076720744 |
| 124-13-0 | FI | 124-13-0 | 0.309079905 | 0.173845731 | 1.777897579 | 0.08126819 |
| 112-14-1 | FI | 112-14-1 | 0.038752369 | 0.022019379 | 1.759921112 | 0.08430261 |
| 2548-87-0 | FI | 2548-87-0 | 0.603902619 | 0.345231767 | 1.749267238 | 0.086145102 |
| 628-63-7 | FI | 628-63-7 | 0.489153312 | 0.32242086 | 1.517126753 | 0.13529108 |
| 105-66-8 | FI | 105-66-8 | 0.204900665 | 0.144382328 | 1.419153353 | 0.161821044 |
| 20664-46-4 | FI | 20664-46-4 | 0.039848695 | 0.028102724 | 1.417965561 | 0.162165888 |
| 564-94-3 | FI | 564-94-3 | 0.101778765 | 0.072261153 | 1.408485214 | 0.164938746 |
| 4887-30-3 | FI | 4887-30-3 | 0.022412348 | 0.01648244 | 1.35977123 | 0.179769288 |
| 110-38-3 | FI | 110-38-3 | 0.261078873 | 0.203011174 | 1.286032031 | 0.204128981 |
| 53398-83-7 | FI | 53398-83-7 | 0.147050978 | 0.117136685 | 1.255379379 | 0.21495325 |
| 539-82-2 | FI | 539-82-2 | 0.163161085 | 0.139359792 | 1.170790241 | 0.247020557 |
| Sourness | FI | Sourness | 0.191627196 | 0.175891847 | 1.089460363 | 0.280974138 |
| intensity | | intensity | | | | |
| 29811-50-5 | FI | 29811-50-5 | 0.105533085 | 0.101374977 | 1.041017112 | 0.3026837 |
| 556-24-1 | FI | 556-24-1 | 0.009437781 | 0.009471347 | 0.996456132 | 0.323643024 |
| 589-38-8 | FI | 589-38-8 | 0.462104636 | 0.468176731 | 0.987030336 | 0.328198355 |
| 821-55-6 | FI | 821-55-6 | 0.062519944 | 0.066075819 | 0.94618493 | 0.348430479 |
| 7452-79-1 | FI | 7452-79-1 | 0.015810581 | 0.01743614 | 0.906770705 | 0.368710944 |
| 66-25-1 | FI | 66-25-1 | 0.000284247 | 0.000313822 | 0.905759531 | 0.369241001 |
| 116-53-0 | FI | 116-53-0 | 0.030002783 | 0.033817704 | 0.887191614 | 0.379060843 |
| 128-37-0 | FI | 128-37-0 | 0.122681353 | 0.146717756 | 0.8361725 | 0.406883915 |
| Ph | FI | Ph | 1.87907784 | 2.549336361 | 0.737085097 | 0.464383469 |
| 106-70-7 | FI | 106-70-7 | 0.002290944 | 0.003305805 | 0.693006285 | 0.491389326 |
| 1534-08-3 | FI | 1534-08-3 | 1.808187041 | 2.895480928 | 0.62448591 | 0.535039031 |
| 71-41-0 | FI | 71-41-0 | 0.244542457 | 0.403970195 | 0.605347771 | 0.547580932 |
| 123-66-0 | FI | 123-66-0 | 0.002385596 | 0.004241953 | 0.562381505 | 0.576272599 |
| 75-85-4 | FI | 75-85-4 | 0.105118006 | 0.245597992 | 0.428008409 | 0.670412524 |
| 140-11-4 | FI | 140-11-4 | 0.022035617 | 0.063278921 | 0.348229973 | 0.729073349 |
| 2497-18-9 | FI | 2497-18-9 | 0.008247786 | 0.025315978 | 0.325793695 | 0.745887892 |
| 624-41-9 | FI | 624-41-9 | 0.009695911 | 0.030015933 | 0.323025469 | 0.747971351 |
| 96-04-8 | FI | 96-04-8 | 0.019585827 | 0.068404621 | 0.286323152 | 0.775768293 |
| 123-92-2 | FI | 123-92-2 | 0.005815982 | 0.025280458 | 0.230058392 | 0.818949026 |
| Malic | FI | Malic | 0.001142469 | 0.010557933 | 0.108209547 | 0.914245935 |
| 103-09-3 | FI | 103-09-3 | 0.019652674 | 0.486981222 | 0.040356123 | 0.96796376 |
| 1576-95-0 | FI | 1576-95-0 | −0.006041966 | 0.27670679 | −0.021835266 | 0.982662936 |
| 928-95-0 | FI | 928-95-0 | −0.000637898 | 0.008832411 | −0.072222372 | 0.942702019 |
| 55514-48-2 | FI | 55514-48-2 | −0.1505507 | 1.030864654 | −0.14604313 | 0.884452026 |
| 109-60-4 | FI | 109-60-4 | −0.05307496 | 0.20009876 | −0.265243824 | 0.791870326 |
| 111-27-3 | FI | 111-27-3 | −0.0018865 | 0.005748936 | −0.328147589 | 0.744117777 |
| Puncture | FI | Puncture | −1.078845267 | 3.104866186 | −0.347469167 | 0.729641387 |
| force | | force | | | | |
| 108-10-1 | FI | 108-10-1 | −0.072978472 | 0.209224799 | −0.348804119 | 0.728644778 |
| 105-37-3 | FI | 105-37-3 | −0.013710834 | 0.038501458 | −0.356112069 | 0.723197424 |
| 1191-16-8 | FI | 1191-16-8 | −0.035891159 | 0.077755853 | −0.461587875 | 0.646302095 |
| 106-32-1 | FI | 106-32-1 | −0.092492463 | 0.183129853 | −0.505064911 | 0.615647208 |
| 15111-96-3 | FI | 15111-96-3 | −0.236480496 | 0.458271776 | −0.516026751 | 0.608023105 |
| 623-43-8 | FI | 623-43-8 | −0.100966561 | 0.159353652 | −0.633600548 | 0.529118704 |
| 624-24-8 | FI | 624-24-8 | −0.100012454 | 0.146523439 | −0.682569658 | 0.497908421 |
| 2432-51-1 | FI | 2432-51-1 | −0.08748755 | 0.093014621 | −0.940578471 | 0.351269944 |
| 134-20-3 | FI | 134-20-3 | −0.848408207 | 0.802706543 | −1.05693446 | 0.295427129 |
| 110-62-3 | FI | 110-62-3 | −0.124867795 | 0.059031204 | −2.115284566 | 0.039215403 |

### REFERENCES FOR EXAMPLE 3, ALL OF WHICH ARE HEREBY INCORPORATED BY REFERENCE HEREIN

1. Aharoni, A., Giri, A. P., Verstappen, F. W. A., Bertea, C. M., Sevenier, R., Sun, Z. K., Jongsma, M. A., Schwab, W., and Bouwmeester, H. J. (2004). Gain and loss of fruit flavor compounds produced by wild and cultivated strawberry species. Plant Cell 16.
2. Aharoni, A., Keizer, L. C. P., Bouwmeester, H. J., Sun, Z. K., Alvarez-Huerta, M., Verhoeven, H. A., Blaas, J., van Houwelingen, A., De Vos, R. C. H., van der Voet, H., et al. (2000). Identification of the SAAT gene involved in strawberry flavor biogenesis by use of DNA microarrays. Plant Cell 12.
3. Bartoshuk, L. M., Duffy, V. B., Fast, K., Green, B. G., Prutkin, J., and Snyder, D. J. (2003). Labeled scales (eg, category, Likert, VAS) and invalid across-group comparisons: what we have learned from genetic variation in taste. Food Quality and Preference 14, 125-138.
4. Bartoshuk, L. M., Fast, K., and Snyder, D. J. (2005). Differences in our sensory-Invalid comparisons with labeled scales. Current Directions in Psychological Science 14, 122-125.

5. Basson, C. E., Groenewald, J. H., Kossmann, J., Cronje, C., and Bauer, R. (2010). Sugar and acid-related quality attributes and enzyme activities in strawberry fruits: Invertase is the main sucrose hydrolysing enzyme. Food Chemistry 121.
6. Bingham, A. F., Birch, G. G., Degraaf, C., Behan, J. M., and Perring, K. D. (1990). SENSORY STUDIES WITH SUCROSE MALTOL MIXTURES. Chemical Senses 15.
7. Brummell, D. A., and Harpster, M. H. (2001). Cell wall metabolism in fruit softening and quality and its manipulation in transgenic plants. Plant Molecular Biology 47.
8. Burdach, K. J., Kroeze, J. H. A., and Koster, E. P. (1984). NASAL, RETRONASAL, AND GUSTATORY PERCEPTION-AN EXPERIMENTAL COMPARISON. Perception & Psychophysics 36.
9. Cliff, M., and Noble, A. C. (1990). TIME-INTENSITY EVALUATION OF SWEETNESS AND FRUITINESS AND THEIR INTERACTION IN A MODEL SOLUTION. Journal of Food Science 55.
10. Colquhoun, T. A., Levin, L. A., Moskowitz, H. R., Whitaker, V. M., Clark, D. G., and Folta, K. M. (2012). Framing the perfect strawberry: an exercise in consumer-assisted selection of fruit crops. Journal of Berry Research 2, 45-61.
11. Cumplido-Laso, G., Medina-Puche, L., Moyano, E., Hoffmann, T., Sinz, Q., Ring, L., Studart-Wittkowski, C., Luis Caballero, J., Schwab, W., Munoz-Blanco, J., et al. (2012). The fruit ripening-related gene FaAAT2 encodes an acyl transferase involved in strawberry aroma biogenesis. Journal of Experimental Botany 63.
12. Fait, A., Hanhineva, K., Beleggia, R., Dai, N., Rogachev, I., Nikiforova, V. J., Fernie, A. R., and Aharoni, A. (2008). Reconfiguration of the achene and receptacle metabolic networks during strawberry fruit development. Plant Physiology 148.
13. Frank, R. A., and Byram, J. (1988). TASTE SMELL INTERACTIONS ARE TASTANT AND ODORANT DEPENDENT. Chemical Senses 13.
14. Frank, R. A., Ducheny, K., and Mize, S. J. S. (1989). STRAWBERRY ODOR, BUT NOT RED COLOR, ENHANCES THE SWEETNESS OF SUCROSE SOLUTIONS. Chemical Senses 14.
15. Goff, S. A., and Klee, H. J. (2006). Plant volatile compounds: Sensory cues for health and nutritional value? Science 311.
16. Hakala, M. A., Lapvetelainen, A. T., and Kallio, H. P. (2002). Volatile compounds of selected strawberry varieties analyzed by purge-and-trap headspace GC-MS. Journal of Agricultural and Food Chemistry 50.
17. Hancock, J. F. (1999). Strawberries. Strawberries.
18. Hoffmann, T., Kalinowski, G., and Schwab, W. (2006). RNAi-induced silencing of gene expression in strawberry fruit (Fragaria x ananassa) by agroinfiltration: a rapid assay for gene function analysis. Plant Journal 48.
19. Hong, V., and Wrolstad, R. E. (1990). USE OF HPLC SEPARATION PHOTODIODE ARRAY DETECTION FOR CHARACTERIZATION OF ANTHOCYANINS. Journal of Agricultural and Food Chemistry 38.
20. Jetti, R. R., Yang, E., Kurnianta, A., Finn, C., and Qian, M. C. (2007). Quantification of selected aroma-active compounds in strawberries by headspace solid-phase microextraction gas chromatography and correlation with sensory descriptive analysis. Journal of Food Science 72.
21. Kato, Y. (2003). Chemical and sensory changes in flavor of roux prepared from wheat flour and butter by heating to various temperatures. Food Science and Technology Research 9.
22. Labbe, D., Damevin, L., Vaccher, C., Morgenegg, C., and Martin, N. (2006). Modulation of perceived taste by olfaction in familiar and unfamiliar beverages. Food Quality and Preference 17.
23. Lavid, N., Schwab, W., Kafkas, E., Koch-Dean, M., Bar, E., Larkov, O., Ravid, U., and Lewinsohn, E. (2002). Aroma biosynthesis in strawberry: S-adenosylmethionine: furaneol O-methyltransferase activity in ripening fruits. Journal of Agricultural and Food Chemistry 50.
24. Lavin, J. G., and Lawless, H. T. (1998). Effects of color and odor on judgments of sweetness among children and adults. Food Quality and Preference 9.
25. Maarse, H. (1991). FOOD SCIENCE AND TECHNOLOGY NEW YORK VOL. 44. VOLATILE COMPOUNDS IN FOODS AND BEVERAGES. Maarse, H. (Ed.). Food Science and Technology (New York), Vol. 44. Volatile Compounds in Foods and Beverages. Xiii+764 p. Marcel Dekker, Inc.: New York, N.Y., USA; Basel, Switzerland. Illus.
26. MacKenzie, S. J., and Chandler, C. K. (2009). The late season decline in strawberry fruit soluble solid content observed in Florida is caused by rising temperatures. Acta Horticulturae.
27. MacKenzie, S. J., Chandler, C. K., Hasing, T., and Whitaker, V. M. (2011). The Role of Temperature in the Late-season Decline in Soluble Solids Content of Strawberry Fruit in a Subtropical Production System. Hortscience 46.
28. Menager, I., Jost, M., and Aubert, C. (2004). Changes in physicochemical characteristics and volatile constituents of strawberry (Cv. cigaline) during maturation. Journal of Agricultural and Food Chemistry 52.
29. Mikulic-Petkovsek, M., Schmitzer, V., Slatnar, A., Stampar, F., and Veberic, R. (2012). Composition of Sugars, Organic Acids, and Total Phenolics in 25 Wild or Cultivated Berry Species. Journal of Food Science 77, C1064-C1070.
30. Murphy, C., and Cain, W. S. (1980). TASTE AND OLFACTION-INDEPENDENCE VS INTERACTION. Physiology & Behavior 24.
31. Murphy, C., Cain, W. S., and Bartoshuk, L. M. (1977). MUTUAL ACTION OF TASTE AND OLFACTION. Sensory Processes 1.
32. Olbricht, K., Grafe, C., Weiss, K., and Ulrich, D. (2008). Inheritance of aroma compounds in a model population of Fragaria x ananassa Duch. Plant Breeding 127.
33. Pelayo-Zaldivar, C., Ebeler, S. E., and Kader, A. A. (2005). Cultivar and harvest date effects on flavor and other quality attributes of California strawberries. Journal of Food Quality 28.
34. Perez, A. G., Olias, R., Luaces, P., and Sanz, C. (2002). Biosynthesis of strawberry aroma compounds through amino acid metabolism. Journal of Agricultural and Food Chemistry 50.
35. Prescott, J. (1999). Flavour as a psychological construct: implications for perceiving and measuring the sensory qualities of foods. Food Quality and Preference 10.
36. Prescott, J. J. (2004). Psychological processes in flavour perception. Flavor perception.
37. Quesada, M. A., Blanco-Portales, R., Pose, S., Garcia-Gago, J. A., Jimenez-Bermudez, S., Munoz-Serrano, A., Caballero, J. L., Pliego-Alfaro, F., Mercado, J. A., and Munoz-Blanco, J. (2009). Antisense Down-Regulation of the FaPG1 Gene Reveals an Unexpected Central Role for Polygalacturonase in Strawberry Fruit Softening. Plant Physiology 150.
38. Raab, T., Lopez-Raez, J. A., Klein, D., Caballero, J. L., Moyano, E., Schwab, W., and Munoz-Blanco, J. (2006). FaQR, required for the biosynthesis of the strawberry flavor compound 4-hydroxy-2,5-dimethyl-3(2H)-furanone, encodes an enone oxidoreductase. Plant Cell 18.
39. Santos, B. M., Peres, N. A., Price, J. F., Whitaker, V. M., Dittmar, P. J., Olson, S. M., and Smith, S. A. (2012). Strawberry Production in Florida. In Vegetable Production Handbook, Volume HS710. (Gainesville, Fla.: University of Florida Institute of Food and Agricultural Sciences).
40. Schieberle, P., and Hofmann, T. (1997). Evaluation of the character impact odorants in fresh strawberry juice by quantitative measurements and sensory studies on model mixtures. Journal of Agricultural and Food Chemistry 45.
41. Schmelz, E. A., Alborn, H. T., Banchio, E., and Tumlinson, J. H. (2003). Quantitative relationships between induced jasmonic acid levels and volatile emission in Zea mays during Spodoptera exigua herbivory. Planta 216, 665-673.
42. Schmelz, E. A., Alborn, H. T., and Tumlinson, J. H. (2001). The influence of intact-plant and excised-leaf bioassay designs on volicitin- and jasmonic acid-induced sesquiterpene volatile release in Zea mays. Planta 214, 171-179.
43. M Loren, B., and Cairncross Stanley, E. (1955). Role of Sweeteners in Food Flavor. In USE OF SUGARS AND OTHER CARBOHYDRATES IN THE FOOD INDUSTRY, Volume 12. (AMERICAN CHEMICAL SOCIETY), pp. 108-113.
44. Small, D. M., Voss, J., Mak, Y. E., Simmons, K. B., Parrish, T., and Gitelman, D. (2004). Experience-dependent neural integration of taste and smell in the human brain. Journal of Neurophysiology 92.
45. Stevenson, R. J., Prescott, J., and Boakes, R. A. (1999). Confusing tastes and smells: How odours can influence the perception of sweet and sour tastes. Chemical Senses 24.
46. Strand, L. (2008). Integrated pest management for strawberries, Volume 3351, (ANR

Publications).
47. Tieman, D., Bliss, P., McIntyre, L. M., Blandon-Ubeda, A., Bies, D., Odabasi, A. Z., Rodriguez, G. R., van der Knaap, E., Taylor, M. G., Goulet, C., et al. (2012). The Chemical Interactions Underlying Tomato Flavor Preferences. Current Biology 22, 1035-1039.
48. Trainotti, L., Ferrarese, L., Dalla Vecchia, F., Rascio, N., and Casadoro, G. (1999). Two different endo-beta-1,4-glucanases contribute to the softening of the strawberry fruits. Journal of Plant Physiology 154.
49. Ulrich, D., Hoberg, E., Rapp, A., and Kecke, S. (1997). Analysis of strawberry flavour-discrimination of aroma types by quantification of volatile compounds. Zeitschrift Fur Lebensmittel-Untersuchung Und-Forschung a-Food Research and Technology 205.
50. Underwood, B. A., Tieman, D. M., Shibuya, K., Dexter, R. J., Loucas, H. M., Simkin, A. J., Sims, C. A., Schmelz, E. A., Klee, H. J., and Clark, D. G. (2005). Ethylene-regulated floral volatile synthesis in petunia corollas. Plant Physiology 138, 255-266.
51. Watson, R., Wright, C. J., McBurney, T., Taylor, A. J., and Linforth, R. S. T. (2002). Influence of harvest date and light integral on the development of strawberry flavour compounds. Journal of Experimental Botany 53.
52. Whitaker, V. M., Hasing, T., Chandler, C. K., Plotto, A., and Baldwin, E. (2011). Historical Trends in Strawberry Fruit Quality Revealed by a Trial of University of Florida Cultivars and Advanced Selections. Hortscience 46, 553-557.
53. Zabetakis, I., and Holden, M. A. (1997). Strawberry flavour: Analysis and biosynthesis. Journal of the Science of Food and Agriculture 74.
54. Zhang, Y., Wang, G., Dong, J., Zhong, C., Chang, L., Wang, L., Zhang, Y. T., Wang, G. X., Dong, J., Zhong, C. F., et al. (2011). Analysis of volatile compounds in 33 Euramerican strawberry cultivars. Journal of Fruit Science 28.

1. A method comprising:
increasing the perceived sweetness of a manufactured comestible by adding to the comestible a taste modifying composition comprising a combination of 10 to 42 volatile compounds chosen from the group consisting of: neral, 4-carene, 3-methyl-1-butanol, 6-methyl-5-hepten-2-ol, isovaleric acid, geranial, 1-penten-3-one, (E)-pent-2-en-1-al, (Z)-pent-2-en-1-al,5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, and S-methyl butanethioate;
wherein the combined volatile compounds increase the perceived sweetness of the comestible independent of a natural or artificial sweetener in the comestible.

2. The method of claim 1, comprising adding from 20 to 42 of the volatile compounds to the comestible.

3. The method of claim 1, wherein the comestible also comprises a natural or artificial sweetener and wherein the increase in perceived sweetness occurs without increasing the amount of natural or artificial sweetener in the comestible.

4. The method of claim 1, wherein at least 1 of the volatile compounds is selected from the group consisting of: neral, 4-carene, 3-methyl-1-butanol, 6-methyl-5-hepten-2-ol, isovaleric acid, and geranial.

5. A sweetener composition for increasing the perceived sweetness of a comestible, the composition comprising:
a combination of 10 to 42 volatile compounds chosen from the group consisting of: neral, 4-carene, 3-methyl-1-butanol, 6-methyl-5-hepten-2-ol, isovaleric acid, geranial, 1-penten-3-one, (E)-pent-2-en-1-al, (Z)-pent-2-en-1-al, 5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, and S-methyl butanethioate; and
a natural or artificial sweetener,
wherein the perceived sweetness of the sweetener composition is greater than the perceived sweetness of a comparable sweetener composition comprising the natural or artificial sweetener without the combination of volatile compounds.

6. The sweetener composition of claim 5, wherein the perceived sweetness of the sweetener composition is greater than the perceived sweetness of a comparable sweetener composition comprising only one of the volatile compounds.

7. The sweetener composition of claim 5, wherein the perceived sweetness of a comestible comprising the sweetener composition is greater than the perceived sweetness of a comparable comestible including only one of the volatile compounds.

8. The sweetener composition of claim 5, comprising a combination of 20 to 42 of the volatile compounds.

9. The sweetener composition of claim 5, wherein at least 1 of the volatile compounds is selected from the group consisting of: neral, 4-carene, 3-methyl-1-butanol, 6-methyl-5-hepten-2-ol, isovaleric acid, and geranial.

10. A taste modifying composition for increasing the perceived sweetness of a comestible, the composition comprising:
a combination of 10 to 42 volatile compounds chosen from the group consisting of: neral, 4-carene, 3-methyl-1-butanol, 6-methyl-5-hepten-2-ol, isovaleric acid, geranial, 1-penten-3-one, (E)-pent-2-en-1-al, (Z)-pent-2-en-1-al, 5-octyldihydro-2(3H)-furanone, 2-decenal, nonanal, (2E)-2-hexenal, 2-hexanone, 3-ethyloctane, pentyl butyrate, hexyl butyrate, ethyl butyrate, 6,6-dimethylbicyclo[3.1.1]hept-2-ene-2-carbaldehyde, heptanal, 4-methoxy-2,5-dimethyl-3(2H)-furanone, 6-methyl-5-hepten-2-one, isopropyl butyrate, hexyl acetate, 2-pentanyl butyrate, 2-methylbutanoic acid, butyl acetate, butyl butyrate, butyl 3-methylbutanoate, decyl butyrate, (2E)-2-hexen-1-yl butyrate, 2-ethyl-1-hexanol, octyl butyrate, propyl butyrate, nonyl 2-methylpropanoate, octyl acetate, octyl hexanoate, octyl 3-methylbutanoate, ethyl decanoate, isopropyl hexanoate, ethyl valerate, and S-methyl butanethioate;
wherein the perceived sweetness of the comestible is greater than the perceived sweetness of a comparable comestible comprising without the combination of volatile compounds.

11. The taste modifying composition of claim 10, wherein the perceived sweetness of a comestible comprising the taste modifying composition is greater than the perceived sweetness of a taste modifying composition including only one of the volatile compounds.

12. The taste modifying composition of claim 10, wherein the taste modifying composition also includes a a natural or artificial sweetener, and wherein the perceived sweetness of the taste modifying composition is greater than the perceived sweetness of a comparable composition comprising the natural or artificial sweetener without the combination of volatile compounds

13. The taste modifying composition of claim 10, comprising a combination of 20 to 42 of the volatile compounds.

14. The taste modifying composition of claim 10, wherein at least 1 of the volatile compounds is selected from the group consisting of: neral, 4-carene, 3-methyl-1-butanol, 6-methyl-5-hepten-2-ol, isovaleric acid, and geranial.


SEQUENCE LISTING (2 sequences)

SEQ ID NO: 1 - DNA, 20 bp, Artificial Sequence
  Chemically synthesized forward primer
gcaatgcatcatgtgtgcta

SEQ ID NO: 2 - DNA, 21 bp, Artificial Sequence
  Chemically synthesized reverse primer
gtaaatgtcgaattcccttcg